(19) United States
(12) Patent Application Publication
(10) Pub. No.: US 2024/0121800 A1
(43) Pub. Date: Apr. 11, 2024

(54) METHOD AND APPARATUS FOR TCI STATE INDICATION AND ASSOCIATION FOR CONTROL AND DATA CHANNELS

(71) Applicant: Samsung Electronics Co., Ltd., Suwon-si (KR)

(72) Inventors: Dalin Zhu, Allen, TX (US); Emad Nader Farag, Flanders, NJ (US); Aristides Papasakellariou, Houston, TX (US); Eko Onggosanusi, Coppell, TX (US)

(21) Appl. No.: 18/470,338

(22) Filed: Sep. 19, 2023

Related U.S. Application Data
(60) Provisional application No. 63/412,254, filed on Sep. 30, 2022.
(60) Provisional application No. 63/413,486, filed on Oct. 5, 2022.
(60) Provisional application No. 63/471,105, filed on Jun. 5, 2023.

(51) Int. Cl. H04W 72/232; H04W 72/1263

(52) U.S. Cl. CPC H04W 72/232; H04W 72/1263

(57) ABSTRACT

Methods and apparatuses for transmission configuration indication (TCI) state indication and association for control and data channels. A method performed by a user equipment (UE) includes receiving first information for first and second groups of configured TCI states; receiving, in a downlink control information (DCI), a first indicated TCI state of a TCI codepoint; and receiving second information for a first control resource set (CORESET). The method further includes identifying, based on the first information, whether the first indicated TCI state is associated with the first or second group of configured TCI states; identifying, based on the second information, whether the first CORESET is associated with the first or second group of configured TCI states; and based on identifying that the first indicated TCI state and the first CORESET are associated with the same group of configured TCI states, receiving physical downlink control channel (PDCCH) candidates in the first CORESET according to the first indicated TCI state.

### CROSS-REFERENCE TO RELATED APPLICATIONS AND CLAIM OF PRIORITY

The present application claims priority to: U.S. Provisional Patent Application No. 63/412,254, filed on Sep. 30, 2022; U.S. Provisional Patent Application No. 63/413,486, filed on Oct. 5, 2022; and U.S. Provisional Patent Application No. 63/471,105, filed on Jun. 5, 2023. The contents of the above-identified patent documents are incorporated herein by reference.

### TECHNICAL FIELD

The present disclosure relates generally to wireless communication systems and, more specifically, the present disclosure relates to a transmission configuration indication (TCI) state indication and association for control and data channels in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to a TCI state indication and association for control and data channels in a wireless communication system.

In one embodiment, a user equipment (UE) is provided. The UE includes a transceiver configured to receive first information for first and second groups of configured TCI states, receive, in a downlink control information (DCI), a first indicated TCI state of a TCI codepoint, and receive second information for a first control resource set (CORESET). The UE further includes a processor operably coupled with the transceiver. The processor configured to identify, based on the first information, whether the first indicated TCI state is associated with the first or second group of configured TCI states and identify, based on the second information, whether the first CORESET is associated with the first or second group of configured TCI states. When the first indicated TCI state and the first CORESET are associated with the same group of configured TCI states, the transceiver is further configured to receive physical downlink control channel (PDCCH) candidates in the first CORESET according to the first indicated TCI state.

In another embodiment, a base station (BS) is provided. The BS includes a transceiver configured to transmit first information for first and second groups of configured TCI states; transmit, in a DCI, a first indicated TCI state of a TCI codepoint; and transmit second information for a first CORESET. The BS further includes a processor operably coupled with the transceiver. The processor is configured to identify, based on the first information, whether the first indicated TCI state is associated with the first or second group of configured TCI states and identify, based on the second information, whether the first CORESET is associated with the first or second group of configured TCI states. When the first indicated TCI state and the first CORESET are associated with the same group of configured TCI states, the transceiver is further configured to transmit PDCCH candidates in the first CORESET according to the first indicated TCI state.

In yet another embodiment, a method performed by a UE is provided. The method includes receiving first information for first and second groups of configured TCI states; receiving, in a DCI, a first indicated TCI state of a TCI codepoint; and receiving second information for a first CORESET. The method further includes identifying, based on the first information, whether the first indicated TCI state is associated with the first or second group of configured TCI states; identifying, based on the second information, whether the first CORESET is associated with the first or second group of configured TCI states; and based on identifying that the first indicated TCI state and the first CORESET are associated with the same group of configured TCI states, receiving PDCCH candidates in the first CORESET according to the first indicated TCI state.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to this disclosure;

FIG. 6A illustrates an example of wireless system beam according to embodiments of the present disclosure;

FIG. 6B illustrates an example of multi-beam operation according to embodiments of the present disclosure;

FIG. 7 illustrates an example of antenna structure according to embodiments of the present disclosure;

FIG. 8 illustrates an example of multiple transmission and reception points system according to embodiments of the present disclosure;

FIG. 9 illustrates a flowchart of a UE procedure for determining TCI states for monitoring PDCCH candidates according to embodiments of the present disclosure;

FIGS. 10 and 11 illustrate examples of determining TCI state(s) for monitoring PDCCH candidates in overlapping CORESETs according to embodiments of the present disclosure;

FIG. 12 illustrates an example of determining which of the indicated TCI states to use for PDSCH receptions according to embodiments of the present disclosure;

FIG. 13 illustrates a flowchart of a UE procedure for determining which of the indicated TCI state(s) to use for PDSCH receptions according to embodiments of the present disclosure;

FIG. 14 illustrates an example of associating CORESETs with/to TCI states according to embodiments of the present disclosure;

FIG. 15 illustrates another example of associating CORESETs with/to TCI states according to embodiments of the present disclosure;

FIG. 16 illustrates yet another example of associating CORESETs with/to TCI states according to embodiments of the present disclosure;

FIGS. 17 and 18 illustrate flowcharts of UE procedures for determining TCI state(s) for receiving PDCCH candidates according to embodiments of the present disclosure;

FIG. 19 illustrates a flowchart of a UE procedure for associating the indicated TCI states with/to the PDCCH candidates according to embodiments of the present disclosure;

FIG. 20 illustrates an example of associating the indicated TCI states with/to the PDSCH receptions according to embodiments of the present disclosure; and

FIG. 21 illustrates a flowchart of a UE procedure for determining the association between the indicated TCI states and the PDSCH receptions according to embodiments of the present disclosure.

### DETAILED DESCRIPTION

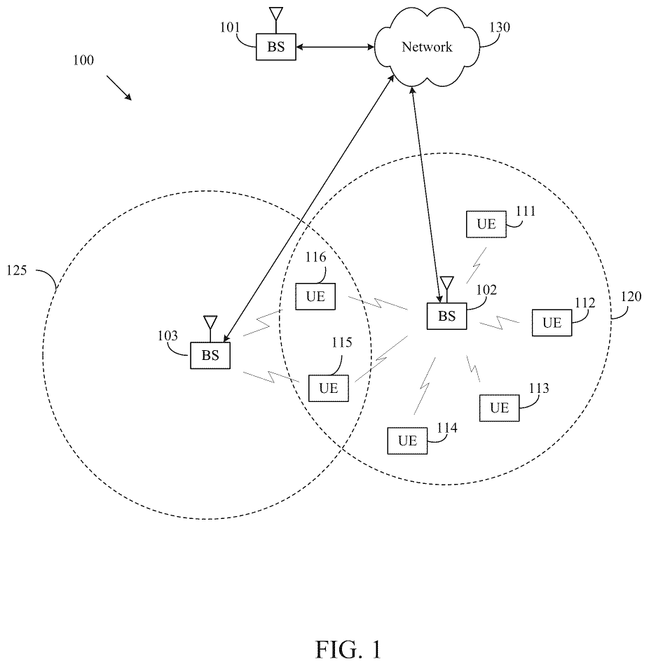

FIG. 1 through FIG. 21, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents are hereby incorporated by reference into the present disclosure as if fully set forth herein: 3GPP TS 38.211 v16.1.0, “NR; Physical channels and modulation”; 3GPP TS 38.212 v16.1.0, “NR; Multiplexing and Channel coding”; 3GPP TS 38.213 v16.1.0, “NR; Physical Layer Procedures for Control”; 3GPP TS 38.214 v16.1.0, “NR; Physical Layer Procedures for Data”; 3GPP TS 38.321 v16.1.0, “NR; Medium Access Control (MAC) protocol specification”; and 3GPP TS 38.331 v16.1.0, “NR; Radio Resource Control (RRC) Protocol Specification.”

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for identification of a TCI state indication and association for control and data channels in a wireless communication system. In certain embodiments, and one or more of the gNBs 101-103 includes circuitry, programing, or a combination thereof, for supporting a TCI state indication and association for control and data channels in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

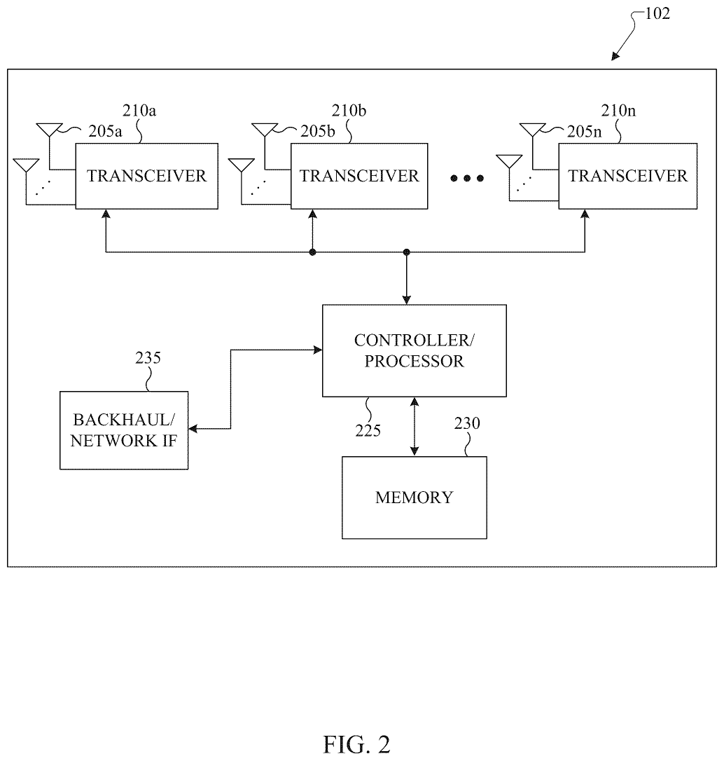

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes for a TCI state indication and association for control and data channels in a wireless communication system. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

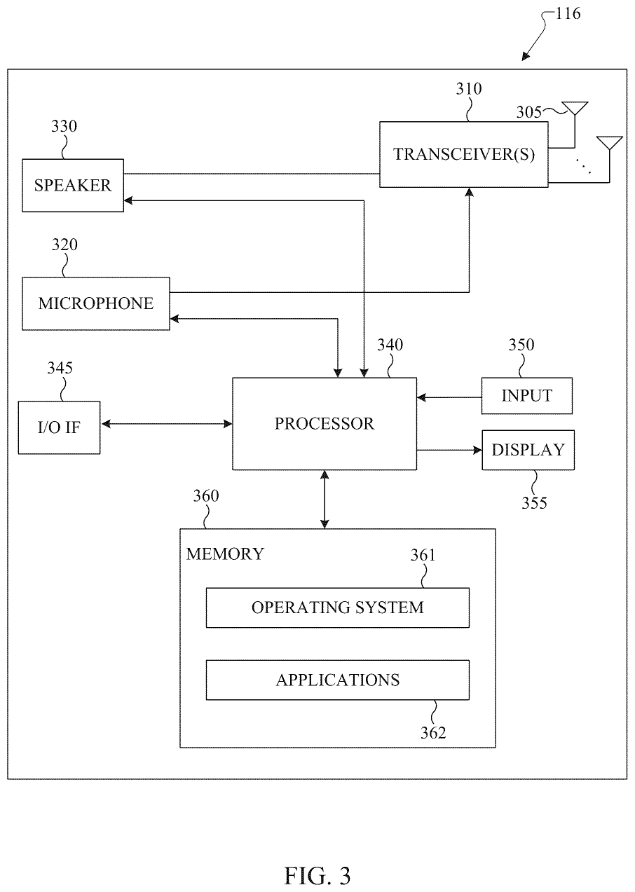

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for identification of a TCI state indication and association for control and data channels in a wireless communication system.

The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355m which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

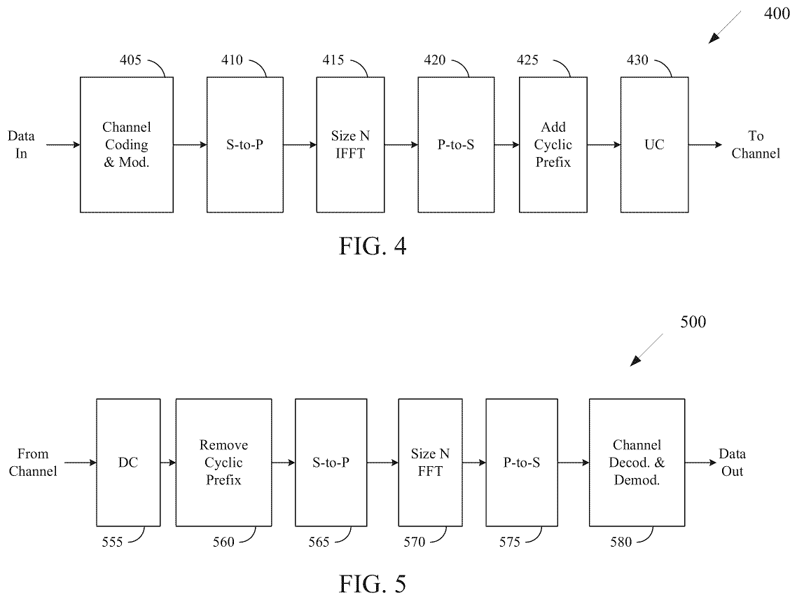

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the receive path 500 is configured to support identification of a TCI state indication and association for control and data channels in a wireless communication system.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the down converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond and an RB can have a bandwidth of 180 KHz and include 12 SCs with inter-SC spacing of 15 KHz. A slot can be either full DL slot, or full UL slot, or hybrid slot similar to a special subframe in time division duplex (TDD) systems.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. A UE can be indicated a spatial setting for a PDCCH reception based on a configuration of a value for a TCI state of a CORESET where the UE receives the PDCCH. The UE can be indicated a spatial setting for a PDSCH reception based on a configuration by higher layers or based on an indication by a DCI format scheduling the PDSCH reception of a value for a TCI state. The gNB can configure the UE to receive signals on a cell within a DL bandwidth part (BWP) of the cell DL BW.

A gNB transmits one or more of multiple types of RS including channel state information RS (CSI-RS) and demodulation RS (DMRS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process consists of NZP CSI-RS and CSI-IM resources. A UE can determine CSI-RS transmission parameters through DL control signaling or higher layer signaling, such as an RRC signaling from a gNB. Transmission instances of a CSI-RS can be indicated by DL control signaling or configured by higher layer signaling. A DMRS is transmitted only in the BW of a respective PDCCH or PDSCH and a UE can use the DMRS to demodulate data or control information.

UL signals also include data signals conveying information content, control signals conveying UL control information (UCI), DMRS associated with data or UCI demodulation, sounding RS (SRS) enabling a gNB to perform UL channel measurement, and a random access (RA) preamble enabling a UE to perform random access. A UE transmits data information or UCI through a respective physical UL shared channel (PUSCH) or a physical UL control channel (PUCCH). A PUSCH or a PUCCH can be transmitted over a variable number of slot symbols including one slot symbol. The gNB can configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in the buffer of UE, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER, of a precoding matrix indicator (PMI) informing a gNB how to combine signals from multiple transmitter antennas in accordance with a multiple input multiple output (MIMO) transmission principle, and of a rank indicator (RI) indicating a transmission rank for a PDSCH. UL RS includes DMRS and SRS. DMRS is transmitted only in a BW of a respective PUSCH or PUCCH transmission. A gNB can use a DMRS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel.

In the present disclosure, a beam is determined by either of: (1) a TCI state, which establishes a quasi-colocation (QCL) relationship between a source reference signal (e.g., synchronization signal/physical broadcasting channel (PBCH) block (SSB) and/or CSI-RS) and a target reference signal; or (2) spatial relation information that establishes an association to a source reference signal, such as SSB or CSI-RS or SRS. In either case, the ID of the source reference signal identifies the beam.

The TCI state and/or the spatial relation reference RS can determine a spatial Rx filter for reception of downlink channels at the UE, or a spatial Tx filter for transmission of uplink channels from the UE.

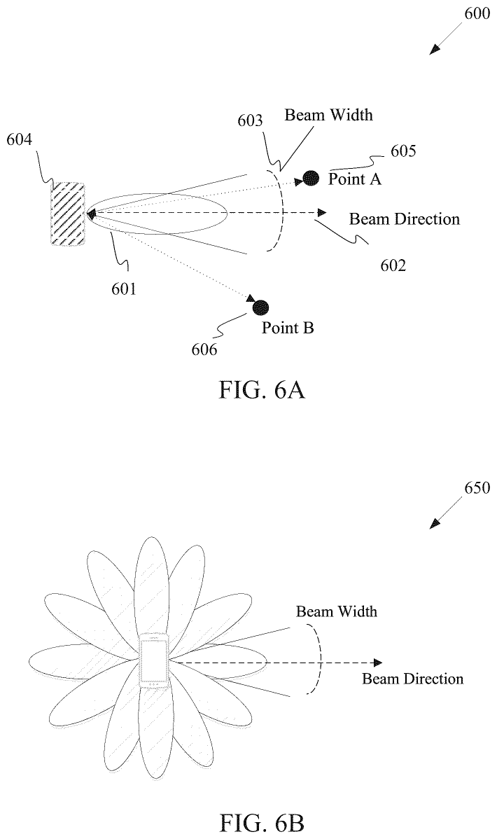

FIG. 6A illustrates an example wireless system beam 600 according to embodiments of the present disclosure. An embodiment of the wireless system beam 600 shown in FIG. 6A is for illustration only.

As illustrated in FIG. 6A, in a wireless system a beam 601, for a device 604, can be characterized by a beam direction 602 and a beam width 603. For example, a device 604 with a transmitter transmits radio frequency (RF) energy in a beam direction and within a beam width. The device 604 with a receiver receives RF energy coming towards the device in a beam direction and within a beam width. As illustrated in FIG. 6A, a device at point A 605 can receive from and transmit to the device 604 as point A is within a beam width of a beam traveling in a beam direction and coming from the device 604.

As illustrated in FIG. 6A, a device at point B 606 cannot receive from and transmit to the device 604 as point B is outside a beam width of a beam traveling in a beam direction and coming from the device 604. While FIG. 6A, for illustrative purposes, shows a beam in 2-dimensions (2D), it may be apparent to those skilled in the art, that a beam can be in 3-dimensions (3D), where the beam direction and beam width are defined in space.

FIG. 6B illustrates an example multi-beam operation 650 according to embodiments of the present disclosure. An embodiment of the multi-beam operation 650 shown in FIG. 6B is for illustration only.

In a wireless system, a device can transmit and/or receive on multiple beams. This is known as “multi-beam operation” and is illustrated in FIG. 6B. While FIG. 6B, for illustrative purposes, is in 2D, it may be apparent to those skilled in the art, that a beam can be 3D, where a beam can be transmitted to or received from any direction in space.

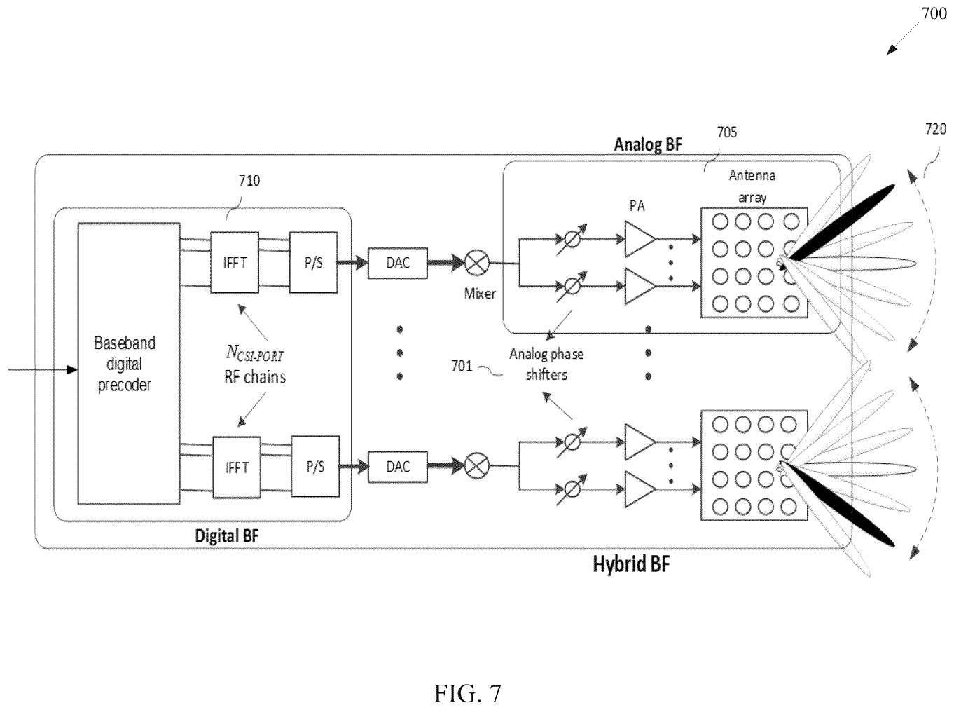

Rel.14 LTE and Rel.15 NR support up to 32 CSI-RS antenna ports which enable an eNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports—which can correspond to the number of digitally precoded ports—tends to be limited due to hardware constraints (such as the feasibility to install a large number of ADCs/DACs at mmWave frequencies) as illustrated in FIG. 7.

FIG. 7 illustrates an example antenna structure 700 according to embodiments of the present disclosure. An embodiment of the antenna structure 700 shown in FIG. 7 is for illustration only.

In this case, one CSI-RS port is mapped onto a large number of antenna elements which can be controlled by a bank of analog phase shifters 701. One CSI-RS port can then correspond to one sub-array which produces a narrow analog beam through analog beamforming 705. This analog beam can be configured to sweep across a wider range of angles 720 by varying the phase shifter bank across symbols or subframes. The number of sub-arrays (equal to the number of RF chains) is the same as the number of CSI-RS ports NCSI-PORT. A digital beamforming unit 710 performs a linear combination across NCSI-PORT analog beams to further increase precoding gain. While analog beams are wideband (hence not frequency-selective), digital precoding can be varied across frequency sub-bands or resource blocks. Receiver operation can be conceived analogously.

Since the aforementioned system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting,” respectively), and receiving a DL or UL transmission via a selection of a corresponding RX beam.

The aforementioned system is also applicable to higher frequency bands such as >52.6 GHz. In this case, the system can employ only analog beams. Due to the O2 absorption loss around 60 GHz frequency (˜10 dB additional loss @100 m distance), larger number of and sharper analog beams (hence larger number of radiators in the array) may be needed to compensate for the additional path loss.

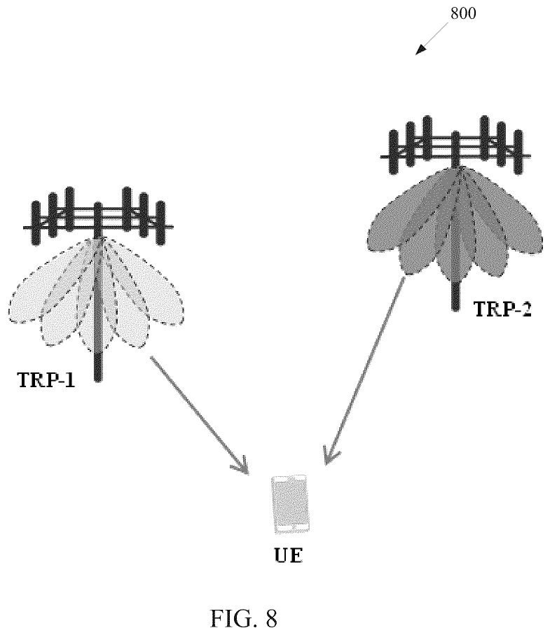

FIG. 8 illustrates an example of multiple transmission and reception point system 800 according to embodiments of the present disclosure. An embodiment of the multiple transmission and reception point system 800 shown in FIG. 8 is for illustration only.

In a multiple transmission and reception point (TRP) system depicted in FIG. 8, the UE could simultaneously receive from multiple physically non-co-located TRPs various channels/RSs such as PDCCHs and/or PDSCHs using either a single receive (RX) panel or multiple RX panels. In this disclosure, a RX panel could correspond to a set of RX antenna elements/ports at the UE, a set of measurement RS resources such as SRS resources, a spatial domain RX filter or etc. Further, a TRP in the multi-TRP system can represent a collection of measurement antenna ports, measurement RS resources and/or control resource sets (CORESETs).

For example, a TRP could be associated with one or more of: (1) a plurality of CSI-RS resources; (2) a plurality of CRIs (CSI-RS resource indices/indicators); (3) a measurement RS resource set, for example, a CSI-RS resource set along with its indicator; (4) a plurality of CORESETs associated with a CORESETPoolIndex; and (5) a plurality of CORESETs associated with a TRP-specific index/indicator/identity.

A cell/TRP could be a non-serving cell/TRP. In this disclosure, the non-serving cell(s) or the non-serving cell TRP(s) could have/broadcast different physical cell IDs (PCIs) and/or other higher layer signaling index values from that of the serving cell or the serving cell TRP (i.e., the serving cell PCI). In one example, the serving cell or the serving cell TRP could be associated with the serving cell ID (SCI) and/or the serving cell PCI. That is, for the inter-cell operation considered in the present disclosure, different cells/TRPs could broadcast different PCIs and/or one or more cells/TRPs (referred to/defined as non-serving cells/TRPs in the present disclosure) could broadcast different PCIs from that of the serving cell/TRP (i.e., the serving cell PCI) and/or one or more cells/TRPs are not associated with valid SCI (e.g., provided by the higher layer parameter ServCellIndex). In the present disclosure, a non-serving cell PCI can also be referred to as an additional PCI, another PCI or a different PCI (with respect to the serving cell PCI).

The UE could be configured by the network one or more transmission configuration information (TCI) states, which indicate the QCL information/assumptions for one or more RSs/channels such as PDCCHs and/or PDSCHs. The TCI state update/indication for PDCCH and/or PDSCH can also be referred to as beam indication. For instance, for data transmissions on the shared channel (such as the physical downlink shared channel in NR, i.e., PDSCH), the corresponding beam indication procedure under the 3GPP Rel. 15/16 TCI framework can be summarized as follows: a UE can be first higher layer configured by the network (e.g., via high layer RRC signaling) a set/pool of TCI states; the UE could then receive from the network a MAC CE command activating one or more TCI states from the set/pool of RRC configured TCI states; the UE could be indicated by the network via dynamic DCI signaling that one or more of the MAC CE activated TCI states are active for the reception of the PDSCH(s).

Under the Rel. 17 unified TCI framework, wherein a UE could be provided by the network one or more separate/joint DL or UL TCI state for various DL or UL channels/signals, various design aspects related to beam indication for control resource sets (CORESETs), PDSCH, PUSCH, PUCCH, CSI-RS and/or SRS need to be specified.

The present disclosure considers various design aspects/enhancements related to beam indication for CORESETs/PDCCHs, PDSCH, PUCCH, PUSCH, CSI-RS and/or SRS in a multi-TRP system or an inter-cell system wherein at least a PCI different from the serving cell PCI is deployed under the unified TCI framework. Means of associating indicated TCI state(s) to various target control and/or shared channels especially with overlapping CORESETs are specified.

As described in U.S. patent application Ser. No. 17/584,239, filed Jan. 25, 2022, which is incorporated by reference herein, a unified TCI framework could indicate/include N≥1 DL TCI states and/or M≥1 UL TCI states, wherein the indicated TCI state could be at least one of: (1) a DL TCI state and/or its corresponding/associated TCI state ID; (2) an UL TCI state and/or its corresponding/associated TCI state ID; (3) a joint DL and UL TCI state and/or its corresponding/associated TCI state ID; and (4) separate DL TCI state and UL TCI state and/or their corresponding/associated TCI state ID(s).

There could be various design options/channels to indicate to the UE a beam (i.e., a TCI state) for the transmission/reception of a PDCCH or a PDSCH. As described in U.S. patent application Ser. No. 17/584,239, in one example, a MAC CE could be used to indicate to the UE a beam (i.e., a TCI state and/or a TCI state ID) for the transmission/reception of a PDCCH or a PDSCH; and (2) In another example, a DCI could be used to indicate to the UE a beam (i.e., a TCI state and/or a TCI state ID) for the transmission/reception of a PDCCH or a PDSCH.

For example, a DL related DCI (e.g., DCI format 1_0, DCI format 1_1 or DCI format 1_2) could be used to indicate to the UE a beam (i.e., a TCI state and/or a TCI state ID) for the transmission/reception of a PDCCH or a PDSCH, wherein the DL related DCI may or may not include a DL assignment.

For another example, an UL related DCI (e.g., DCI format 00, DCI format 0_1, DCI format 0_2) could be used to indicate to the UE a beam (i.e., a TCI state and/or a TCI state ID) for the transmission/reception of a PDCCH or a PDSCH, wherein the UL related DCI may or may not include an UL scheduling grant.

Yet for another example, a custom/purpose designed DCI format could be used to indicate to the UE a beam (i.e., a TCI state and/or a TCI state ID) for the transmission/reception of a PDCCH or a PDSCH.

Rel-17 introduced the unified TCI framework, where a unified or master or main TCI state is signaled to the UE. The unified or master or main TCI state can be one of: (1) in case of joint TCI state indication, wherein a same beam is used for DL and UL channels, a joint TCI state that can be used at least for UE-dedicated DL channels and UE-dedicated UL channels; (2) in case of separate TCI state indication, wherein different beams are used for DL and UL channels, a DL TCI state can be used at least for UE-dedicated DL channels, or (3) in case of separate TCI state indication, wherein different beams are used for DL and UL channels, a UL TCI state can be used at least for UE-dedicated UL channels.

The unified (master or main) TCI state is TCI state of UE-dedicated reception on PDSCH/PDCCH or dynamic-grant/configured-grant based PUSCH and all of dedicated PUCCH resources.

As discussed above, a UE could be provided by the network, e.g., via MAC CE or DCI (e.g., DCI format 1_1 or 1_2 with or without DL assignment) based signaling via higher layer parameters DLorJointTCIState or UL-TCIState, M>1 joint DL and UL TCI states or M>1 separate UL TCI states or a first combination of M>1 joint DL and UL TCI states and separate UL TCI states or N>1 separate DL TCI states or a second combination of N>1 joint DL and UL TCI states and separate DL TCI states or a third combination of N>1 joint DL and UL TCI states, separate DL TCI states and separate UL Rel. 17 unified TCI for UE-dedicated reception on PDSCH/PDCCH or dynamic-grant/configured-grant based PUSCH and all of dedicated PUCCH resources.

Throughout the present disclosure, the term “configuration” or “higher layer configuration” and variations thereof (such as “configured” and so on) could be used to refer to one or more of a system information signaling such as by a MIB or a SIB (such as SIB1), a common or cell-specific higher layer/RRC signaling, or a dedicated or UE-specific or BWP-specific higher layer/RRC signaling.

The UE can be configured with a list of up to M TCI-State configurations within the higher layer parameter PDSCH-Config to decode PDSCH according to a detected PDCCH with DCI intended for the UE and the given serving cell, where M depends on the UE capability maxNumberConfiguredTCIstatesPerCC. Each TCI-State contains parameters for configuring a quasi-co-location relationship between one or two downlink reference signals and the DM-RS ports of the PDSCH, the DM-RS port of PDCCH or the CSI-RS port(s) of a CSI-RS resource. The quasi-co-location relationship is configured by the higher layer parameter qcl-Type1 for the first DL RS, and qcl-Type2 for the second DL RS (if configured). For the case of two DL RSs, the QCL types may not be the same, regardless of whether the references are to the same DL RS or different DL RSs.

The quasi co-location types corresponding to each DL RS are given by the higher layer parameter qcl-Type in QCL-Info and may take one of the following values: (1) “typeA”: {Doppler shift, Doppler spread, average delay, delay spread}; (2) “typeB”: {Doppler shift, Doppler spread}; (3) “typeC”: {Doppler shift, average delay}; and (4) “typeD”: {Spatial Rx parameter}.

The UE can be configured with a list of up to 128 DLorJointTCIState configurations, within the higher layer parameter PDSCH-Config for providing a reference signal for the quasi co-location for DM-RS of PDSCH and DM-RS of PDCCH in a CC, for CSI-RS, and to provide a reference, if applicable, for determining UL TX spatial filter for dynamic-grant and configured-grant based PUSCH and PUCCH resource in a CC, and SRS.

If the DLorJointTCIState or UL-TCIState configurations are absent in a BWP of the CC, the UE can apply the DLorJointTCIState or UL-TCIState configurations from a reference BWP of a reference CC. The UE is not expected to be configured with TCI-State, SpatialRelationInfo or PUCCH-SpatialRelationInfo, except SpatialRelationInfoPos in a CC in a band, if the UE is configured with DLorJointTCIState or UL-TCIState in any CC in the same band. The UE can assume that when the UE is configured with TCI-State in any CC in the CC list configured by simultaneousTCI-UpdateList1-r16, simultaneousTCI-UpdateList2-r16, simultaneousSpatial-UpdatedList1-r16, or simultaneousSpatial-UpdatedList2-r16, the UE is not configured with DLorJointTCIState or UL-TCIState in any CC within the same band in the CC list.

The UE receives an activation command, as described in TS 38.321, used to map up to 8 TCI states and/or pairs of TCI states, with one TCI state for DL channels/signals and one TCI state for UL channels/signals to the codepoints of the DCI field “Transmission Configuration Indication” for one or for a set of CCs/DL BWPs, and if applicable, for one or for a set of CCs/UL BWPs. When a set of TCI state IDs are activated for a set of CCs/DL BWPs and if applicable, for a set of CCs/UL BWPs, where the applicable list of CCs is determined by the indicated CC in the activation command, the same set of TCI state IDs are applied for all DL and/or UL BWPs in the indicated CCs.

The unified TCI States Activation/Deactivation MAC CE is identified by a MAC subheader with eLCID as specified in TS 38.321. The Unified TCI States Activation/Deactivation MAC CE has a variable size consisting of following fields.

In one example of serving Cell ID, this field indicates the identity of the Serving Cell for which the MAC CE applies. The length of the field is 5 bits. If the indicated Serving Cell is configured as part of a simultaneousU-TCI-UpdateList1, simultaneousU-TCI-UpdateList2, simultaneousU-TCI-UpdateList3 or simultaneousU-TCI-UpdateList4 as specified in TS 38.331, this MAC CE applies to all theServing Cells in the set simultaneousU-TCI-UpdateList1, simultaneousU-TCI-UpdateList2, simultaneousU-TCI-UpdateList3 or simultaneousU-TCI-UpdateList4, respectively.

In one example of DL BWP ID, this field indicates a DL BWP for which the MAC CE applies as the codepoint of the DCI bandwidth part indicator field as specified in TS 38.212. The length of the BWP ID field is 2 bits.

In one example of UL BWP ID, this field indicates a UL BWP for which the MAC CE applies as the codepoint of the DCI bandwidth part indicator field as specified in TS 38.212. The length of the BWP ID field is 2 bits.

In one example of Pᵢ, this field indicates whether each TCI codepoint has multiple TCI states or single TCI state. If Pᵢ field set to 1, the field indicates that i^{th} TCI codepoint includes the DL TCI state and the UL TCI state. If Pᵢ field set to 0, the field indicates that i^{th} TCI codepoint includes only the DL TCI state or the UL TCI state.

In one exmaple of D/U, this field indicate whether the TCI state ID in the same octet is for joint/downlink or uplink TCI state. If this field is set to 1, the TCI state ID in the same octet is for joint/downlink. If this field is set to 0, the TCI state ID in the same octet is for uplink.

In one example of TCI state ID, this field indicates the TCI state identified by TCI-StateId as specified in TS 38.331. If D/U is set to 1, 7-bits length TCI state ID i.e., TCI-StateId as specified in TS 38.331 is used. If D/U is set to 0, the most significant bit of TCI state ID is considered as the reserved bit and remainder 6 bits indicate the UL-TCIState-Id as specified in TS 38.331. The maximum number of activated TCI states is 16.

In one example of R, this filed is a eeserved bit and set to 0.

The CellGroupConfig IE specified in the TS 38.331 is used to configure a master cell group (MCG) or secondary cell group (SCG). A cell group comprises of one MAC entity, a set of logical channels with associated RLC entities and of a primary cell (SpCell) and one or more secondary cells (SCells).

simultaneousTCI-UpdateList1, simultaneousTCI-UpdateList2 are list of serving cells which can be updated simultaneously for TCI relation with a MAC CE. The simultaneousTCI-UpdateList1 and simultaneousTCI-UpdateList2 may not contain same serving cells. Network may not configure serving cells that are configured with a BWP with two different values for the coresetPoolIndex in these lists.

simultaneousU-TCI-UpdateList1, simultaneousU-TCI-UpdateList2, simultaneousU-TCI-UpdateList3, simultaneousU-TCI-UpdateList4 are list of serving cells for which the Unified TCI States Activation/Deactivation MAC CE applies simultaneously, as specified in TS 38.321. The different lists may not contain same serving cells. Network only configures in these lists serving cells that are configured with unifiedtci-StateType.

When the bwp-id or cell for QCL-TypeA/D source RS in a QCL-Info of the TCI state configured with DLorJointTCIState is not configured, the UE assumes that QCL-TypeA/D source RS is configured in the CC/DL BWP where TCI state applies.

When tci-PresentInDCI is set as “enabled” or tci-PresentDCI-1-2 is configured for the CORESET, the UE with activated DLorJointTCIState or UL-TCIState receives DCI format 1_1/1_2 providing indicated DLorJointTCIState or UL-TCIState for a CC or all CCs in the same CC list configured by simultaneousTCI-UpdateList1-r17, simultaneousTCI-UpdateList2-r17, simultaneousTCI-UpdateList3-r17, simultaneousTCI-UpdateList4-r17. The DCI format 1_1/1_2 can be with or without, if applicable, DL assignment. If the DCI format 1_1/1_2/is without DL assignment, the UE can assume the following: (1) CS-RNTI is used to scramble the CRC for the DCI and (2) the values of the following DCI fields are set as follows: (i) RV=all “1”s, (ii) MCS=all “1”s, (iii) NDI=0, and (iv) Set to all “0”s for FDRA Type 0, or all “1”s for FDRA Type 1, or all “0”s for dynamicSwitch (as illustrated in TS 38.213).

After a UE receives an initial higher layer configuration of more than one DLorJoint-TCIState and before application of an indicated TCI state from the configured TCI states, the UE assumes that DM-RS of PDSCH and DM-RS of PDCCH and the CSI-RS applying the indicated TCI state are quasi co-located with the SS/PBCH block the UE identified during the initial access procedure.

After a UE receives an initial higher layer configuration of more than one DLorJoint-TCIState or UL-TCIState and before application of an indicated TCI state from the configured TCI states, the UE assumes that the UL TX spatial filter, if applicable, for dynamic-grant and configured-grant based PUSCH and PUCCH, and for SRS applying the indicated TCI state, is the same as that for a PUSCH transmission scheduled by a RAR UL grant during the initial access procedure.

After a UE receives a higher layer configuration of more than one DLorJoint-TCIState as part of a Reconfiguration with sync procedure as described in TS 38.331 and before applying an indicated TCI state from the configured TCI states, the UE assumes that DM-RS of PDSCH and DM-RS of PDCCH, and the CSI-RS applying the indicated TCI state are quasi co-located with the SS/PBCH block or the CSI-RS resource the UE identified during the random access procedure initiated by the Reconfiguration with sync procedure as described in TS 38.331.

After a UE receives a higher layer configuration of more than one DLorJoint-TCIState or UL-TCIState as part of a Reconfiguration with sync procedure as described in TS 38.331 and before applying an indicated TCI state from the configured TCI states, the UE assumes that the UL TX spatial filter, if applicable, for dynamic-grant and configured-grant based PUSCH and PUCCH, and for SRS applying the indicated TCI state, is the same as that for a PUSCH transmission scheduled by a RAR UL grant during random access procedure initiated by the Reconfiguration with sync procedure as described in TS 38.331.

If a UE receives a higher layer configuration of a single DLorJoint-TCIState, that can be used as an indicated TCI state, the UE obtains the QCL assumptions from the configured TCI state for DM-RS of PDSCH and DM-RS of PDCCH, and the CSI-RS applying the indicated TCI state.

If a UE receives a higher layer configuration of a single DLorJoint-TCIState or UL-TCIState, that can be used as an indicated TCI state, the UE determines an UL TX spatial filter, if applicable, from the configured TCI state for dynamic-grant and configured-grant based PUSCH and PUCCH, and SRS applying the indicated TCI state.

When the UE may transmit the last symbol of a PUCCH with HARQ-ACK information corresponding to the DCI carrying the TCI State indication and without DL assignment, or corresponding to the PDSCH scheduling by the DCI carrying the TCI State indication, and if the indicated TCI State is different from the previously indicated one, the indicated DLorJointTCIState or UL-TCIstate may be applied starting from the first slot that is at least BeamAppTime_r17 symbols after the last symbol of the PUCCH. The first slot and the BeamAppTime_r17 symbols are both determined on the carrier with the smallest SCS among the carrier(s) applying the beam indication.

If a UE is configured with pdsch-TimeDomainAllocationListForMultiPDSCH-r17 in which one or more rows contain multiple SLIVs for PDSCH on a DL BWP of a serving cell, and the UE is receiving a DCI carrying the TCI-State indication and without DL assignment, the UE does not expect that the number of indicated SLIVs in the row of the pdsch-TimeDomainAllocationListForMultiPDSCH-r17 by the DCI is more than one.

If the UE is configured with NumberOfAdditionalPCI and with PDCCH-Config that contains two different values of coresetPoolIndex in ControlResourceSet, the UE receives an activation command for CORESET associated with each coresetPoolIndex, as described in TS 38.321, used to map up to 8 TCI states to the codepoints of the DCI field “Transmission Configuration Indication” in one CC/DL BWP. When a set of TCI state IDs are activated for a coresetPoolIndex, the activated TCI states corresponding to one coresetPoolIndex can be associated with one physical cell ID and activated TCI states corresponding to another coresetPoolIndex can be associated with another physical cell ID.

When a UE supports two TCI states in a codepoint of the DCI field “Transmission Configuration Indication” the UE may receive an activation command, as described in TS 38.321, the activation command is used to map up to 8 combinations of one or two TCI states to the codepoints of the DCI field “Transmission Configuration Indication.” The UE is not expected to receive more than 8 TCI states in the activation command.

When the DCI field “Transmission Configuration Indication” is present in DCI format 1_2 and when the number of codepoints S in the DCI field “Transmission Configuration Indication” of DCI format 1_2 is smaller than the number of TCI codepoints that are activated by the activation command, as described in TS38.321, only the first S activated codepoints are applied for DCI format 1_2.

When the UE may transmit a PUCCH with HARQ-ACK information in slot n corresponding to the PDSCH carrying the activation command, the indicated mapping between TCI states and codepoints of the DCI field “Transmission Configuration Indication” may be applied starting from the first slot that is after slot

$$n + 3 {N}_{s l o t}^{subframe , μ} + \frac{{2}^{μ}}{{2}^{μ} {K}_{mac}} \cdot {k}_{m a c}$$

where m is the SCS configuration for the PUCCH and μ_{K}_{_{mac}} is the subcarrier spacing configuration for k_{mac} with a value of 0 for frequency range 1, and k_{mac} is provided by K-Mac or k_{mac}=0 if K-Mac is not provided. If tci-PresentInDCI is set to “enabled” or tci-PresentDCI-1-2 is configured for the CORESET scheduling the PDSCH, and the time offset between the reception of the DL DCI and the corresponding PDSCH is equal to or greater than timeDurationForQCL if applicable, after a UE receives an initial higher layer configuration of TCI states and before reception of the activation command, the UE may assume that the DM-RS ports of PDSCH of a serving cell are quasi co-located with the SS/PBCH block determined in the initial access procedure with respect to qcl-Type set to “typeA” and when applicable, also with respect to qcl-Type set to “typeD.”

If a UE is configured with the higher layer parameter tci-PresentInDCI that is set as “enabled” for the CORESET scheduling a PDSCH, the UE assumes that the TCI field is present in the DCI format 1_1 of the PDCCH transmitted on the CORESET. If a UE is configured with the higher layer parameter tci-PresentDCI-1-2 for the CORESET scheduling the PDSCH, the UE assumes that the TCI field with a DCI field size indicated by tci-PresentDCI-1-2 is present in the DCI format 1_2 of the PDCCH transmitted on the CORESET. If the PDSCH is scheduled by a DCI format not having the TCI field present, and the time offset between the reception of the DL DCI and the corresponding PDSCH of a serving cell is equal to or greater than a threshold timeDurationForQCL if applicable, where the threshold is based on reported UE capability as illustrated in TS 38.306, for determining PDSCH antenna port quasi co-location, the UE assumes that the TCI state or the QCL assumption for the PDSCH is identical to the TCI state or QCL assumption whichever is applied for the CORESET used for the PDCCH transmission within the active BWP of the serving cell.

When a UE is configured with both sfnSchemePdcch and sfnSchemePdsch scheduled by DCI format 1_0 or by DCI format 1_1/1_2, if the time offset between the reception of the DL DCI and the corresponding PDSCH of a serving cell is equal to or greater than a threshold timeDurationForQCL if applicable: (1) if the UE supports DCI scheduling without TCI field, the UE assumes that the TCI state(s) or the QCL assumption(s) for the PDSCH is identical to the TCI state(s) or QCL assumption(s) whichever is applied for the CORESET used for the reception of the DL DCI within the active BWP of the serving cell regardless of the number of active TCI states of the CORESET. If the UE does not support dynamic switching between SFN PDSCH and non-SFN PDSCH, the UE may be activated with the CORESET with two TCI states; and (2) else if the UE does not support DCI scheduling without TCI field, the UE may expect TCI field present when scheduled by DCI format 1_1/1_2.

When a UE is configured with sfnSchemePdsch and sfnSchemePdcch is not configured, when scheduled by DCI format 1_1/1_2, if the time offset between the reception of the DL DCI and the corresponding PDSCH of a serving cell is equal to or greater than a threshold timeDurationForQCL if applicable, the UE may expect TCI field present.

For PDSCH scheduled by DCI format 1_0, 1_1, 1_2, when a UE is configured with sfnSchemePdcch set to “sfnSchemeA” and sfnSchemePdsch is not configured, and there is no TCI codepoint with two TCI states in the activation command, and if the time offset between the reception of the DL DCI and the corresponding PDSCH is equal or larger than the threshold timeDurationForQCL if applicable and the CORESET which schedules the PDSCH is indicated with two TCI states, the UE assumes that the TCI state or the QCL assumption for the PDSCH is identical to the first TCI state or QCL assumption which is applied for the CORESET used for the PDCCH transmission within the active BWP of the serving cell.

If a PDSCH is scheduled by a DCI format having the TCI field present, the TCI field in DCI in the scheduling component carrier points to the activated TCI states in the scheduled component carrier or DL BWP, the UE may use the TCI-State according to the value of the “Transmission Configuration Indication” field in the detected PDCCH with DCI for determining PDSCH antenna port quasi co-location. The UE may assume that the DM-RS ports of PDSCH of a serving cell are quasi co-located with the RS(s) in the TCI state with respect to the QCL type parameter(s) given by the indicated TCI state if the time offset between the reception of the DL DCI and the corresponding PDSCH is equal to or greater than a threshold timeDurationForQCL, where the threshold is based on reported UE capability as illustrated in TS 38.306. For a single slot PDSCH, the indicated TCI state(s) may be based on the activated TCI states in the slot with the scheduled PDSCH.

For a multi-slot PDSCH or the UE is configured with higher layer parameter pdsch-TimeDomainAllocationListForMultiPDSCH-r17, the indicated TCI state(s) may be based on the activated TCI states in the first slot with the scheduled PDSCH(s), and UE may expect the activated TCI states are the same across the slots with the scheduled PDSCH(s). When the UE is configured with CORESET associated with a search space set for cross-carrier scheduling and the UE is not configured with enableDefaultBeamForCCS, the UE expects tci-PresentInDCI is set as “enabled” or tci-PresentDCI-1-2 is configured for the CORESET, and if one or more of the TCI states configured for the serving cell scheduled by the search space set contains qcl-Type set to “typeD,” the UE expects the time offset between the reception of the detected PDCCH in the search space set and a corresponding PDSCH is larger than or equal to the threshold timeDurationForQCL.

Independent of the configuration of tci-PresentInDCI and tci-PresentDCI-1-2 in RRC connected mode, if the offset between the reception of the DL DCI and the corresponding PDSCH is less than the threshold timeDurationForQCL and at least one configured TCI state for the serving cell of scheduled PDSCH contains qcl-Type set to “typeD,” one of following examples is performed.

In one example, the UE may assume that the DM-RS ports of PDSCH(s) of a serving cell are quasi co-located with the RS(s) with respect to the QCL parameter(s) used for PDCCH quasi co-location indication of the CORESET associated with a monitored search space with the lowest controlResourceSetId in the latest slot in which one or more CORESETs within the active BWP of the serving cell are monitored by the UE. In this case, if the qcl-Type is set to “typeD” of the PDSCH DM-RS is different from that of the PDCCH DM-RS with which they overlap in at least one symbol, the UE is expected to prioritize the reception of PDCCH associated with that CORESET. This also applies to the intra-band CA case (when PDSCH and the CORESET are in different component carriers).

In one example, if a UE is configured with enableDefaultTCI-StatePerCoresetPoolIndex and the UE is configured by higher layer parameter PDCCH-Config that contains two different values of coresetPoolIndex in different ControlResourceSets.

In such examples, the UE may assume that the DM-RS ports of PDSCH associated with a value of coresetPoolIndex of a serving cell are quasi co-located with the RS(s) with respect to the QCL parameter(s) used for PDCCH quasi co-location indication of the CORESET associated with a monitored search space with the lowest controlResourceSetId among CORESETs, which are configured with the same value of coresetPoolIndex as the PDCCH scheduling that PDSCH, in the latest slot in which one or more CORESETs associated with the same value of coresetPoolIndex as the PDCCH scheduling that PDSCH within the active BWP of the serving cell are monitored by the UE. In this case, if the “QCL-TypeD” of the PDSCH DM-RS is different from that of the PDCCH DM-RS with which they overlap in at least one symbol and they are associated with same value of coresetPoolIndex, the UE is expected to prioritize the reception of PDCCH associated with that CORESET. This also applies to the intra-band CA case (when PDSCH and the CORESET are in different component carriers).

In one example, if a UE is configured with enableTwoDefaultTCI-States, and at least one TCI codepoint indicates two TCI states, the UE may assume that the DM-RS ports of PDSCH or PDSCH transmission occasions of a serving cell are quasi co-located with the RS(s) with respect to the QCL parameter(s) associated with the TCI states corresponding to the lowest codepoint among the TCI codepoints containing two different TCI states. When the UE is configured by higher layer parameter repetitionScheme set to “tdmSchemeA” or is configured with higher layer parameter repetitionNumber, and the offset between the reception of the DL DCI and the first PDSCH transmission occasion is less than the threshold timeDurationForQCL, the mapping of the TCI states to PDSCH transmission occasions is determined according to TS 38.214 by replacing the indicated TCI states with the TCI states corresponding to the lowest codepoint among the TCI codepoints containing two different TCI states based on the activated TCI states in the slot with the first PDSCH transmission occasion. In this case, if the “QCL-TypeD” in both of the TCI states corresponding to the lowest codepoint among the TCI codepoints containing two different TCI states is different from that of the PDCCH DM-RS with which they overlap in at least one symbol, the UE is expected to prioritize the reception of PDCCH associated with that CORESET. This also applies to the intra-band CA case (when PDSCH and the CORESET are in different component carriers).

In one example, if a UE is not configured with sfnSchemePdsch, and the UE is configured with sfnSchemePdcch set to “sfnSchemeA” and there is no TCI codepoint with two TCI states in the activation command and the CORESET with the lowest ID in the latest slot is indicated with two TCI states, the UE may assume that the DM-RS ports of PDSCH of a serving cell are quasi co-located with the RS(s) with respect to the QCL parameter(s) associated with the first TCI state of two TCI states indicated for the CORESET.

In one example, in all cases above, if none of configured TCI states for the serving cell of scheduled PDSCH is configured with qcl-Type set to “typeD,” the UE may obtain the other QCL assumptions from the indicated TCI state(s) for its scheduled PDSCH irrespective of the time offset between the reception of the DL DCI and the corresponding PDSCH.

If the PDCCH carrying the scheduling DCI is received on one component carrier, and a PDSCH scheduled by that DCI is on another component carrier: (1) the timeDurationForQCL is determined based on the subcarrier spacing of the scheduled PDSCH. If μ_{PDCCH}<μ_{PDSCH} an additional timing delay d

$$\frac{{2}^{μ} P D S C H}{{2}^{μ} P D C C H}$$

is added to the timeDurationForQCL, where d is defined in TS 38.214, otherwise d is zero; and (2) when the UE is configured with enableDefaultBeamForCCS, if the offset between the reception of the DL DCI and the corresponding PDSCH is less than the threshold timeDurationForQCL, or if the DL DCI does not have the TCI field present, the UE obtains its QCL assumption for the scheduled PDSCH from the activated TCI state with the lowest ID applicable to PDSCH in the active BWP of the scheduled cell.

A UE that has indicated a capability beamCorrespondenceWithoutUL-BeamSweeping set to “1,” as described in TS 38.822, can determine a spatial domain filter to be used while performing the applicable channel access procedures described in TS 37.213 to transmit a UL transmission on the channel as follows: (1) if UE is indicated with an SRI corresponding to the UL transmission, the UE may use a spatial domain filter that is same as the spatial domain transmission filter associated with the indicated SRI and (2) if UE is configured with TCI-State configurations with DLorJointTCIState or UL-TCIState, the UE may use a spatial domain transmit filter that is same as the spatial domain receive filter the UE may use to receive the DL reference signal associated with the indicated TCI state.

When the PDCCH reception includes two PDCCH from two respective search space sets, as described in TS 38.213, for the purpose of determining the time offset between the reception of the DL DCI and the corresponding PDSCH, the PDCCH candidate that ends later in time is used. When the PDCCH reception includes two PDCCH candidates from two respective search space sets, as described in TS 38.213, for the configuration of tci-PresentInDCI or tci-PresentDCI-1-2, the UE expects the same configuration in the first and second CORESETs associated with the two PDCCH candidates; and if the PDSCH is scheduled by a DCI format not having the TCI field present and if the scheduling offset is equal to or larger than timeDurationForQCL, if applicable, PDSCH QCL assumption is based on the CORESET with lower ID among the first and second CORESETs associated with the two PDCCH candidates.

For a periodic CSI-RS resource in an NZP-CSI-RS-ResourceSet configured with higher layer parameter trs-Info, the UE may expect that a TCI-State indicates one of the following quasi co-location type(s): (1) “typeC” with an SS/PBCH block and, when applicable, “typeD” with the same SS/PBCH block or (2) “typeC” with an SS/PBCH block and, when applicable, “typeD” with a CSI-RS resource in an NZP-CSI-RS-ResourceSet configured with higher layer parameter repetition.

For periodic/semi-persistent CSI-RS, the UE can assume that the indicated DLorJointTCIState is not applied.

For an aperiodic CSI-RS resource in an NZP-CSI-RS-ResourceSet configured with higher layer parameter trs-Info, the UE may expect that a TCI-State indicates qcl-Type set to “typeA” with a periodic CSI-RS resource in a NZP-CSI-RS-ResourceSet configured with higher layer parameter trs-Info and, when applicable, qcl-Type set to “typeD” with the same periodic CSI-RS resource.

For a CSI-RS resource in an NZP-CSI-RS-ResourceSet configured without higher layer parameter trs-Info and without the higher layer parameter repetition, the UE may expect that a TCI-State indicates one of the following quasi co-location type(s): (1) “typeA” with a CSI-RS resource in a NZP-CSI-RS-ResourceSet configured with higher layer parameter trs-Info and, when applicable, “typeD” with the same CSI-RS resource; (2) “typeA” with a CSI-RS resource in a NZP-CSI-RS-ResourceSet configured with higher layer parameter trs-Info and, when applicable, “typeD” with an SS/PBCH block; (3) “typeA” with a CSI-RS resource in a NZP-CSI-RS-ResourceSet configured with higher layer parameter trs-Info and, when applicable, “typeD” with a CSI-RS resource in a NZP-CSI-RS-ResourceSet configured with higher layer parameter repetition, or (4) “typeB” with a CSI-RS resource in a NZP-CSI-RS-ResourceSet configured with higher layer parameter trs-Info when “typeD” is not applicable.

For a CSI-RS resource in an NZP-CSI-RS-ResourceSet configured with higher layer parameter repetition, the UE may expect that a TCI-State indicates one of the following quasi co-location type(s): (1) “typeA” with a CSI-RS resource in a NZP-CSI-RS-ResourceSet configured with higher layer parameter trs-Info and, when applicable, “typeD” with the same CSI-RS resource; (2) “typeA” with a CSI-RS resource in a NZP-CSI-RS-ResourceSet configured with higher layer parameter trs-Info and, when applicable, “typeD” with a CSI-RS resource in a NZP-CSI-RS-ResourceSet configured with higher layer parameter repetition, or (3) “typeC” with an SS/PBCH block and, when applicable, “typeD” with the same SS/PBCH block, the reference RS may additionally be an SS/PBCH block having a PCI different from the PCI of the serving cell. The UE can assume center frequency, SCS, SFN offset are the same for SS/PBCH block from the serving cell and SS/PBCH block having a PCI different from the serving cell.

For the DM-RS of PDCCH, the UE may expect that a TCI-State or DLorJointTCIState except an indicated DLorJointTCIState indicates one of the following quasi co-location type(s): (1) “typeA” with a CSI-RS resource in a NZP-CSI-RS-ResourceSet configured with higher layer parameter trs-Info and, when applicable, “typeD” with the same CSI-RS resource; (2) “typeA” with a CSI-RS resource in a NZP-CSI-RS-ResourceSet configured with higher layer parameter trs-Info and, when applicable, “typeD” with a CSI-RS resource in an NZP-CSI-RS-ResourceSet configured with higher layer parameter repetition; or (3) “typeA” with a CSI-RS resource in a NZP-CSI-RS-ResourceSet configured without higher layer parameter trs-Info and without higher layer parameter repetition and, when applicable, “typeD” with the same CSI-RS resource.

When a UE is configured with sfnSchemePdcch set to “sfnSchemeA,” and CORESET is activated with two TCI states, the UE may assume that the DM-RS port(s) of the PDCCH in the CORESET is quasi co-located with the DL-RSs of the two TCI states. When a UE is configured with sfnSchemePdcch set to “sfnSchemeB,” and a CORESET is activated with two TCI states, the UE may assume that the DM-RS port(s) of the PDCCH is quasi co-located with the DL-RSs of the two TCI states except for quasi co-location parameters {Doppler shift, Doppler spread} of the second indicated TCI state.

For the DM-RS of PDSCH, the UE may expect that a TCI-State or DLorJointTCIState except an indicated DLorJointTCIState indicates one of the following quasi co-location type(s): (1) “typeA” with a CSI-RS resource in a NZP-CSI-RS-ResourceSet configured with higher layer parameter trs-Info and, when applicable, “typeD” with the same CSI-RS resource; (2) “typeA” with a CSI-RS resource in a NZP-CSI-RS-ResourceSet configured with higher layer parameter trs-Info and, when applicable, “typeD” with a CSI-RS resource in an NZP-CSI-RS-ResourceSet configured with higher layer parameter repetition, or (3) “typeA” with a CSI-RS resource in a NZP-CSI-RS-ResourceSet configured without higher layer parameter trs-Info and without higher layer parameter repetition and, when applicable, “typeD” with the same CSI-RS resource

For the DM-RS of PDCCH, the UE may expect that an indicated DLorJointTCIState indicates one of the following quasi co-location type(s): (1) “typeA” with a CSI-RS resource in a NZP-CSI-RS-ResourceSet configured with higher layer parameter trs-Info and, when applicable, “typeD” with the same CSI-RS resource or (2) “typeA” with a CSI-RS resource in a NZP-CSI-RS-ResourceSet configured with higher layer parameter trs-Info and, when applicable, “typeD” with a CSI-RS resource in an NZP-CSI-RS-ResourceSet configured with higher layer parameter repetition.

For the DM-RS of PDSCH, the UE may expect that an indicated DLorJointTCIState indicates one of the following quasi co-location type(s) if the UE is configured TCI-State(s) with tci-StateId_r17: (1) “typeA” with a CSI-RS resource in a NZP-CSI-RS-ResourceSet configured with higher layer parameter trs-Info and, when applicable, “typeD” with the same CSI-RS resourc or (2) “typeA” with a CSI-RS resource in a NZP-CSI-RS-ResourceSet configured with higher layer parameter trs-Info and, when applicable, “typeD” with a CSI-RS resource in an NZP-CSI-RS-ResourceSet configured with higher layer parameter repetition.

When a UE is configured with sfnSchemePdsch set to “sfnSchemeA,” and the UE is indicated with two TCI states in a codepoint of the DCI field “Transmission Configuration Indication” in a DCI scheduling a PDSCH, the UE may assume that the DM-RS port(s) of the PDSCH is quasi co-located with the DL-RSs of the two TCI states. When a UE is configured with sfnSchemePdsch set to “sfnSchemeB,” and the UE is indicated with two TCI states in a codepoint of the DCI field “Transmission Configuration Indication” in a DCI scheduling a PDSCH, the UE may assume that the DM-RS port(s) of the PDSCH is quasi co-located with the DL-RSs of the two TCI states except for quasi co-location parameters {Doppler shift, Doppler spread} of the second indicated TCI state.

Throughout the present disclosure, the joint (e.g., provided by DLorJoint-TCIState), separate DL (e.g., provided by DLorJoint-TCIState) and/or separate UL (e.g., provided by UL-TCIState) TCI states described/discussed above could also be referred to as unified TCI states, common TCI states, main TCI states and etc. Furthermore, an indicator/parameter set to “1” (or “0,” “00,” “01,” “10,” or “11”) could also correspond to or be equivalent to the indicator/parameter set to “enabled,” and an indicator/parameter set to “0” (or “1,” “00,” “01,” “10,” or “11”) could also correspond to or be equivalent to the indicator/parameter set to “disabled.” In addition, throughout the present disclosure, the following two operations are equivalent: (1) a UE uses/applies a TCI state to receive a channel/signal and (2) the UE assumes the DM-RS antenna port(s) of the channel/signal is quasi co-located with the RS(s) in the RS set(s) provided/indicated/configured in the TCI state. Also, a PDSCH can be a scheduled PDSCH (e.g., by the corresponding scheduling DCI) or a configured PDSCH.

As discussed herein in the present disclosure, a UE could receive a MAC CE activation command, e.g., Unified TCI states activation/deactivation MAC CE command, used to map up to Ncp≥1 (e.g., Ncp=8 or Ncp=16) TCI codepoints of a TCI field in a beam indication DCI (e.g., DCI format 1_1/1_2 with or without DL assignment), wherein a TCI codepoint could contain/comprise/include one or more, e.g., N≥1 or M≥1 (e.g., N=2 or M=2), TCI states or pairs of TCI states, and a TCI state could correspond to a joint TCI state provided by DLorJointTCIState, a separate DL TCI state provided by DLorJointTCIState, or a separate UL TCI state provided by UL-TCIState.

In one embodiment, the UE could be provided/indicated/configured by the network, in a higher layer parameter, e.g., ControlResourceSet for a CORESET, an indicator/parameter to inform the UE the association between the indicated TCI state(s) and the PDSCH reception(s), wherein different CORESETs configured with the same indicator/parameter could be in a same CORESET group.

In one example, for N=2 or M=2, the UE could apply/use the first (or second) indicated TCI state/pair of TCI states to monitor PDCCH candidate(s) received in CORESET(s) associated/configured with the indicator/parameter in the corresponding ControlResourceSet set to “0” (or equivalently, the UE could assume that the DM-RS antenna port(s) of the PDCCH received in CORESET(s) associated/configured with the indicator/parameter in the corresponding ControlResourceSet set to “0” is quasi co-located with the RS(s) in the RS set(s) provided/indicated/configured in the first (or second) indicated TCI state/pair of TCI states), and the UE could apply/use the second (or first) indicated TCI state/pair of TCI states to monitor PDCCH candidate(s) received in CORESET(s) associated/configured with the indicator/parameter in the corresponding ControlResourceSet set to “1” (or equivalently, the UE could assume that the DM-RS antenna port(s) of the PDCCH received in CORESET(s) associated/configured with the indicator/parameter in the corresponding ControlResourceSet set to “1” is quasi co-located with the RS(s) in the RS set(s) provided/indicated/configured in the second (or first) indicated TCI state/pair of TCI states).

In another example, for N=2 or M=2, the UE could apply/use the first indicated TCI state/pair of TCI states to monitor first PDCCH candidate(s) received in CORESET(s) associated/configured with the indicator/parameter in the corresponding ControlResourceSet set to “0” (or “1”) and the second indicated TCI state/pair of TCI states to monitor second PDCCH candidate(s) received in CORESET(s) associated/configured with the indicator/parameter in the corresponding ControlResourceSet set to “0” (or “1”). The UE could apply/use the second indicated TCI state/pair of TCI states to monitor first PDCCH candidate(s) received in CORESET(s) associated/configured with the indicator/parameter in the corresponding ControlResourceSet set to “1” (or “0”) and the first indicated TCI state/pair of TCI states to monitor second PDCCH candidate(s) received in CORESET(s) associated/configured with the indicator/parameter in the corresponding ControlResourceSet set to “1” (or “0”).

In yet another example, for N=2 or M=2, the UE could apply/use the first (or second) indicated TCI state/pair of TCI states to monitor PDCCH candidate(s) received in CORESET(s) associated/configured with the indicator/parameter in the corresponding ControlResourceSet set to “00” (“01,” “10,” or “11”)—or equivalently, the UE could assume that the DM-RS antenna port(s) of the PDCCH received in CORESET(s) associated/configured with the indicator/parameter in the corresponding ControlResourceSet set to “00” (“01,” “10,” or “11”) is quasi co-located with the RS(s) in the RS set(s) provided/indicated/configured in the first (or second) indicated TCI state/pair of TCI states, the UE could apply/use the second (or first) indicated TCI state/pair of TCI states to monitor PDCCH candidate(s) received in CORESET(s) associated/configured with the indicator/parameter in the corresponding ControlResourceSet set to “01” (“00,” “10,” or “11”)—or equivalently, the UE could assume that the DM-RS antenna port(s) of the PDCCH received in CORESET(s) associated/configured with the indicator/parameter in the corresponding ControlResourceSet set to “01” (“00,” “10,” or “11”) is quasi co-located with the RS(s) in the RS set(s) provided/indicated/configured in the second (or first) indicated TCI state/pair of TCI states), the UE could apply/use the first indicated TCI state/pair of TCI states to monitor first PDCCH candidate(s) received in CORESET(s) associated/configured with the indicator/parameter in the corresponding ControlResourceSet set to “10” (“00,” “01,” or “11”) and the second indicated TCI state/pair of TCI states to monitor second PDCCH candidate(s) received in CORESET(s) associated/configured with the indicator/parameter in the corresponding ControlResourceSet set to “10” (“00,” “01,” or “11”), or the UE could apply/use the second indicated TCI state/pair of TCI states to monitor first PDCCH candidate(s) received in CORESET(s) associated/configured with the indicator/parameter in the corresponding ControlResourceSet set to “11” (“00,” “01,” or “10”) and the first indicated TCI state/pair of TCI states to monitor second PDCCH candidate(s) received in CORESET(s) associated/configured with the indicator/parameter in the corresponding ControlResourceSet set to “11” (“00,” “01,” or “10”).

In yet another example, for N=2 or M=2, when/if the beam indication DCI is received in CORESET(s) associated/configured with the indicator/parameter in the corresponding ControlResourceSet set to “0,” the UE could apply/use the first (or second) indicated TCI state/pair of TCI states to monitor PDCCH candidate(s), wherein the PDCCH candidate(s) could be received in any CORESET(s) or CORESET(s) not associated/configured with the indicator/parameter specified/defined herein in the present disclosure (e.g., in the corresponding ControlResourceSet) or CORESET(s) associated/configured with the indicator/parameter in the corresponding ControlResourceSet set to “0” or “1,” and when/if the beam indication DCI is received in CORESET(s) associated/configured with the indicator/parameter in the corresponding ControlResourceSet set to “1,” the UE could apply/use the second (or first) indicated TCI state/pair of TCI states to monitor PDCCH candidate(s), wherein the PDCCH candidate(s) could be received in any CORESET(s) or CORESET(s) not associated/configured with the indicator/parameter specified/defined herein in the present disclosure (e.g., in the corresponding ControlResourceSet) or CORESET(s) associated/configured with the indicator/parameter in the corresponding ControlResourceSet set to “0” or “1.”

In yet another example, for N=2 or M=2, when/if the beam indication DCI is received in CORESET(s) associated/configured with the indicator/parameter in the corresponding ControlResourceSet set to “0” (or “1”), the UE could apply/use the first indicated TCI state/pair of TCI states to monitor first PDCCH candidate(s) and the second indicated TCI state/pair of TCI states to monitor second PDCCH candidate(s), wherein the first and/or second PDCCH candidate(s) could be received in any CORESET(s) or CORESET(s) not associated/configured with the indicator/parameter specified/defined herein in the present disclosure (e.g., in the corresponding ControlResourceSet) or CORESET(s) associated/configured with the indicator/parameter in the corresponding ControlResourceSet set to “0” or “1,” and when/if the beam indication DCI is received in CORESET(s) associated/configured with the indicator/parameter in the corresponding ControlResourceSet set to “1” (or “0”), the UE could apply/use the second indicated TCI state/pair of TCI states to monitor the first PDCCH candidate(s) and the first indicated TCI state/pair of TCI states to monitor the second PDCCH candidate(s), wherein the first and/or second PDCCH candidate(s) could be received in any CORESET(s) or CORESET(s) not associated/configured with the indicator/parameter specified/defined herein in the present disclosure (e.g., in the corresponding ControlResourceSet) or CORESET(s) associated/configured with the indicator/parameter in the corresponding ControlResourceSet set to “0” or “1.”

In yet another example, for N=2 or M=2, when/if the beam indication DCI is received in CORESET(s) associated/configured with the indicator/parameter in the corresponding ControlResourceSet set to “00” (“01,” “10,” or “11”), the UE could apply/use the first (or second) indicated TCI state/pair of TCI states to monitor PDCCH candidate(s), wherein the PDCCH candidate(s) could be received in any CORESET(s) or CORESET(s) not associated/configured with the indicator/parameter specified/defined herein in the present disclosure (e.g., in the corresponding ControlResourceSet) or CORESET(s) associated/configured with the indicator/parameter in the corresponding ControlResourceSet set to “00,” “01,” “10,” or “11,” when/if the beam indication DCI is received in CORESET(s) associated/configured with the indicator/parameter in the corresponding ControlResourceSet set to “01” (“00,” “10,” or “11”), the UE could apply/use the second (or first) indicated TCI state/pair of TCI states to monitor PDCCH candidate(s), wherein the PDCCH candidate(s) could be received in any CORESET(s) or CORESET(s) not associated/configured with the indicator/parameter specified/defined herein in the present disclosure (e.g., in the corresponding ControlResourceSet) or CORESET(s) associated/configured with the indicator/parameter in the corresponding ControlResourceSet set to “00,” “01,” “10,” or “11,” when/if the beam indication DCI is received in CORESET(s) associated/configured with the indicator/parameter in the corresponding ControlResourceSet set to “10” (“00,” “01,” or “11”), the UE could apply/use the first indicated TCI state/pair of TCI states to monitor first PDCCH candidate(s) and the second indicated TCI state/pair of TCI states to monitor second PDCCH candidate(s), wherein the first and/or second PDCCH candidate(s) could be received in any CORESET(s) or CORESET(s) not associated/configured with the indicator/parameter specified/defined herein in the present disclosure (e.g., in the corresponding ControlResourceSet) or CORESET(s) associated/configured with the indicator/parameter in the corresponding ControlResourceSet set to “00,” “01,” “10,” or “11,” and when/if the beam indication DCI is received in CORESET(s) associated/configured with the indicator/parameter in the corresponding ControlResourceSet set to “11” (“00,” “01,” or “10”), the UE could apply/use the second indicated TCI state/pair of TCI states to monitor the first PDCCH candidate(s) and the first indicated TCI state/pair of TCI states to monitor the second PDCCH candidate(s), wherein the first and/or second PDCCH candidate(s) could be received in any CORESET(s) or CORESET(s) not associated/configured with the indicator/parameter specified/defined herein in the present disclosure (e.g., in the corresponding ControlResourceSet) or CORESET(s) associated/configured with the indicator/parameter in the corresponding ControlResourceSet set to “00,” “01,” “10,” or “11.”

The UE could first follow one or more of the design examples (e.g., the design as shown in examples of the present disclosure) specified/discussed herein in the present disclosure to determine the association between the indicated TCI state(s) and the PDCCH reception(s). The UE could then follow one or more of the design examples (e.g., the design as shown in examples of the present disclosure) specified/discussed herein in the present disclosure to determine the association between the indicated TCI state(s) and the PDCCH reception(s) according to/based on one or more events, or one or more conditions discussed/specified herein.

In one example, for N=2 or M=2, the UE could monitor category-1 PDCCH candidate(s) received in CORESET(s) associated/configured with the indicator/parameter in the corresponding ControlResourceSet set to “0,” “1,” “00,” “01,” “10,” or “11,” and the UE could monitor category-2 PDCCH candidate(s) received in CORESET(s) not associated/configured with the indicator/parameter specified/defined herein in the present disclosure (e.g., in the corresponding ControlResourceSet).

The UE could apply/use the first (or second) indicated TCI state/pair of TCI states to monitor the category-1 PDCCH candidate(s) received in CORESET(s) associated/configured with the indicator/parameter in the corresponding ControlResourceSet set to “0” (or equivalently, the UE could assume that the DM-RS antenna port(s) of the category-1 PDCCH candidate(s) received in CORESET(s) associated/configured with the indicator/parameter in the corresponding ControlResourceSet set to “0” is quasi co-located with the RS(s) in the RS set(s) provided/indicated/configured in the first (or second) indicated TCI state/pair of TCI states), and the UE could apply/use the second (or first) indicated TCI state/pair of TCI states to monitor the category-1 PDCCH candidate(s) received in CORESET(s) associated/configured with the indicator/parameter in the corresponding ControlResourceSet set to “1” (or equivalently, the UE could assume that the DM-RS antenna port(s) of the category-1 PDCCH candidate(s) received in CORESET(s) associated/configured with the indicator/parameter in the corresponding ControlResourceSet set to “1” is quasi co-located with the RS(s) in the RS set(s) provided/indicated/configured in the second (or first) indicated TCI state/pair of TCI states).

For the category-2 PDCCH candidate(s), following examples can be provided.

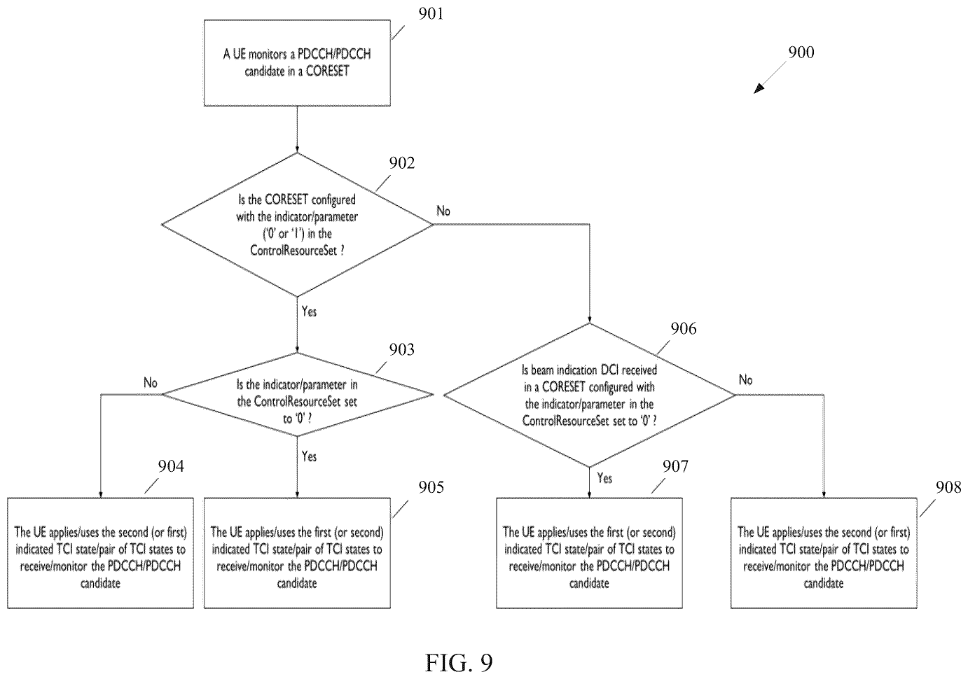

In one example, when/if the beam indication DCI is received in CORESET(s) associated/configured with the indicator/parameter in the corresponding ControlResourceSet set to “0,” the UE could apply/use the first (or second) indicated TCI state/pair of TCI states to monitor the category-2 PDCCH candidate(s), and when/if the beam indication DCI is received in CORESET(s) associated/configured with the indicator/parameter in the corresponding ControlResourceSet set to “1,” the UE could apply/use the second (or first) indicated TCI state/pair of TCI states to monitor the category-2 PDCCH candidate(s). In FIG. 9, an example algorithm flowchart characterizing the above discussed TCI state(s) and PDCCH candidate(s) association is provided.

FIG. 9 illustrates a flowchart of UE procedure 900 for determining TCI states for monitoring PDCCH candidates according to embodiments of the present disclosure. For example, the UE procedure 900 as may be performed by a UE such as 111-116 as illustrated in FIG. 1). An embodiment of the UE procedure 900 shown in FIG. 9 is for illustration only. One or more of the components illustrated in FIG. 9 can be implemented in specialized circuitry configured to perform the noted functions or one or more of the components can be implemented by one or more processors executing instructions to perform the noted functions.

As illustrated in FIG. 9, the UE procedures begins at step 901. In step 901, a UE monitors a PDCCH/PDCCH candidate in a CORESET. In step 902, the UE determines if the CORESET is configured with the indicator/parameters. In step 903, the UE determines if the indicator/parameter is set. In step 904, the UE applies the second indicated TCI state/pair of TCI states to receive the PDCCH/PDCCH candidate. In step 905, the UE applies the first indicated TCI stat of TCI states to receiver the PDCCH/PDCCH candidate. In step 906, the UE determines if beam indication DCI is received in a CORESET. In step 907, the UE applies the first indicated TCI state of TCI states to receive the PDCCH/PDCCH candidate. In step 908, the UE applies the second indicated TCI state of TCI states to receive the PDCCH/PDCCH candidate.

In another example, when/if the beam indication DCI is received in CORESET(s) associated/configured with the indicator/parameter in the corresponding ControlResourceSet set to “0” (or “1”), the UE could apply/use the first indicated TCI state/pair of TCI states to monitor first category-2 PDCCH candidate(s) and the second indicated TCI state/pair of TCI states to monitor second category-2 PDCCH candidate(s), and when/if the beam indication DCI is received in CORESET(s) associated/configured with the indicator/parameter in the corresponding ControlResourceSet set to “1” (or “0”), the UE could apply/use the second indicated TCI state/pair of TCI states to monitor the first category-2 PDCCH candidate(s) and the first indicated TCI state/pair of TCI states to monitor the second category-2 PDCCH candidate(s).

In yet another example, when/if the beam indication DCI is received in CORESET(s) associated/configured with the indicator/parameter in the corresponding ControlResourceSet set to “00” (“01,” “10,” or “11”), the UE could apply/use the first (or second) indicated TCI state/pair of TCI states to monitor category-2 PDCCH candidate(s), when/if the beam indication DCI is received in CORESET(s) associated/configured with the indicator/parameter in the corresponding ControlResourceSet set to “01” (“00,” “10,” or “11”), the UE could apply/use the second (or first) indicated TCI state/pair of TCI states to monitor category-2 PDCCH candidate(s), when/if the beam indication DCI is received in CORESET(s) associated/configured with the indicator/parameter in the corresponding ControlResourceSet set to “10” (“00,” “01,” or “11”), the UE could apply/use the first indicated TCI state/pair of TCI states to monitor first category-2 PDCCH candidate(s) and the second indicated TCI state/pair of TCI states to monitor second category-2 PDCCH candidate(s), and when/if the beam indication DCI is received in CORESET(s) associated/configured with the indicator/parameter in the corresponding ControlResourceSet set to “11” (“00,” “01,” or “10”), the UE could apply/use the second indicated TCI state/pair of TCI states to monitor the first category-2 PDCCH candidate(s) and the first indicated TCI state/pair of TCI states to monitor the second category-2 PDCCH candidate(s).

In another example, for N=2 or M=2, the UE could monitor category-1 PDCCH candidate(s) received in CORESET(s) associated/configured with the indicator/parameter in the corresponding ControlResourceSet set to “0,” “1,” “00,” “01,” “10,” or “11,” and the UE could monitor category-2 PDCCH candidate(s) received in CORESET(s) not associated/configured with the indicator/parameter specified/defined herein in the present disclosure (e.g., in the corresponding ControlResourceSet). The UE could apply/use the first indicated TCI state/pair of TCI states to monitor first category-1 PDCCH candidate(s) received in CORESET(s) associated/configured with the indicator/parameter in the corresponding ControlResourceSet set to “0” (or “1”) and the second indicated TCI state/pair of TCI states to monitor second category-1 PDCCH candidate(s) received in CORESET(s) associated/configured with the indicator/parameter in the corresponding ControlResourceSet set to “0” (or “1”).

The UE could apply/use the second indicated TCI state/pair of TCI states to monitor first category-1 PDCCH candidate(s) received in CORESET(s) associated/configured with the indicator/parameter in the corresponding ControlResourceSet set to “1” (or “0”) and the first indicated TCI state/pair of TCI states to monitor second category-1 PDCCH candidate(s) received in CORESET(s) associated/configured with the indicator/parameter in the corresponding ControlResourceSet set to “1” (or “0”).

For example, when/if the beam indication DCI is received in CORESET(s) associated/configured with the indicator/parameter in the corresponding ControlResourceSet set to “0,” the UE could apply/use the first (or second) indicated TCI state/pair of TCI states to monitor the category-2 PDCCH candidate(s), and when/if the beam indication DCI is received in CORESET(s) associated/configured with the indicator/parameter in the corresponding ControlResourceSet set to “1,” the UE could apply/use the second (or first) indicated TCI state/pair of TCI states to monitor the category-2 PDCCH candidate(s).

For another example, when/if the beam indication DCI is received in CORESET(s) associated/configured with the indicator/parameter in the corresponding ControlResourceSet set to “0” (or “1”), the UE could apply/use the first indicated TCI state/pair of TCI states to monitor first category-2 PDCCH candidate(s) and the second indicated TCI state/pair of TCI states to monitor second category-2 PDCCH candidate(s), and when/if the beam indication DCI is received in CORESET(s) associated/configured with the indicator/parameter in the corresponding ControlResourceSet set to “1” (or “0”), the UE could apply/use the second indicated TCI state/pair of TCI states to monitor the first category-2 PDCCH candidate(s) and the first indicated TCI state/pair of TCI states to monitor the second category-2 PDCCH candidate(s).

Yet for another example, when/if the beam indication DCI is received in CORESET(s) associated/configured with the indicator/parameter in the corresponding ControlResourceSet set to “00” (“01,” “10,” or “11”), the UE could apply/use the first (or second) indicated TCI state/pair of TCI states to monitor category-2 PDCCH candidate(s), when/if the beam indication DCI is received in CORESET(s) associated/configured with the indicator/parameter in the corresponding ControlResourceSet set to “01” (“00,” “10,” or “11”), the UE could apply/use the second (or first) indicated TCI state/pair of TCI states to monitor category-2 PDCCH candidate(s), when/if the beam indication DCI is received in CORESET(s) associated/configured with the indicator/parameter in the corresponding ControlResourceSet set to “10” (“00,” “01,” or “11”), the UE could apply/use the first indicated TCI state/pair of TCI states to monitor first category-2 PDCCH candidate(s) and the second indicated TCI state/pair of TCI states to monitor second category-2 PDCCH candidate(s), and when/if the beam indication DCI is received in CORESET(s) associated/configured with the indicator/parameter in the corresponding ControlResourceSet set to “11” (“00,” “01,” or “10”), the UE could apply/use the second indicated TCI state/pair of TCI states to monitor the first category-2 PDCCH candidate(s) and the first indicated TCI state/pair of TCI states to monitor the second category-2 PDCCH candidate(s).

In yet another example, for N=2 or M=2, the UE could monitor category-1 PDCCH candidate(s) received in CORESET(s) associated/configured with the indicator/parameter in the corresponding ControlResourceSet set to “0,” “1,” “00,” “01,” “10,” or “11,” and the UE could monitor category-2 PDCCH candidate(s) received in CORESET(s) not associated/configured with the indicator/parameter specified/defined herein in the present disclosure (e.g., in the corresponding ControlResourceSet).

The UE could apply/use the first (or second) indicated TCI state/pair of TCI states to monitor category-1 PDCCH candidate(s) received in CORESET(s) associated/configured with the indicator/parameter in the corresponding ControlResourceSet set to “00” (“01,” “10” or “11”)—or equivalently, the UE could assume that the DM-RS antenna port(s) of the category-1 PDCCH received in CORESET(s) associated/configured with the indicator/parameter in the corresponding ControlResourceSet set to “00” (“01,” “10,” or “11”) is quasi co-located with the RS(s) in the RS set(s) provided/indicated/configured in the first (or second) indicated TCI state/pair of TCI states, the UE could apply/use the second (or first) indicated TCI state/pair of TCI states to monitor category-1 PDCCH candidate(s) received in CORESET(s) associated/configured with the indicator/parameter in the corresponding ControlResourceSet set to “01” (“00,” “10,” or “11”)—or equivalently, the UE could assume that the DM-RS antenna port(s) of the category-1 PDCCH received in CORESET(s) associated/configured with the indicator/parameter in the corresponding ControlResourceSet set to “01” (“00,” “10,” or “11”) is quasi co-located with the RS(s) in the RS set(s) provided/indicated/configured in the second (or first) indicated TCI state/pair of TCI states), the UE could apply/use the first indicated TCI state/pair of TCI states to monitor first category-1 PDCCH candidate(s) received in CORESET(s) associated/configured with the indicator/parameter in the corresponding ControlResourceSet set to “10” (“00,” “01,” or “11”) and the second indicated TCI state/pair of TCI states to monitor second category-1 PDCCH candidate(s) received in CORESET(s) associated/configured with the indicator/parameter in the corresponding ControlResourceSet set to “10” (“00,” “01,” or “11”), or the UE could apply/use the second indicated TCI state/pair of TCI states to monitor first category-1 PDCCH candidate(s) received in CORESET(s) associated/configured with the indicator/parameter in the corresponding ControlResourceSet set to “11” (“00,” “01,” or “10”) and the first indicated TCI state/pair of TCI states to monitor second category-1 PDCCH candidate(s) received in CORESET(s) associated/configured with the indicator/parameter in the corresponding ControlResourceSet set to “11” (“00,” “01,” or “10”).

For example, when/if the beam indication DCI is received in CORESET(s) associated/configured with the indicator/parameter in the corresponding ControlResourceSet set to “0,” the UE could apply/use the first (or second) indicated TCI state/pair of TCI states to monitor the category-2 PDCCH candidate(s), and when/if the beam indication DCI is received in CORESET(s) associated/configured with the indicator/parameter in the corresponding ControlResourceSet set to “1,” the UE could apply/use the second (or first) indicated TCI state/pair of TCI states to monitor the category-2 PDCCH candidate(s).

For another example, when/if the beam indication DCI is received in CORESET(s) associated/configured with the indicator/parameter in the corresponding ControlResourceSet set to “0” (or “1”), the UE could apply/use the first indicated TCI state/pair of TCI states to monitor first category-2 PDCCH candidate(s) and the second indicated TCI state/pair of TCI states to monitor second category-2 PDCCH candidate(s), and when/if the beam indication DCI is received in CORESET(s) associated/configured with the indicator/parameter in the corresponding ControlResourceSet set to “1” (or “0”), the UE could apply/use the second indicated TCI state/pair of TCI states to monitor the first category-2 PDCCH candidate(s) and the first indicated TCI state/pair of TCI states to monitor the second category-2 PDCCH candidate(s).

Yet for another example, when/if the beam indication DCI is received in CORESET(s) associated/configured with the indicator/parameter in the corresponding ControlResourceSet set to “00” (“01,” “10,” or “11”), the UE could apply/use the first (or second) indicated TCI state/pair of TCI states to monitor category-2 PDCCH candidate(s), when/if the beam indication DCI is received in CORESET(s) associated/configured with the indicator/parameter in the corresponding ControlResourceSet set to “01” (“00,” “10,” or “11”), the UE could apply/use the second (or first) indicated TCI state/pair of TCI states to monitor category-2 PDCCH candidate(s), when/if the beam indication DCI is received in CORESET(s) associated/configured with the indicator/parameter in the corresponding ControlResourceSet set to “10” (“00,” “01,” or “11”), the UE could apply/use the first indicated TCI state/pair of TCI states to monitor first category-2 PDCCH candidate(s) and the second indicated TCI state/pair of TCI states to monitor second category-2 PDCCH candidate(s), and when/if the beam indication DCI is received in CORESET(s) associated/configured with the indicator/parameter in the corresponding ControlResourceSet set to “11” (“00,” “01,” or “10”), the UE could apply/use the second indicated TCI state/pair of TCI states to monitor the first category-2 PDCCH candidate(s) and the first indicated TCI state/pair of TCI states to monitor the second category-2 PDCCH candidate(s).

The UE could first follow one or more of the design examples (e.g., the design as shown in examples of the present disclosure) specified/discussed herein in the present disclosure to determine the association between the indicated TCI state(s) and the PDCCH reception(s). The UE could then follow one or more of the design examples (e.g., the design examples as shown in examples of the present disclosure) specified/discussed herein in the present disclosure to determine the association between the indicated TCI state(s) and the PDCCH reception(s) according to/based on one or more events, or one or more conditions discussed/specified herein.

In one example, for N=2 or M=2, when/if the beam indication DCI is received in CORESET(s) associated/configured with the indicator/parameter in the corresponding ControlResourceSet set to “0,” the UE could apply/use the first (or second) indicated TCI state/pair of TCI states to monitor PDCCH candidate(s), wherein the PDCCH candidate(s) could be received in any CORESET(s) or CORESET(s) not associated/configured with the indicator/parameter specified/defined herein in the present disclosure (e.g., in the corresponding ControlResourceSet) or CORESET(s) associated/configured with the indicator/parameter in the corresponding ControlResourceSet set to “0,” “1,” “00,” “01,” “10,” or “11,” and when/if the beam indication DCI is received in CORESET(s) associated/configured with the indicator/parameter in the corresponding ControlResourceSet set to “1,” the UE could apply/use the second (or first) indicated TCI state/pair of TCI states to monitor PDCCH candidate(s), wherein the PDCCH candidate(s) could be received in any CORESET(s) or CORESET(s) not associated/configured with the indicator/parameter specified/defined herein in the present disclosure (e.g., in the corresponding ControlResourceSet) or CORESET(s) associated/configured with the indicator/parameter in the corresponding ControlResourceSet set to “0,” “1,” “00,” “01,” “10,” or “11.” When/if the beam indication DCI is received in CORESET(s) not associated/configured with the indicator/parameter specified/defined herein in the present disclosure (e.g., in the corresponding ControlResourceSet), followings examples can be performed.

In one example, the UE could apply/use the first (or second) indicated TCI state/pair of TCI states to monitor PDCCH candidate(s) received in CORESET(s) associated/configured with the indicator/parameter in the corresponding ControlResourceSet set to “0” (or equivalently, the UE could assume that the DM-RS antenna port(s) of the PDCCH received in CORESET(s) associated/configured with the indicator/parameter in the corresponding ControlResourceSet set to “0” is quasi co-located with the RS(s) in the RS set(s) provided/indicated/configured in the first (or second) indicated TCI state/pair of TCI states), and the UE could apply/use the second (or first) indicated TCI state/pair of TCI states to monitor PDCCH candidate(s) received in CORESET(s) associated/configured with the indicator/parameter in the corresponding ControlResourceSet set to “1” (or equivalently, the UE could assume that the DM-RS antenna port(s) of the PDCCH received in CORESET(s) associated/configured with the indicator/parameter in the corresponding ControlResourceSet set to “1” is quasi co-located with the RS(s) in the RS set(s) provided/indicated/configured in the second (or first) indicated TCI state/pair of TCI states).

In another example, the UE could apply/use the first indicated TCI state/pair of TCI states to monitor first PDCCH candidate(s) received in CORESET(s) associated/configured with the indicator/parameter in the corresponding ControlResourceSet set to “0” (or “1”) and the second indicated TCI state/pair of TCI states to monitor second PDCCH candidate(s) received in CORESET(s) associated/configured with the indicator/parameter in the corresponding ControlResourceSet set to “0” (or “1”). The UE could apply/use the second indicated TCI state/pair of TCI states to monitor first PDCCH candidate(s) received in CORESET(s) associated/configured with the indicator/parameter in the corresponding ControlResourceSet set to “1” (or “0”) and the first indicated TCI state/pair of TCI states to monitor second PDCCH candidate(s) received in CORESET(s) associated/configured with the indicator/parameter in the corresponding ControlResourceSet set to “1” (or “0”).

In yet another example, the UE could apply/use the first (or second) indicated TCI state/pair of TCI states to monitor PDCCH candidate(s) received in CORESET(s) associated/configured with the indicator/parameter in the corresponding ControlResourceSet set to “00” (“01,” “10,” or “11”)—or equivalently, the UE could assume that the DM-RS antenna port(s) of the PDCCH received in CORESET(s) associated/configured with the indicator/parameter in the corresponding ControlResourceSet set to “00” (“01,” “10,” or “11”) is quasi co-located with the RS(s) in the RS set(s) provided/indicated/configured in the first (or second) indicated TCI state/pair of TCI states, the UE could apply/use the second (or first) indicated TCI state/pair of TCI states to monitor PDCCH candidate(s) received in CORESET(s) associated/configured with the indicator/parameter in the corresponding ControlResourceSet set to “01” (“00,” “10,” or “11”)—or equivalently, the UE could assume that the DM-RS antenna port(s) of the PDCCH received in CORESET(s) associated/configured with the indicator/parameter in the corresponding ControlResourceSet set to “01” (“00,” “10,” or “11”) is quasi co-located with the RS(s) in the RS set(s) provided/indicated/configured in the second (or first) indicated TCI state/pair of TCI states), the UE could apply/use the first indicated TCI state/pair of TCI states to monitor first PDCCH candidate(s) received in CORESET(s) associated/configured with the indicator/parameter in the corresponding ControlResourceSet set to “10” (“00,” “01,” or “11”) and the second indicated TCI state/pair of TCI states to monitor second PDCCH candidate(s) received in CORESET(s) associated/configured with the indicator/parameter in the corresponding ControlResourceSet set to “10” (“00,” “01,” or “11”), or the UE could apply/use the second indicated TCI state/pair of TCI states to monitor first PDCCH candidate(s) received in CORESET(s) associated/configured with the indicator/parameter in the corresponding ControlResourceSet set to “11” (“00,” “01,” or “10”) and the first indicated TCI state/pair of TCI states to monitor second PDCCH candidate(s) received in CORESET(s) associated/configured with the indicator/parameter in the corresponding ControlResourceSet set to “11” (“00,” “01,” or “10”).

In another example, for N=2 or M=2, when/if the beam indication DCI is received in CORESET(s) associated/configured with the indicator/parameter in the corresponding ControlResourceSet set to “0” (or “1”), the UE could apply/use the first indicated TCI state/pair of TCI states to monitor first PDCCH candidate(s) and the second indicated TCI state/pair of TCI states to monitor second PDCCH candidate(s), wherein the first and/or second PDCCH candidate(s) could be received in any CORESET(s) or CORESET(s) not associated/configured with the indicator/parameter specified/defined herein in the present disclosure (e.g., in the corresponding ControlResourceSet) or CORESET(s) associated/configured with the indicator/parameter in the corresponding ControlResourceSet set to “0,” “1,” “00,” “01,” “10,” or “11,” and when/if the beam indication DCI is received in CORESET(s) associated/configured with the indicator/parameter in the corresponding ControlResourceSet set to “1” (or “0”), the UE could apply/use the second indicated TCI state/pair of TCI states to monitor the first PDCCH candidate(s) and the first indicated TCI state/pair of TCI states to monitor the second PDCCH candidate(s), wherein the first and/or second PDCCH candidate(s) could be received in any CORESET(s) or CORESET(s) not associated/configured with the indicator/parameter specified/defined herein in the present disclosure (e.g., in the corresponding ControlResourceSet) or CORESET(s) associated/configured with the indicator/parameter in the corresponding ControlResourceSet set to “0,” “0.1,” “00,” “01,” “0.10,” or “11.”

When/if the beam indication DCI is received in CORESET(s) not associated/configured with the indicator/parameter specified/defined herein in the present disclosure (e.g., in the corresponding ControlResourceSet), followings examples can be performed.

In one example, the UE could apply/use the first (or second) indicated TCI state/pair of TCI states to monitor PDCCH candidate(s) received in CORESET(s) associated/configured with the indicator/parameter in the corresponding ControlResourceSet set to “0” (or equivalently, the UE could assume that the DM-RS antenna port(s) of the PDCCH received in CORESET(s) associated/configured with the indicator/parameter in the corresponding ControlResourceSet set to “0” is quasi co-located with the RS(s) in the RS set(s) provided/indicated/configured in the first (or second) indicated TCI state/pair of TCI states), and the UE could apply/use the second (or first) indicated TCI state/pair of TCI states to monitor PDCCH candidate(s) received in CORESET(s) associated/configured with the indicator/parameter in the corresponding ControlResourceSet set to “1” (or equivalently, the UE could assume that the DM-RS antenna port(s) of the PDCCH received in CORESET(s) associated/configured with the indicator/parameter in the corresponding ControlResourceSet set to “1” is quasi co-located with the RS(s) in the RS set(s) provided/indicated/configured in the second (or first) indicated TCI state/pair of TCI states).

In another example, the UE could apply/use the first indicated TCI state/pair of TCI states to monitor first PDCCH candidate(s) received in CORESET(s) associated/configured with the indicator/parameter in the corresponding ControlResourceSet set to “0” (or “1”) and the second indicated TCI state/pair of TCI states to monitor second PDCCH candidate(s) received in CORESET(s) associated/configured with the indicator/parameter in the corresponding ControlResourceSet set to “0” (or “1”). The UE could apply/use the second indicated TCI state/pair of TCI states to monitor first PDCCH candidate(s) received in CORESET(s) associated/configured with the indicator/parameter in the corresponding ControlResourceSet set to “1” (or “0”) and the first indicated TCI state/pair of TCI states to monitor second PDCCH candidate(s) received in CORESET(s) associated/configured with the indicator/parameter in the corresponding ControlResourceSet set to “1” (or “0”).

In yet another example, the UE could apply/use the first (or second) indicated TCI state/pair of TCI states to monitor PDCCH candidate(s) received in CORESET(s) associated/configured with the indicator/parameter in the corresponding ControlResourceSet set to “00” (“01,” “10,” or “11”)—or equivalently, the UE could assume that the DM-RS antenna port(s) of the PDCCH received in CORESET(s) associated/configured with the indicator/parameter in the corresponding ControlResourceSet set to “00” (“01,” “10,” or “11”) is quasi co-located with the RS(s) in the RS set(s) provided/indicated/configured in the first (or second) indicated TCI state/pair of TCI states, the UE could apply/use the second (or first) indicated TCI state/pair of TCI states to monitor PDCCH candidate(s) received in CORESET(s) associated/configured with the indicator/parameter in the corresponding ControlResourceSet set to “01” (“00,” “10,” or “11”)—or equivalently, the UE could assume that the DM-RS antenna port(s) of the PDCCH received in CORESET(s) associated/configured with the indicator/parameter in the corresponding ControlResourceSet set to “01” (“00,” “10,” or “11”) is quasi co-located with the RS(s) in the RS set(s) provided/indicated/configured in the second (or first) indicated TCI state/pair of TCI states), the UE could apply/use the first indicated TCI state/pair of TCI states to monitor first PDCCH candidate(s) received in CORESET(s) associated/configured with the indicator/parameter in the corresponding ControlResourceSet set to “10” (“00,” “01,” or “11”) and the second indicated TCI state/pair of TCI states to monitor second PDCCH candidate(s) received in CORESET(s) associated/configured with the indicator/parameter in the corresponding ControlResourceSet set to “10” (“00,” “01,” or “11”), or the UE could apply/use the second indicated TCI state/pair of TCI states to monitor first PDCCH candidate(s) received in CORESET(s) associated/configured with the indicator/parameter in the corresponding ControlResourceSet set to “11” (“00,” “01,” or “10”) and the first indicated TCI state/pair of TCI states to monitor second PDCCH candidate(s) received in CORESET(s) associated/configured with the indicator/parameter in the corresponding ControlResourceSet set to “11” (“00,” “01,” or “10”).

In yet another example, for N=2 or M=2, when/if the beam indication DCI is received in CORESET(s) associated/configured with the indicator/parameter in the corresponding ControlResourceSet set to “00” (“01,” “10,” or “11”), the UE could apply/use the first (or second) indicated TCI state/pair of TCI states to monitor PDCCH candidate(s), wherein the PDCCH candidate(s) could be received in any CORESET(s) or CORESET(s) not associated/configured with the indicator/parameter specified/defined herein in the present disclosure (e.g., in the corresponding ControlResourceSet) or CORESET(s) associated/configured with the indicator/parameter in the corresponding ControlResourceSet set to “0,” “1,” “00,” “01,” “10,” or “11,” when/if the beam indication DCI is received in CORESET(s) associated/configured with the indicator/parameter in the corresponding ControlResourceSet set to “01” (“00,” “10,” or “11”), the UE could apply/use the second (or first) indicated TCI state/pair of TCI states to monitor PDCCH candidate(s), wherein the PDCCH candidate(s) could be received in any CORESET(s) or CORESET(s) not associated/configured with the indicator/parameter specified/defined herein in the present disclosure (e.g., in the corresponding ControlResourceSet) or CORESET(s) associated/configured with the indicator/parameter in the corresponding ControlResourceSet set to “0,” “1,” “00,” “01,” “10,” or “11,” when/if the beam indication DCI is received in CORESET(s) associated/configured with the indicator/parameter in the corresponding ControlResourceSet set to “10” (“00,” “01,” or “11”), the UE could apply/use the first indicated TCI state/pair of TCI states to monitor first PDCCH candidate(s) and the second indicated TCI state/pair of TCI states to monitor second PDCCH candidate(s), wherein the first and/or second PDCCH candidate(s) could be received in any CORESET(s) or CORESET(s) not associated/configured with the indicator/parameter specified/defined herein in the present disclosure (e.g., in the corresponding ControlResourceSet) or CORESET(s) associated/configured with the indicator/parameter in the corresponding ControlResourceSet set to “0,” “1,” “00,” “01,” “10,” or “11,” and when/if the beam indication DCI is received in CORESET(s) associated/configured with the indicator/parameter in the corresponding ControlResourceSet set to “11” (“00,” “01,” or “10”), the UE could apply/use the second indicated TCI state/pair of TCI states to monitor the first PDCCH candidate(s) and the first indicated TCI state/pair of TCI states to monitor the second PDCCH candidate(s), wherein the first and/or second PDCCH candidate(s) could be received in any CORESET(s) or CORESET(s) not associated/configured with the indicator/parameter specified/defined herein in the present disclosure (e.g., in the corresponding ControlResourceSet) or CORESET(s) associated/configured with the indicator/parameter in the corresponding ControlResourceSet set to “0,” “1,” “00,” “01,” “10,” or “11.”

When/if the beam indication DCI is received in CORESET(s) not associated/configured with the indicator/parameter specified/defined herein in the present disclosure (e.g., in the corresponding ControlResourceSet), following examples can be performed.

In one example, the UE could apply/use the first (or second) indicated TCI state/pair of TCI states to monitor PDCCH candidate(s) received in CORESET(s) associated/configured with the indicator/parameter in the corresponding ControlResourceSet set to “0” (or equivalently, the UE could assume that the DM-RS antenna port(s) of the PDCCH received in CORESET(s) associated/configured with the indicator/parameter in the corresponding ControlResourceSet set to “0” is quasi co-located with the RS(s) in the RS set(s) provided/indicated/configured in the first (or second) indicated TCI state/pair of TCI states), and the UE could apply/use the second (or first) indicated TCI state/pair of TCI states to monitor PDCCH candidate(s) received in CORESET(s) associated/configured with the indicator/parameter in the corresponding ControlResourceSet set to “1” (or equivalently, the UE could assume that the DM-RS antenna port(s) of the PDCCH received in CORESET(s) associated/configured with the indicator/parameter in the corresponding ControlResourceSet set to “1” is quasi co-located with the RS(s) in the RS set(s) provided/indicated/configured in the second (or first) indicated TCI state/pair of TCI states).

In another example, the UE could apply/use the first indicated TCI state/pair of TCI states to monitor first PDCCH candidate(s) received in CORESET(s) associated/configured with the indicator/parameter in the corresponding ControlResourceSet set to “0” (or “1”) and the second indicated TCI state/pair of TCI states to monitor second PDCCH candidate(s) received in CORESET(s) associated/configured with the indicator/parameter in the corresponding ControlResourceSet set to “0” (or “1”). The UE could apply/use the second indicated TCI state/pair of TCI states to monitor first PDCCH candidate(s) received in CORESET(s) associated/configured with the indicator/parameter in the corresponding ControlResourceSet set to “1” (or “0”) and the first indicated TCI state/pair of TCI states to monitor second PDCCH candidate(s) received in CORESET(s) associated/configured with the indicator/parameter in the corresponding ControlResourceSet set to “1” (or “0”).

In yet another example, the UE could apply/use the first (or second) indicated TCI state/pair of TCI states to monitor PDCCH candidate(s) received in CORESET(s) associated/configured with the indicator/parameter in the corresponding ControlResourceSet set to “00” (“01,” “10,” or “11”)—or equivalently, the UE could assume that the DM-RS antenna port(s) of the PDCCH received in CORESET(s) associated/configured with the indicator/parameter in the corresponding ControlResourceSet set to “00” (“01,” “10,” or “11”) is quasi co-located with the RS(s) in the RS set(s) provided/indicated/configured in the first (or second) indicated TCI state/pair of TCI states, the UE could apply/use the second (or first) indicated TCI state/pair of TCI states to monitor PDCCH candidate(s) received in CORESET(s) associated/configured with the indicator/parameter in the corresponding ControlResourceSet set to “01” (“00,” “10,” or “11”)—or equivalently, the UE could assume that the DM-RS antenna port(s) of the PDCCH received in CORESET(s) associated/configured with the indicator/parameter in the corresponding ControlResourceSet set to “01” (“00,” “10,” or “11”) is quasi co-located with the RS(s) in the RS set(s) provided/indicated/configured in the second (or first) indicated TCI state/pair of TCI states), the UE could apply/use the first indicated TCI state/pair of TCI states to monitor first PDCCH candidate(s) received in CORESET(s) associated/configured with the indicator/parameter in the corresponding ControlResourceSet set to “10” (“00,” “01,” or “11”) and the second indicated TCI state/pair of TCI states to monitor second PDCCH candidate(s) received in CORESET(s) associated/configured with the indicator/parameter in the corresponding ControlResourceSet set to “10” (“00,” “01,” or “11”), or the UE could apply/use the second indicated TCI state/pair of TCI states to monitor first PDCCH candidate(s) received in CORESET(s) associated/configured with the indicator/parameter in the corresponding ControlResourceSet set to “11” (“00,” “01,” or “10”) and the first indicated TCI state/pair of TCI states to monitor second PDCCH candidate(s) received in CORESET(s) associated/configured with the indicator/parameter in the corresponding ControlResourceSet set to “11” (“00,” “01,” or “10”).

Furthermore, the UE could be indicated/configured/provided by the network, e.g., via higher layer RRC signaling/parameter and/or MAC CE command and/or dynamic DCI based L1 signaling, to follow one or more of the design examples (e.g., the design examples as shown in examples of the present disclosure) specified herein in the present disclosure to determine the association between the indicated TCI state(s) and the PDCCH reception(s). For example, when/if the UE receives from the network, e.g., via higher layer RRC signaling (e.g., in PDCCH-Config, PDSCH-Config or ControlResourceSet), a higher layer parameter “beamSelectionPDCCH” set to “enabled,” the UE could follow the indicator/parameter provided/indicated/configured in the higher layer parameter PDSCH-Config as specified herein in the present disclosure to determine the association between the indicated TCI state(s) and the PDSCH reception(s); otherwise, e.g., when/if the higher layer parameter “beamSelectionPDSCH” is set to “disabled,” the UE could follow the dynamic TRP(s) selection/switching methods specified herein in the present disclosure (e.g., the design examples as shown in the present disclosure) to determine the association between the indicated TCI state(s) and the PDSCH reception(s).

The UE could receive one or more PDCCH candidates in one or more CORESETs that are fully or partially overlapping in time and/or frequency domains (e.g., with overlapping control channel elements (CCEs), PDCCH monitoring occasions, search space sets, PRBs, REs, symbols, slots, and/or etc.). For the design examples specified herein in the present disclosure (e.g., the design examples as shown in the present disclosure), wherein the UE could use the indicator/parameter indicated/configured/provided in ControlResourceSet to determine which one or more of the indicated TCI states/pairs of TCI states to use/apply for receiving the PDCCH candidate(s) in the corresponding CORESET(s), the UE could follow one or more of the following design examples or combination(s) of one or more of the following design examples to determine which one or more of the indicated TCI states/pairs of TCI states to use/apply to monitor PDCCH candidates received in overlapping CORESETs.

In one example, if the UE monitors PDCCH candidates in multiple overlapping CORESETs (e.g., with overlapping PDCCH monitoring occasions and/or with overlapping CCEs and/or etc.)—e.g., each CORESET could be associated/configured with a valid indicator/parameter provided/configured/indicated in the corresponding ControlResourceSet discussed/specified herein in the present disclosure—that have been configured with same or different qcl-Type set to “typeD” properties on active DL BWP(s) of one or more cells, the UE could monitor PDCCH(s)/PDCCH candidate(s) only in the CORESET (e.g., in the overlapping PDCCH monitoring occasions and/or in the overlapping CCEs and/or in the overlapping search space sets with the lowest/highest aggregation level) with the lowest (or highest) CORESET index/ID, or in any other CORESET(s) from the multiple overlapping CORESETs (e.g., in the overlapping PDCCH monitoring occasions and/or in the overlapping CCEs and/or in the overlapping search space sets with the lowest/highest aggregation level) that have been configured with qcl-Type set to same “typeD” properties as the CORESET with the lowest (or highest) CORESET index/ID on the active DL BWP of a cell from the one or more cells.

In another example, if the UE monitors PDCCH candidates in multiple overlapping CORESETs (e.g., with overlapping PDCCH monitoring occasions and/or with overlapping CCEs and/or etc.)—e.g., each CORESET could be associated/configured with a valid indicator/parameter provided/configured/indicated in the corresponding ControlResourceSet discussed/specified herein in the present disclosure—that have been configured with same or different qcl-Type set to “typeD” properties on active DL BWP(s) of one or more cells, the UE could monitor PDCCH(s)/PDCCH candidate(s) only in the CORESET (e.g., in the overlapping PDCCH monitoring occasions and/or in the overlapping CCEs and/or in the overlapping search space sets with the lowest/highest aggregation level) that is received earlier (or later) in time than the other CORESET(s) from the multiple overlapping CORESETs, or in any other CORESET(s) from the multiple overlapping CORESETs (e.g., in the overlapping PDCCH monitoring occasions and/or in the overlapping CCEs and/or in the overlapping search space sets with the lowest/highest aggregation level) that have been configured with qcl-Type set to same “typeD” properties as the CORESET that is received the earliest (or the latest) in time among the multiple overlapping CORESETs on the active DL BWP of a cell from the one or more cells.

In yet another example, if the UE monitors PDCCH candidates in multiple overlapping CORESETs (e.g., with overlapping PDCCH monitoring occasions and/or with overlapping CCEs and/or etc.)—e.g., each CORESET could be associated/configured with a valid indicator/parameter provided/configured/indicated in the corresponding ControlResourceSet discussed/specified herein in the present disclosure—that have been configured with same or different qcl-Type set to “typeD” properties on active DL BWP(s) of one or more cells, the UE could monitor PDCCH(s)/PDCCH candidate(s) only in the CORESET (e.g., in the overlapping PDCCH monitoring occasions and/or in the overlapping CCEs and/or in the overlapping search space sets with the lowest/highest aggregation level) that has the lowest (or highest) CCE index among the multiple overlapping CORESETs, or in any other CORESET(s) from the multiple overlapping CORESETs (e.g., in the overlapping PDCCH monitoring occasions and/or in the overlapping CCEs and/or in the overlapping search space sets with the lowest/highest aggregation level) that have been configured with qcl-Type set to same “typeD” properties as the CORESET that has the lowest (or highest) CCE index among the multiple overlapping CORESETs on the active DL BWP of a cell from the one or more cells.

In yet another example, if the UE monitors PDCCH candidates in multiple overlapping CORESETs (e.g., with overlapping PDCCH monitoring occasions and/or with overlapping CCEs and/or etc.)—e.g., each CORESET could be associated/configured with a valid indicator/parameter provided/configured/indicated in the corresponding ControlResourceSet discussed/specified herein in the present disclosure—that have been configured with same or different qcl-Type set to “typeD” properties on active DL BWP(s) of one or more cells, the UE could monitor PDCCH(s)/PDCCH candidate(s) in the multiple CORESETs (e.g., in the overlapping PDCCH monitoring occasions and/or in the overlapping CCEs and/or in the overlapping search space sets with the lowest/highest aggregation level) with a descending (or an ascending) order of their CORESET indexes/IDs, and/or with a descending (or an ascending) order of their configured/associated CORESET pool indexes/IDs, and/or with a descending (or an ascending) order of their configured/associated CORESET group indexes/IDs.

In yet another example, if the UE monitors PDCCH candidates in multiple overlapping CORESETs (e.g., with overlapping PDCCH monitoring occasions and/or with overlapping CCEs and/or etc.)—e.g., each CORESET could be associated/configured with a valid indicator/parameter provided/configured/indicated in the corresponding ControlResourceSet discussed/specified herein in the present disclosure—that have been configured with same or different qcl-Type set to “typeD” properties on active DL BWP(s) of one or more cells, the UE could monitor PDCCH(s)/PDCCH candidate(s) in the multiple CORESETs (e.g., in the overlapping PDCCH monitoring occasions and/or in the overlapping CCEs and/or in the overlapping search space sets with the lowest/highest aggregation level) with a descending (or an ascending) order of their reception time.

In yet another example, if the UE monitors PDCCH candidates in multiple overlapping CORESETs (e.g., with overlapping PDCCH monitoring occasions and/or with overlapping CCEs and/or etc.)—e.g., each CORESET could be associated/configured with a valid indicator/parameter provided/configured/indicated in the corresponding ControlResourceSet discussed/specified herein in the present disclosure—that have been configured with same or different qcl-Type set to “typeD” properties on active DL BWP(s) of one or more cells, the UE could monitor PDCCH(s)/PDCCH candidate(s) in the multiple CORESETs (e.g., in the overlapping PDCCH monitoring occasions and/or in the overlapping CCEs and/or in the overlapping search space sets with the lowest/highest aggregation level) with a descending (or an ascending) order of their lowest (or highest) CCE indexes.

In yet another example, if the UE monitors PDCCH candidates in multiple overlapping CORESETs (e.g., with overlapping PDCCH monitoring occasions and/or with overlapping CCEs and/or etc.)—e.g., each CORESET could be associated/configured with a valid indicator/parameter provided/configured/indicated in the corresponding ControlResourceSet discussed/specified herein in the present disclosure—that have been configured with same or different qcl-Type set to “typeD” properties on active DL BWP(s) of one or more cells, the UE could use/apply a first decoding/demodulation sequence to monitor at least the overlapping PDCCH(s)/PDCCH candidate(s) in the multiple CORESETs (e.g., in the overlapping PDCCH monitoring occasions and/or in the overlapping CCEs and/or in the overlapping search space sets), and a second decoding/demodulation sequence to monitor at least the overlapping PDCCH(s)/PDCCH candidate(s) in the multiple CORESETs (e.g., in the overlapping PDCCH monitoring occasions and/or in the overlapping CCEs and/or in the overlapping search space sets).

In yet another example, if the UE monitors PDCCH candidates in multiple overlapping CORESETs (e.g., with overlapping PDCCH monitoring occasions and/or with overlapping CCEs and/or etc.)—e.g., each CORESET could be associated/configured with a valid indicator/parameter provided/configured/indicated in the corresponding ControlResourceSet discussed/specified herein in the present disclosure—that have been configured with same or different qcl-Type set to “typeD” properties on active DL BWP(s) of one or more cells, following examples can be performed.

In one example, the UE could monitor PDCCH(s)/PDCCH candidate(s) only in a CORESET (e.g., in the overlapping PDCCH monitoring occasions and/or in the overlapping CCEs and/or in the overlapping search space sets with the lowest/highest aggregation level), and in any other CORESET from the multiple overlapping CORESETs (e.g., in the overlapping PDCCH monitoring occasions and/or in the overlapping CCEs and/or in the overlapping search space sets with the lowest/highest aggregation level) that have been configured with qcl-Type set to same “typeD” properties as the CORESET, on the active DL BWP of a cell from the one or more cells, wherein the CORESET could correspond to the CSS set with the lowest index in the cell with the lowest index containing CSS, if any; otherwise, to the USS set with the lowest index in the cell with lowest index; here, the lowest USS set index is determined over all USS sets with at least one PDCCH candidate in the overlapping PDCCH monitoring occasions and/or in the overlapping CCEs of the overlapping CORESETs.

In another example, if the UE is further configured/provided/indicated by the network, e.g., via higher layer parameter two-QCLTypeDforPDCCHRepetition, two QCL “typeD” properties for receiving PDCCH repetitions, the UE could monitor PDCCH(s)/PDCCH candidate(s) only in a first CORESET (e.g., in the overlapping PDCCH monitoring occasions and/or in the overlapping CCEs and/or in the overlapping search space sets with the lowest/highest aggregation level) with qcl-Type set to first “typeD” properties (e.g., associated with the first indicated TCI state/pair of TCI states specified herein in the present disclosure) and, if any, in a second CORESET (e.g., in the overlapping PDCCH monitoring occasions and/or in the overlapping CCEs and/or in the overlapping search space sets with the lowest/highest aggregation level) with qcl-Type set to second “typeD” properties (e.g., associated with the second indicated TCI state/pair of TCI states specified herein in the present disclosure) that are different than the first “typeD” properties, and in any other CORESET (e.g., in the overlapping PDCCH monitoring occasions and/or in the overlapping CCEs and/or in the overlapping search space sets with the lowest/highest aggregation level) from the multiple CORESETs with corresponding qcl-Type set to the first “typeD” properties and/or to the second “typeD” properties, wherein the first CORESET could correspond to the CSS set with the lowest index in the cell with the lowest index containing CSS sets, if any; otherwise, to the USS set with the lowest index in the cell with lowest index excluding CSS sets and USS sets associated with CORESETs with qcl-Type set to first “typeD” properties, the second CORESET could correspond to the CSS set with the lowest index in the cell with the lowest index containing CSS sets, if any; otherwise, to the USS set with the lowest index in the cell with lowest index, where the CSS set or the USS set includes searchSpaceLinking with a value indicating, respectively, any CSS set or any USS set associated with CORESETs with qcl-Type set to first “typeD” properties; here, the lowest USS set index is determined over all USS sets with at least one PDCCH candidate in overlapping PDCCH monitoring occasions and/or overlapping CCEs.

In another example, if one or more of the multiple (overlapping) CORESETs have more than one (e.g., two) active/activated TCI states/pairs of TCI states and the UE reports a capability signaling, e.g., twoTypeDcapability, to indicate to the network that they are capable of/able to simultaneously monitor PDCCH candidate(s) received in a CORESET with more than one (e.g., two) active/activated TCI states/pairs of TCI states, the UE could monitor PDCCH(s)/PDCCH candidate(s) only in a CORESET (e.g., in the overlapping PDCCH monitoring occasions and/or in the overlapping CCEs and/or in the overlapping search space sets with the lowest/highest aggregation level) with a first qcl-Type set to first “typeD” properties (e.g., associated with the first indicated TCI state/pair of TCI states) and, if any, a second qcl-Type set to second “typeD” properties (e.g., associated with the second indicated TCI state/pair of TCI states) that are different than the first “typeD” properties, and in any other CORESET (e.g., in the overlapping PDCCH monitoring occasions and/or in the overlapping CCEs and/or in the overlapping search space sets with the lowest/highest aggregation level) from the multiple CORESETs with corresponding qcl-Type set to the first “typeD” properties or to the second “typeD” properties, wherein the CORESET could correspond to the CSS set with the lowest index in the cell with the lowest index containing CSS, if any; otherwise, to the USS set with the lowest index in the cell with lowest index; here, the lowest USS set index is determined over all USS sets with at least one PDCCH candidate in overlapping PDCCH monitoring occasions and/or overlapping CCEs.

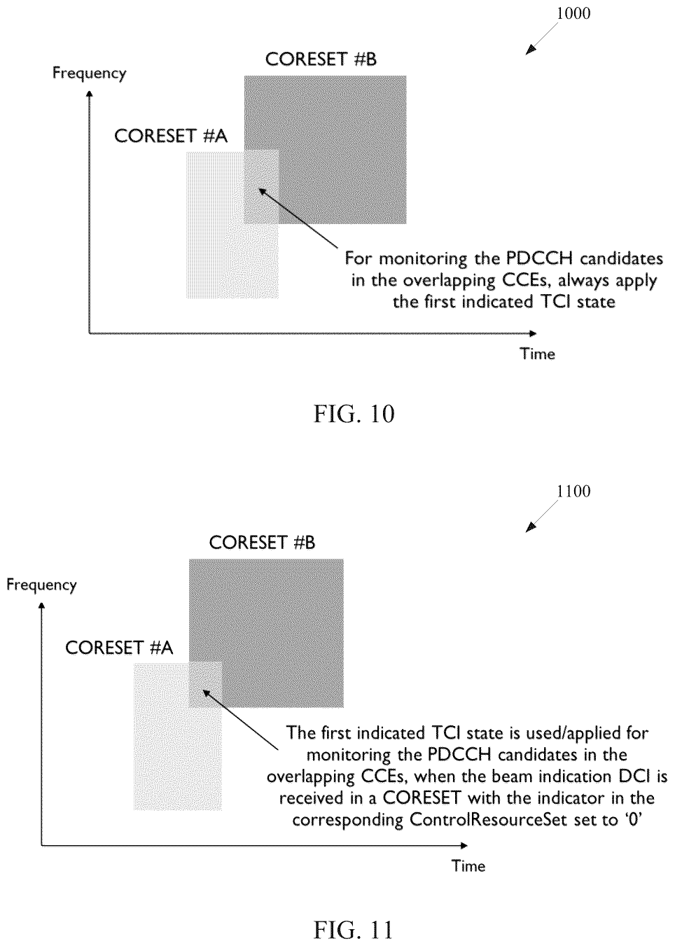

FIGS. 10 and 11 illustrate examples of determining TCI state(s) for monitoring PDCCH candidates in overlapping CORESETs 1000 and 1100 according to embodiments of the present disclosure. An embodiment of determining the TCI state(s) for monitoring the PDCCH candidates in the overlapping CORESETs 1000 and 1100 shown in FIGS. 10 and 11 are for illustration only.

In yet another example, if the UE monitors PDCCH candidates in multiple overlapping CORESETs (e.g., with overlapping PDCCH monitoring occasions and/or with overlapping CCEs and/or etc.)—e.g., each CORESET could be associated/configured with a valid indicator/parameter provided/configured/indicated in the corresponding ControlResourceSet discussed/specified herein in the present disclosure—that have been configured with same or different qcl-Type set to “typeD” properties on active DL BWP(s) of one or more cells, the UE could always apply the first indicated TCI state/pair of TCI state to monitor at least the overlapping PDCCH(s)/PDCCH candidate(s) in the multiple CORESETs (e.g., in the overlapping PDCCH monitoring occasions and/or in the overlapping CCEs and/or in the overlapping search space sets)—i.e., the UE could always assume that the DM-RS port(s) of at least the overlapping PDCCH(s)/PDCCH candidate(s) in the multiple CORESETs (e.g., in the overlapping PDCCH monitoring occasions and/or in the overlapping CCEs and/or in the overlapping search space sets) is quasi co-located with the RS(s) in the RS set(s) indicated/provided in the first indicated TCI state/pair of TCI states (one conceptual example is provided in FIG. 10).

Alternatively, the UE could always apply the second indicated TCI state/pair of TCI state to monitor at least the overlapping PDCCH(s)/PDCCH candidate(s) in the multiple CORESETs (e.g., in the overlapping PDCCH monitoring occasions and/or in the overlapping CCEs and/or in the overlapping search space sets)—i.e., the UE could always assume that the DM-RS port(s) of at least the PDCCH(s)/PDCCH candidate(s) in the multiple CORESETs (e.g., in the overlapping PDCCH monitoring occasions and/or in the overlapping CCEs and/or in the overlapping search space sets) is quasi co-located with the RS(s) in the RS set(s) indicated/provided in the second indicated TCI state/pair of TCI states; or optionally, for N=2 or M=2, the UE could always apply both of the first and second indicated TCI states/pairs of TCI state to monitor at least the overlapping PDCCH(s)/PDCCH candidate(s) in the multiple CORESETs (e.g., in the overlapping PDCCH monitoring occasions and/or in the overlapping CCEs and/or in the overlapping search space sets)—i.e., the UE could always assume that the DM-RS port(s) of at least the overlapping PDCCH(s)/PDCCH candidate(s) in the multiple CORESETs (e.g., in the overlapping PDCCH monitoring occasions and/or in the overlapping CCEs and/or in the overlapping search space sets) is quasi co-located with the RS(s) in the RS set(s) indicated/provided in both of the first and second indicated TCI states/pairs of TCI states.

In yet another example, if the UE monitors PDCCH candidates in multiple overlapping CORESETs (e.g., with overlapping PDCCH monitoring occasions and/or with overlapping CCEs and/or etc.)—e.g., each CORESET could be associated/configured with a valid indicator/parameter provided/configured/indicated in the corresponding ControlResourceSet discussed/specified herein in the present disclosure—that have been configured with same or different qcl-Type set to “typeD” properties on active DL BWP(s) of one or more cells, the UE could be provided/indicated/configured by the network, e.g., via higher layer RRC signaling/parameter and/or MAC CE command and/or dynamic DCI based L1 signaling, to follow one or more of the following: (1) the UE could apply the first indicated TCI state/pair of TCI state to monitor at least the overlapping PDCCH(s)/PDCCH candidate(s) in the multiple CORESETs (e.g., in the overlapping PDCCH monitoring occasions and/or in the overlapping CCEs and/or in the overlapping search space sets)—i.e., the UE could assume that the DM-RS port(s) of at least the overlapping PDCCH(s)/PDCCH candidate(s) in the multiple CORESETs (e.g., in the overlapping PDCCH monitoring occasions and/or in the overlapping CCEs and/or in the overlapping search space sets) is quasi co-located with the RS(s) in the RS set(s) indicated/provided in the first indicated TCI state/pair of TCI states, or (2) the UE could apply the second indicated TCI state/pair of TCI state to monitor at least the overlapping PDCCH(s)/PDCCH candidate(s) in the multiple CORESETs (e.g., in the overlapping PDCCH monitoring occasions and/or in the overlapping CCEs and/or in the overlapping search space sets)—i.e., the UE could assume that the DM-RS port(s) of at least the PDCCH(s)/PDCCH candidate(s) in the multiple CORESETs (e.g., in the overlapping PDCCH monitoring occasions and/or in the overlapping CCEs and/or in the overlapping search space sets) is quasi co-located with the RS(s) in the RS set(s) indicated/provided in the second indicated TCI state/pair of TCI states, or (3) for N=2 or M=2, the UE could apply both of the first and second indicated TCI states/pairs of TCI state to monitor at least the overlapping PDCCH(s)/PDCCH candidate(s) in the multiple CORESETs (e.g., in the overlapping PDCCH monitoring occasions and/or in the overlapping CCEs and/or in the overlapping search space sets)—i.e., the UE could assume that the DM-RS port(s) of at least the overlapping PDCCH(s)/PDCCH candidate(s) in the multiple CORESETs (e.g., in the overlapping PDCCH monitoring occasions and/or in the overlapping CCEs and/or in the overlapping search space sets) is quasi co-located with the RS(s) in the RS set(s) indicated/provided in both of the first and second indicated TCI state/pair of TCI states.

In yet another example, if the UE monitors PDCCH candidates in multiple overlapping CORESETs (e.g., with overlapping PDCCH monitoring occasions and/or with overlapping CCEs and/or etc.)—e.g., each CORESET could be associated/configured with a valid indicator/parameter provided/configured/indicated in the corresponding ControlResourceSet discussed/specified herein in the present disclosure—that have been configured with same or different qcl-Type set to “typeD” properties on active DL BWP(s) of one or more cells, the UE could apply the first indicated TCI state/pair of TCI state and/or the second indicated TCI state/pair of TCI states and/or both of the first and second indicated TCI states/pairs of TCI states simultaneously to monitor at least the overlapping PDCCH(s)/PDCCH candidate(s) in the multiple CORESETs (e.g., in the overlapping PDCCH monitoring occasions and/or in the overlapping CCEs and/or in the overlapping search space sets)—i.e., the UE could assume that the DM-RS port(s) of at least the overlapping PDCCH(s)/PDCCH candidate(s) in the multiple CORESETs (e.g., in the overlapping PDCCH monitoring occasions and/or in the overlapping CCEs and/or in the overlapping search space sets) is quasi co-located with the RS(s) in the RS set(s) indicated/provided in the first indicated TCI state/pair of TCI states and/or the second indicated TCI state/pair of TCI states and/or at the same time both of the first and second indicated TCI states/pairs of TCI states.

In yet another example, if the UE monitors PDCCH candidates in multiple overlapping CORESETs (e.g., with overlapping PDCCH monitoring occasions and/or with overlapping CCEs and/or etc.)—e.g., each CORESET could be associated/configured with a valid indicator/parameter provided/configured/indicated in the corresponding ControlResourceSet discussed/specified herein in the present disclosure—that have been configured with same or different qcl-Type set to “typeD” properties on active DL BWP(s) of one or more cells, the UE could follow one or more of the following design examples or combination(s) of one or more of the following design examples to determine the indicated TCI state(s)/pair(s) of TCI states for monitoring at least the overlapping PDCCH(s)/PDCCH candidate(s) in the multiple CORESETs (e.g., in the overlapping PDCCH monitoring occasions and/or in the overlapping CCEs and/or in the overlapping search space sets).

For example, when/if the beam indication DCI is received in CORESET(s) associated/configured with the indicator/parameter in the corresponding ControlResourceSet set to “0,” the UE could apply/use the first (or second) indicated TCI state/pair of TCI states to monitor at least the overlapping PDCCH(s)/PDCCH candidate(s) in the multiple CORESETs (e.g., in the overlapping PDCCH monitoring occasions and/or in the overlapping CCEs and/or in the overlapping search space sets)—one conceptual example is depicted in FIG. 11, and when/if the beam indication DCI is received in CORESET(s) associated/configured with the indicator/parameter in the corresponding ControlResourceSet set to “1,” the UE could apply/use the second (or first) indicated TCI state/pair of TCI states to monitor at least the overlapping PDCCH(s)/PDCCH candidate(s) in the multiple CORESETs (e.g., in the overlapping PDCCH monitoring occasions and/or in the overlapping CCEs and/or in the overlapping search space sets).

For another example, when/if the beam indication DCI is received in CORESET(s) associated/configured with the indicator/parameter in the corresponding ControlResourceSet set to “0” (or “1”), the UE could apply/use the first indicated TCI state/pair of TCI states to monitor at least first overlapping PDCCH(s)/PDCCH candidate(s) in first overlapping CORESETs (e.g., in the overlapping PDCCH monitoring occasions and/or in the overlapping CCEs and/or in the overlapping search space sets) and the second indicated TCI state/pair of TCI states to monitor at least second overlapping PDCCH(s)/PDCCH candidate(s) in second overlapping CORESETs (e.g., in the overlapping PDCCH monitoring occasions and/or in the overlapping CCEs and/or in the overlapping search space sets), and when/if the beam indication DCI is received in CORESET(s) associated/configured with the indicator/parameter in the corresponding ControlResourceSet set to “1” (or “0”), the UE could apply/use the second indicated TCI state/pair of TCI states to monitor at least the first overlapping PDCCH(s)/PDCCH candidate(s) in the first overlapping CORESETs (e.g., in the overlapping PDCCH monitoring occasions and/or in the overlapping CCEs and/or in the overlapping search space sets) and the first indicated TCI state/pair of TCI states to monitor at least the second overlapping PDCCH(s)/PDCCH candidate(s) in the second overlapping CORESETs (e.g., in the overlapping PDCCH monitoring occasions and/or in the overlapping CCEs and/or in the overlapping search space sets).

The first and second CORESETs in this design example could be the same as the first and second CORESETs specified in other design examples described herein in the present disclosure. The first and second PDCCHs/PDCCH candidates in this design example could be the same as the first and second PDCCHs/PDCCH candidates specified in other design examples described herein in the present disclosure.

Yet for another example, when/if the beam indication DCI is received in CORESET(s) associated/configured with the indicator/parameter in the corresponding ControlResourceSet set to “00” (“01,” “10” or “11”), the UE could apply/use the first (or second) indicated TCI state/pair of TCI states to monitor at least the overlapping PDCCH(s)/PDCCH candidate(s) in the multiple CORESETs (e.g., in the overlapping PDCCH monitoring occasions and/or in the overlapping CCEs and/or in the overlapping search space sets), when/if the beam indication DCI is received in CORESET(s) associated/configured with the indicator/parameter in the corresponding ControlResourceSet set to “01” (“00,” “10,” or “11”), the UE could apply/use the second (or first) indicated TCI state/pair of TCI states to monitor at least the overlapping PDCCH(s)/PDCCH candidate(s) in the multiple CORESETs (e.g., in the overlapping PDCCH monitoring occasions and/or in the overlapping CCEs and/or in the overlapping search space sets), when/if the beam indication DCI is received in CORESET(s) associated/configured with the indicator/parameter in the corresponding ControlResourceSet set to “10” (“00,” “01,” or “11”), the UE could apply/use the first indicated TCI state/pair of TCI states to monitor at least first overlapping PDCCH(s)/PDCCH candidate(s) in first overlapping CORESETs (e.g., in the overlapping PDCCH monitoring occasions and/or in the overlapping CCEs and/or in the overlapping search space sets) and the second indicated TCI state/pair of TCI states to monitor at least second overlapping PDCCH(s)/PDCCH candidate(s) in second overlapping CORESETs (e.g., in the overlapping PDCCH monitoring occasions and/or in the overlapping CCEs and/or in the overlapping search space sets), and when/if the beam indication DCI is received in CORESET(s) associated/configured with the indicator/parameter in the corresponding ControlResourceSet set to “11” (“00,” “01,” or “10”), the UE could apply/use the second indicated TCI state/pair of TCI states to monitor at least the first overlapping PDCCH(s)/PDCCH candidate(s) in the first overlapping CORESETs (e.g., in the overlapping PDCCH monitoring occasions and/or in the overlapping CCEs and/or in the overlapping search space sets) and the first indicated TCI state/pair of TCI states to monitor at least the second overlapping PDCCH(s)/PDCCH candidate(s) in the second overlapping CORESETs (e.g., in the overlapping PDCCH monitoring occasions and/or in the overlapping CCEs and/or in the overlapping search space sets).

The first and second CORESETs in this design example could be the same as the first and second CORESETs specified in other design examples described herein in the present disclosure. The first and second PDCCHs/PDCCH candidates in this design example could be the same as the first and second PDCCHs/PDCCH candidates specified in other design examples described herein in the present disclosure.

In one embodiment, the UE could be provided/configured/indicated by the network, in a higher layer parameter, e.g., PDSCH-Config, an indicator/parameter to indicate the association between one or more of the indicated TCI states and the corresponding PDSCH reception(s).

For example, for N=2 or M=2, the indicator could be a one-bit indicator with “0” (or “1”) indicating that the first indicated TCI state/pairs of TCI states could be applied/used for receiving first (or second) PDSCH(s), and with “1” (or “0”) indicating that the second indicated TCI state/pairs of TCI states could be applied/used for receiving second (or first) PDSCH(s).

For another example, for N=2 or M=2, the indicator could be a one-bit indicator with “0” (or “1”) indicating that the first indicated TCI state/pairs of TCI states could be applied/used for receiving first PDSCH DM-RS(s) (or equivalently, the RS(s) in the RS set(s) provided in the first indicated TCI state/pair of TCI states could be quasi-co-located (QCL'ed) with first DM-RS antenna port(s) for PDSCH reception(s)) and the second indicated TCI state/pairs of TCI states could be applied/used for receiving second PDSCH DM-RS(s) (or equivalently, the RS(s) in the RS set(s) provided in the second indicated TCI state/pair of TCI states could be QCL'ed with second DM-RS antenna port(s) for PDSCH reception(s)), and with “1” (or “0”) indicating that the first indicated TCI state/pairs of TCI states could be applied/used for receiving the second PDSCH DM-RS(s) (or equivalently, the RS(s) in the RS set(s) provided in the first indicated TCI state/pair of TCI states could be QCL'ed with the second DM-RS antenna port(s) for PDSCH reception(s)) and the second indicated TCI state/pairs of TCI states could be applied/used for receiving the first PDSCH DM-RS(s) (or equivalently, the RS(s) in the RS set(s) provided in the second indicated TCI state/pair of TCI states could be QCL'ed with the first DM-RS antenna port(s) for PDSCH reception(s)).

Yet for another example, for N=2 or M=2, the indicator could be a 2-bit indicator with “00” (“01,” “10,” or “11”) indicating that the first indicated TCI state/pairs of TCI states could be applied/used for receiving the first (or second) PDSCH(s), with “01” (“00,” “10,” or “11”) indicating that the second indicated TCI state/pairs of TCI states could be applied/used for receiving the second (or first) PDSCH(s), with “10” (“00,” “01,” or “11”) indicating that the first indicated TCI state/pairs of TCI states could be applied/used for receiving the first PDSCH DM-RS(s) (or equivalently, the RS(s) in the RS set(s) provided in the first indicated TCI state/pair of TCI states could be QCL'ed with the first DM-RS antenna port(s) for PDSCH reception(s)) and the second indicated TCI state/pairs of TCI states could be applied/used for receiving the second PDSCH DM-RS(s) (or equivalently, the RS(s) in the RS set(s) provided in the second indicated TCI state/pair of TCI states could be QCL'ed with the second DM-RS antenna port(s) for PDSCH reception(s)), and with “11” (“00,” “01,” or “10”) indicating that the first indicated TCI state/pairs of TCI states could be applied/used for receiving the second PDSCH DM-RS(s) (or equivalently, the RS(s) in the RS set(s) provided in the first indicated TCI state/pair of TCI states could be QCL'ed with the second DM-RS antenna port(s) for PDSCH reception(s)) and the second indicated TCI state/pairs of TCI states could be applied/used for receiving the first PDSCH DM-RS(s) (or equivalently, the RS(s) in the RS set(s) provided in the second indicated TCI state/pair of TCI states could be QCL'ed with the first DM-RS antenna port(s) for PDSCH reception(s)).

Throughout the present disclosure, unless otherwise specified, the first PDSCH(s) could correspond the first PDSCH DM-RS(s) or the first DM-RS antenna port(s) for PDSCH reception(s), and the second PDSCH(s) could correspond to the second PDSCH DM-RS(s) or the second DM-RS antenna port(s) for PDSCH reception(s). The UE could be configured/indicated/provided by the network, e.g., via higher layer RRC signaling/parameter and/or MAC CE command and/or dynamic DCI based L1 signaling, the first and/or second DM-RS antenna ports and their corresponding/respective configuration information. Furthermore, to support dynamic selection/switching of PDSCH reception(s) in a multi-TRP system, following examples can be performed.

In one example, the UE could be first informed/provided/indicated/configured by the network, e.g., by the indicator/parameter in PDSCH-Config described herein in the present disclosure, that the first indicated TCI state/pair of TCI states is applied/used for all PDSCH receptions. That is, the indicators/parameters in all PDSCH-Config's for all PDSCHs could be set to the same value “0” (or “1,” “00,” “01,” “10,” or “11”) according to the descriptions/discussions herein. The UE could then follow one or more of the design examples specified/provided below to further determine the association between the indicated TCI state(s) and the PDSCH reception(s). The UE could be provided/indicated/configured by the network, in a higher layer parameter, e.g., ControlResourceSet for a CORESET, an indicator/parameter to inform/indicate/provide/configure the UE the association between the indicated TCI state(s) and the PDSCH reception(s), wherein different CORESETs configured with the same indicator/parameter could be in a same CORESET group.

In one example, when/if the indicator/parameter discussed above is absent or disabled or not provided/configured/indicated/specified/defined in ControlResourceSet, and/or when/if all CORESETs are configured/associated with same indicators/parameters set to “0”s, “1”s, “00”s, “01”s, “10”s, or “11”s, the UE could follow the indicator/parameter provided/indicated/configured in PDSCH-Config described herein in the present disclosure to determine the association between the indicated TCI state(s) and the PDSCH reception(s).

In another example, if the DCI (e.g., the scheduling DCI or the beam indication DCI with or without DL assignment) is received in a CORESET configured/associated with the indicator/parameter in the corresponding ControlResourceSet set to “0,” the first indicated TCI state/pair of TCI states could still be applied/used for all PDSCH receptions, and if the DCI (e.g., the scheduling DCI or the beam indication DCI with or without DL assignment) is received in a CORESET configured/associated with the indicator/parameter in the corresponding ControlResourceSet set to “1,” the second indicated TCI state/pair of TCI states could be applied/used for all PDSCH receptions—change of TRP that transmits the PDSCH(s). In FIG. 10, a conceptual example characterizing the above described association between the indicated TCI state(s) and the PDSCH reception(s) is presented.

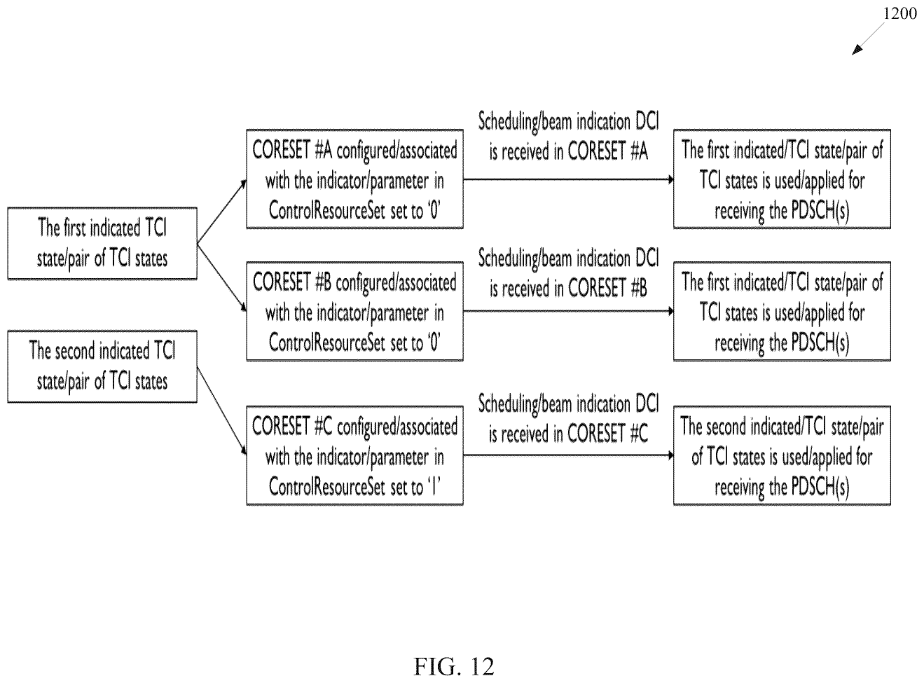

FIG. 12 illustrates an example of determining which of the indicated TCI states to use for PDSCH receptions 1200 according to embodiments of the present disclosure. An embodiment of determining which of the indicated TCI states to use for PDSCH receptions 1200 shown in FIG. 12 is for illustration only.

In yet another example, if the DCI (e.g., the scheduling DCI or the beam indication DCI with or without DL assignment) is received in a CORESET configured/associated with the indicator/parameter in the corresponding ControlResourceSet set to “0,” the second indicated TCI state/pair of TCI states could be applied/used for all PDSCH receptions—change of TRP that transmits the PDSCH(s), and if the DCI (e.g., the scheduling DCI or the beam indication DCI with or without DL assignment) is received in a CORESET configured/associated with the indicator/parameter in the corresponding ControlResourceSet set to “1,” the first indicated TCI state/pair of TCI states could still be applied/used for all PDSCH receptions.

In yet another example, if the DCI (e.g., the scheduling DCI or the beam indication DCI with or without DL assignment) is received in a CORESET configured/associated with the indicator/parameter in the corresponding ControlResourceSet set to “0” (or “1”), the first indicated TCI state/pair of TCI states could be applied/used for receiving the first PDSCH(s), and the second indicated TCI state/pair of TCI states could be applied/used for receiving the second PDSCH(s). If the DCI (e.g., the scheduling DCI or the beam indication DCI with or without DL assignment) is received in a CORESET configured/associated with the indicator/parameter in the corresponding ControlResourceSet set to “1” (or “0”), the first indicated TCI state/pair of TCI states could be applied/used for receiving the second PDSCH(s), and the second indicated TCI state/pair of TCI states could be applied/used for receiving the first PDSCH(s). The UE could be configured/indicated/provided by the network, e.g., via higher layer RRC signaling/parameter and/or MAC CE command and/or dynamic DCI based L1 signaling, the first and/or second PDSCHs and their corresponding/respective configuration information.

In yet another example, if the DCI (e.g., the scheduling DCI or the beam indication DCI with or without DL assignment) is received in a CORESET configured/associated with the indicator/parameter in the corresponding ControlResourceSet set to “0” (or “1”), the first indicated TCI state/pair of TCI states could still be applied/used for all PDSCH receptions, and if the DCI (e.g., the scheduling DCI or the beam indication DCI with or without DL assignment) is received in a CORESET configured/associated with the indicator/parameter in the corresponding ControlResourceSet set to “1” (or “0”), the first indicated TCI state/pair of TCI states could be applied/used for receiving the first (or second) PDSCH(s), and the second indicated TCI state/pair of TCI states could be applied/used for receiving the second (or first) PDSCH(s). The UE could be configured/indicated/provided by the network, e.g., via higher layer RRC signaling/parameter and/or MAC CE command and/or dynamic DCI based L1 signaling, the first and/or second PDSCHs and their corresponding/respective configuration information.

In yet another example, if the DCI (e.g., the scheduling DCI or the beam indication DCI with or without DL assignment) is received in a CORESET configured/associated with the indicator/parameter in the corresponding ControlResourceSet set to “0” (or “1”), the second indicated TCI state/pair of TCI states could be applied/used for all PDSCH receptions—change of TRP that transmits the PDSCH(s), and if the DCI (e.g., the scheduling DCI or the beam indication DCI with or without DL assignment) is received in a CORESET configured/associated with the indicator/parameter in the corresponding ControlResourceSet set to “1” (or “0”), the first indicated TCI state/pair of TCI states could be applied/used for receiving the first (or second) PDSCH(s), and the second indicated TCI state/pair of TCI states could be applied/used for receiving the second (or first) PDSCH(s). The UE could be configured/indicated/provided by the network, e.g., via higher layer RRC signaling/parameter and/or MAC CE command and/or dynamic DCI based L1 signaling, the first and/or second PDSCHs and their corresponding/respective configuration information.

In yet another example, if the DCI (e.g., the scheduling DCI or the beam indication DCI with or without DL assignment) is received in a CORESET configured/associated with the indicator/parameter in the corresponding ControlResourceSet set to “0” (or “1”), the first indicated TCI state/pair of TCI states could be applied/used for receiving the first PDSCH DM-RS(s) (or equivalently, the RS(s) in the RS set(s) provided in the first indicated TCI state/pair of TCI states could be QCL'ed with the first DM-RS antenna port(s) for PDSCH reception(s)), and the second indicated TCI state/pair of TCI states could be applied/used for receiving the second PDSCH DM-RS(s) (or equivalently, the RS(s) in the RS set(s) provided in the second indicated TCI state/pair of TCI states could be QCL'ed with the second DM-RS antenna port(s) for PDSCH reception(s)).

If the DCI (e.g., the scheduling DCI or the beam indication DCI with or without DL assignment) is received in a CORESET configured/associated with the indicator/parameter in the corresponding ControlResourceSet set to “1” (or “0”), the first indicated TCI state/pair of TCI states could be applied/used for receiving the second PDSCH DM-RS(s) (or equivalently, the RS(s) in the RS set(s) provided in the second indicated TCI state/pair of TCI states could be QCL'ed with the second DM-RS antenna port(s) for PDSCH reception(s)), and the second indicated TCI state/pair of TCI states could be applied/used for receiving the first PDSCH DM-RS(s) (or equivalently, the RS(s) in the RS set(s) provided in the second indicated TCI state/pair of TCI states could be QCL'ed with the first DM-RS antenna port(s) for PDSCH reception(s)).

In yet another example, if the DCI (e.g., the scheduling DCI or the beam indication DCI with or without DL assignment) is received in a CORESET configured/associated with the indicator/parameter in the corresponding ControlResourceSet set to “00” (“01,” “10,” or “11”), the first indicated TCI state/pair of TCI states could still be applied/used for all PDSCH receptions, if the DCI (e.g., the scheduling DCI or the beam indication DCI with or without DL assignment) is received in a CORESET configured/associated with the indicator/parameter in the corresponding ControlResourceSet set to “01” (“00,” “10,” or “11”), the second indicated TCI state/pair of TCI states could be applied/used for all PDSCH receptions—change of TRP that transmits the PDSCH(s), if the DCI (e.g., the scheduling DCI or the beam indication DCI with or without DL assignment) is received in a CORESET configured/associated with the indicator/parameter in the corresponding ControlResourceSet set to “10” (“00,” “01,” or “11”), the first indicated TCI state/pair of TCI states could be applied/used for receiving the first PDSCH(s), and the second indicated TCI state/pair of TCI states could be applied/used for receiving the second PDSCH(s), and if the DCI (e.g., the scheduling DCI or the beam indication DCI with or without DL assignment) is received in a CORESET configured/associated with the indicator/parameter in the corresponding ControlResourceSet set to “11” (“00,” “01,” or “10”), the first indicated TCI state/pair of TCI states could be applied/used for receiving the second PDSCH(s), and the second indicated TCI state/pair of TCI states could be applied/used for receiving the first PDSCH(s).

In yet another example, if the DCI (e.g., the scheduling DCI or the beam indication DCI with or without DL assignment) is received in a CORESET configured/associated with the indicator/parameter in the corresponding ControlResourceSet set to “00” (“01,” “10,” or “11”), the first indicated TCI state/pair of TCI states could still be applied/used for all PDSCH receptions, if the DCI (e.g., the scheduling DCI or the beam indication DCI with or without DL assignment) is received in a CORESET configured/associated with the indicator/parameter in the corresponding ControlResourceSet set to “01” (“00,” “10,” or “11”), the second indicated TCI state/pair of TCI states could be applied/used for all PDSCH receptions—change of TRP that transmits the PDSCH(s), if the DCI (e.g., the scheduling DCI or the beam indication DCI with or without DL assignment) is received in a CORESET configured/associated with the indicator/parameter in the corresponding ControlResourceSet set to “10” (“00,” “01,” or “11”), the first indicated TCI state/pair of TCI states could be applied/used for receiving the first PDSCH DM-RS(s) (or equivalently, the RS(s) in the RS set(s) provided in the first indicated TCI state/pair of TCI states could be QCL'ed with the first DM-RS antenna port(s) for PDSCH reception(s)), and the second indicated TCI state/pair of TCI states could be applied/used for receiving the second PDSCH DM-RS(s) (or equivalently, the RS(s) in the RS set(s) provided in the second indicated TCI state/pair of TCI states could be QCL'ed with the second DM-RS antenna port(s) for PDSCH reception(s)), and if the DCI (e.g., the scheduling DCI or the beam indication DCI with or without DL assignment) is received in a CORESET configured/associated with the indicator/parameter in the corresponding ControlResourceSet set to “11” (“00,” “01,” or “10”), the first indicated TCI state/pair of TCI states could be applied/used for receiving the second PDSCH DM-RS(s) (or equivalently, the RS(s) in the RS set(s) provided in the second indicated TCI state/pair of TCI states could be QCL'ed with the second DM-RS antenna port(s) for PDSCH reception(s)), and the second indicated TCI state/pair of TCI states could be applied/used for receiving the first PDSCH DM-RS(s) (or equivalently, the RS(s) in the RS set(s) provided in the second indicated TCI state/pair of TCI states could be QCL'ed with the first DM-RS antenna port(s) for PDSCH reception(s)).

The UE could be provided/configured/indicated by the network, e.g., via higher layer RRC signaling/parameter and/or MAC CE command and/or dynamic DCI based L1 signaling, to follow one or more of the design examples (e.g., the design examples as shown in the present disclosure) to determine the association between the indicated TCI state(s) and the PDSCH reception(s). For instance, a higher layer parameter “dynamicBeamSelectionCoreset” can be provided/configured/indicated in, e.g., PDSCH-Config. When/if the higher layer parameter “dynamicBeamSelectionCoreset” is set to “enabled,” the UE could follow one or more of the design examples (e.g., the design as shown in the present disclosure to determine the association between the indicated TCI state(s) and the PDSCH reception(s).

In another example, the UE could be first informed/provided/configured/indicated by the network, e.g., by the indicator/parameter in PDSCH-Config described herein in the present disclosure, that the second indicated TCI state/pair of TCI states is applied/used for all PDSCH receptions. That is, the indicators/parameters in all PDSCH-Config's for all PDSCHs could be set to the same value “1” (or “0,” “00,” “01,” “10,” or “11”) according to the descriptions/discussions herein. The UE could then follow one or more of the design examples specified/provided below to further determine the association between the indicated TCI state(s) and the PDSCH reception(s). The UE could be provided/indicated/configured by the network, in a higher layer parameter, e.g., ControlResourceSet for a CORESET, an indicator/parameter to inform/provide/configure/indicate the UE the association between the indicated TCI state(s) and the PDSCH reception(s), wherein different CORESETs configured with the same indicator/parameter could be in a same CORESET group.

In one example, when/if the indicator/parameter discussed above is absent or disabled or not provided/configured/indicated/specified/defined in ControlResourceSet, and/or when/if all CORESETs are configured/associated with same indicators/parameters set to “0”s, “1”s, “00”s, “01”s, “10”s, or “11”s, the UE could follow the indicator/parameter provided/indicated/configured in PDSCH-Config described herein in the present disclosure to determine the association between the indicated TCI state(s) and the PDSCH reception(s).

In another example, if the DCI (e.g., the scheduling DCI or the beam indication DCI with or without DL assignment) is received in a CORESET configured/associated with the indicator/parameter in the corresponding ControlResourceSet set to “0,” the second indicated TCI state/pair of TCI states could still be applied/used for all PDSCH receptions, and if the DCI (e.g., the scheduling DCI or the beam indication DCI with or without DL assignment) is received in a CORESET configured/associated with the indicator/parameter in the corresponding ControlResourceSet set to “1,” the first indicated TCI state/pair of TCI states could be applied/used for all PDSCH receptions—change of TRP that transmits the PDSCH(s).

In yet another example, if the DCI (e.g., the scheduling DCI or the beam indication DCI with or without DL assignment) is received in a CORESET configured/associated with the indicator/parameter in the corresponding ControlResourceSet set to “0,” the first indicated TCI state/pair of TCI states could be applied/used for all PDSCH receptions—change of TRP that transmits the PDSCH(s), and if the DCI (e.g., the scheduling DCI or the beam indication DCI with or without DL assignment) is received in a CORESET configured/associated with the indicator/parameter in the corresponding ControlResourceSet set to “1,” the second indicated TCI state/pair of TCI states could still be applied/used for all PDSCH receptions.

In yet another example, if the DCI (e.g., the scheduling DCI or the beam indication DCI with or without DL assignment) is received in a CORESET configured/associated with the indicator/parameter in the corresponding ControlResourceSet set to “0” (or “1”), the first indicated TCI state/pair of TCI states could be applied/used for receiving the first PDSCH(s), and the second indicated TCI state/pair of TCI states could be applied/used for receiving the second PDSCH(s). If the DCI (e.g., the scheduling DCI or the beam indication DCI with or without DL assignment) is received in a CORESET configured/associated with the indicator/parameter in the corresponding ControlResourceSet set to “1” (or “0”), the first indicated TCI state/pair of TCI states could be applied/used for receiving the second PDSCH(s), and the second indicated TCI state/pair of TCI states could be applied/used for receiving the first PDSCH(s). The UE could be configured/indicated/provided by the network, e.g., via higher layer RRC signaling/parameter and/or MAC CE command and/or dynamic DCI based L1 signaling, the first and/or second PDSCHs and their corresponding/respective configuration information.

In yet another example, if the DCI (e.g., the scheduling DCI or the beam indication DCI with or without DL assignment) is received in a CORESET configured/associated with the indicator/parameter in the corresponding ControlResourceSet set to “0” (or “1”), the second indicated TCI state/pair of TCI states could still be applied/used for all PDSCH receptions, and if the DCI (e.g., the scheduling DCI or the beam indication DCI with or without DL assignment) is received in a CORESET configured/associated with the indicator/parameter in the corresponding ControlResourceSet set to “1” (or “0”), the first indicated TCI state/pair of TCI states could be applied/used for receiving the first (or second) PDSCH(s), and the second indicated TCI state/pair of TCI states could be applied/used for receiving the second (or first) PDSCH(s). The UE could be configured/indicated/provided by the network, e.g., via higher layer RRC signaling/parameter and/or MAC CE command and/or dynamic DCI based L1 signaling, the first and/or second PDSCHs and their corresponding/respective configuration information.

In yet another example, if the DCI (e.g., the scheduling DCI or the beam indication DCI with or without DL assignment) is received in a CORESET configured/associated with the indicator/parameter in the corresponding ControlResourceSet set to “0” (or “1”), the first indicated TCI state/pair of TCI states could be applied/used for all PDSCH receptions—change of TRP that transmits the PDSCH(s), and if the DCI (e.g., the scheduling DCI or the beam indication DCI with or without DL assignment) is received in a CORESET configured/associated with the indicator/parameter in the corresponding ControlResourceSet set to “1” (or “0”), the first indicated TCI state/pair of TCI states could be applied/used for receiving the first (or second) PDSCH(s), and the second indicated TCI state/pair of TCI states could be applied/used for receiving the second (or first) PDSCH(s). The UE could be configured/indicated/provided by the network, e.g., via higher layer RRC signaling/parameter and/or MAC CE command and/or dynamic DCI based L1 signaling, the first and/or second PDSCHs and their corresponding/respective configuration information.

In yet another example, if the DCI (e.g., the scheduling DCI or the beam indication DCI with or without DL assignment) is received in a CORESET configured/associated with the indicator/parameter in the corresponding ControlResourceSet set to “0” (or “1”), the first indicated TCI state/pair of TCI states could be applied/used for receiving the first PDSCH DM-RS(s) (or equivalently, the RS(s) in the RS set(s) provided in the first indicated TCI state/pair of TCI states could be QCL'ed with the first DM-RS antenna port(s) for PDSCH reception(s)), and the second indicated TCI state/pair of TCI states could be applied/used for receiving the second PDSCH DM-RS(s) (or equivalently, the RS(s) in the RS set(s) provided in the second indicated TCI state/pair of TCI states could be QCL'ed with the second DM-RS antenna port(s) for PDSCH reception(s)).

If the DCI (e.g., the scheduling DCI or the beam indication DCI with or without DL assignment) is received in a CORESET configured/associated with the indicator/parameter in the corresponding ControlResourceSet set to “1” (or “0”), the first indicated TCI state/pair of TCI states could be applied/used for receiving the second PDSCH DM-RS(s) (or equivalently, the RS(s) in the RS set(s) provided in the second indicated TCI state/pair of TCI states could be QCL'ed with the second DM-RS antenna port(s) for PDSCH reception(s)), and the second indicated TCI state/pair of TCI states could be applied/used for receiving the first PDSCH DM-RS(s) (or equivalently, the RS(s) in the RS set(s) provided in the second indicated TCI state/pair of TCI states could be QCL'ed with the first DM-RS antenna port(s) for PDSCH reception(s)).

In yet another example, if the DCI (e.g., the scheduling DCI or the beam indication DCI with or without DL assignment) is received in a CORESET configured/associated with the indicator/parameter in the corresponding ControlResourceSet set to “00” (“01,” “10,” or “11”), the second indicated TCI state/pair of TCI states could still be applied/used for all PDSCH receptions, if the DCI (e.g., the scheduling DCI or the beam indication DCI with or without DL assignment) is received in a CORESET configured/associated with the indicator/parameter in the corresponding ControlResourceSet set to “01” (“00,” “10,” or “11”), the first indicated TCI state/pair of TCI states could be applied/used for all PDSCH receptions—change of TRP that transmits the PDSCH(s), if the DCI (e.g., the scheduling DCI or the beam indication DCI with or without DL assignment) is received in a CORESET configured/associated with the indicator/parameter in the corresponding ControlResourceSet set to “10” (“00,” “01,” or “11”), the first indicated TCI state/pair of TCI states could be applied/used for receiving the first PDSCH(s), and the second indicated TCI state/pair of TCI states could be applied/used for receiving the second PDSCH(s), and if the DCI (e.g., the scheduling DCI or the beam indication DCI with or without DL assignment) is received in a CORESET configured/associated with the indicator/parameter in the corresponding ControlResourceSet set to “11” (“00,” “01,” or “10”), the first indicated TCI state/pair of TCI states could be applied/used for receiving the second PDSCH(s), and the second indicated TCI state/pair of TCI states could be applied/used for receiving the first PDSCH(s).

In yet another example, if the DCI (e.g., the scheduling DCI or the beam indication DCI with or without DL assignment) is received in a CORESET configured/associated with the indicator/parameter in the corresponding ControlResourceSet set to “00” (“01,” “10,” or “11”), the second indicated TCI state/pair of TCI states could still be applied/used for all PDSCH receptions, if the DCI (e.g., the scheduling DCI or the beam indication DCI with or without DL assignment) is received in a CORESET configured/associated with the indicator/parameter in the corresponding ControlResourceSet set to “01” (“00,” “10,” or “11”), the first indicated TCI state/pair of TCI states could be applied/used for all PDSCH receptions—change of TRP that transmits the PDSCH(s), if the DCI (e.g., the scheduling DCI or the beam indication DCI with or without DL assignment) is received in a CORESET configured/associated with the indicator/parameter in the corresponding ControlResourceSet set to “10” (“00,” “01,” or “11”), the first indicated TCI state/pair of TCI states could be applied/used for receiving the first PDSCH DM-RS(s) (or equivalently, the RS(s) in the RS set(s) provided in the first indicated TCI state/pair of TCI states could be QCL'ed with the first DM-RS antenna port(s) for PDSCH reception(s)), and the second indicated TCI state/pair of TCI states could be applied/used for receiving the second PDSCH DM-RS(s) (or equivalently, the RS(s) in the RS set(s) provided in the second indicated TCI state/pair of TCI states could be QCL'ed with the second DM-RS antenna port(s) for PDSCH reception(s)), and if the DCI (e.g., the scheduling DCI or the beam indication DCI with or without DL assignment) is received in a CORESET configured/associated with the indicator/parameter in the corresponding ControlResourceSet set to “11” (“00,” “01,” or “10”), the first indicated TCI state/pair of TCI states could be applied/used for receiving the second PDSCH DM-RS(s) (or equivalently, the RS(s) in the RS set(s) provided in the second indicated TCI state/pair of TCI states could be QCL'ed with the second DM-RS antenna port(s) for PDSCH reception(s)), and the second indicated TCI state/pair of TCI states could be applied/used for receiving the first PDSCH DM-RS(s) (or equivalently, the RS(s) in the RS set(s) provided in the second indicated TCI state/pair of TCI states could be QCL'ed with the first DM-RS antenna port(s) for PDSCH reception(s)).

The UE could be provided/configured/indicated by the network, e.g., via higher layer RRC signaling/parameter and/or MAC CE command and/or dynamic DCI based L1 signaling, to follow one or more of the design examples (e.g., the design as shown in the present disclosure to determine the association between the indicated TCI state(s) and the PDSCH reception(s). For instance, a higher layer parameter “dynamicBeamSelectionCoreset” can be provided/configured/indicated in, e.g., PDSCH-Config. When/if the higher layer parameter “dynamicBeamSelectionCoreset” is set to “enabled,” the UE could follow one or more of the design examples (e.g., the design examples as shown in the present disclosure to determine the association between the indicated TCI state(s) and the PDSCH reception(s).

In yet another example, the UE could be first informed by the network, e.g., by the indicator/parameter in PDSCH-Config described herein in the present disclosure, that the first indicated TCI state/pair of TCI states is applied/used for receiving the first (or second) PDSCH(s)—e.g., when the indicator/parameter in the corresponding PDSCH-Config is set to “0” (or “1,” “00,” “01,” “10,” or “11”), and the second indicated TCI state/pair of TCI states is applied/used for receiving the second (or first) PDSCH(s)—e.g., when the indicator/parameter in the corresponding PDSCH-Config is set to “1” (or “0,” “00,” “01,” “10,” or “11”).

Optionally, the UE is informed by the network, e.g., by the indicator/parameter in PDSCH-Config described herein in the present disclosure, that the first indicated TCI state/pair of TCI states is applied/used for receiving the first PDSCH DM-RS(s), and the second indicated TCI state/pair of TCI states is applied/used for receiving the second PDSCH DM-RS(s)—e.g., when the indicator/parameter in the corresponding PDSCH-Config is set to “0” (or “1,” “00,” “01,” “10,” or “11”), and the first indicated TCI state/pair of TCI states is applied/used for receiving the second PDSCH DM-RS(s), and the second indicated TCI state/pair of TCI states is applied/used for receiving the first PDSCH DM-RS(s)—e.g., when the indicator/parameter in the corresponding PDSCH-Config is set to “1” (or “0,” “00,” “01,” “10,” or “11”). The UE could then follow one or more of the design examples specified/provided below to further determine the association between the indicated TCI state(s) and the PDSCH reception(s). The UE could be provided/indicated/configured by the network, in a higher layer parameter, e.g., ControlResourceSet for a CORESET, an indicator/parameter to inform the UE the association between the indicated TCI state(s) and the PDSCH reception(s), wherein different CORESETs configured with the same indicator/parameter could be in a same CORESET group.

In one example, when/if the indicator/parameter discussed above is absent or disabled or not provided/configured/indicated/specified/defined in ControlResourceSet, and/or when/if all CORESETs are configured/associated with same indicators/parameters set to “0”s, “1”s, “00”s, “01”s, “10”s, or “11”s, the UE could follow the indicator/parameter provided/indicated/configured in PDSCH-Config described herein in the present disclosure to determine the association between the indicated TCI state(s) and the PDSCH reception(s).

In another example, if the DCI (e.g., the scheduling DCI or the beam indication DCI with or without DL assignment) is received in a CORESET configured/associated with the indicator/parameter in the corresponding ControlResourceSet set to “0,” the first indicated TCI state/pair of TCI states could be applied/used for all PDSCH receptions, and if the DCI (e.g., the scheduling DCI or the beam indication DCI with or without DL assignment) is received in a CORESET configured/associated with the indicator/parameter in the corresponding ControlResourceSet set to “1,” the second indicated TCI state/pair of TCI states could be applied/used for all PDSCH receptions.

In yet another example, if the DCI (e.g., the scheduling DCI or the beam indication DCI with or without DL assignment) is received in a CORESET configured/associated with the indicator/parameter in the corresponding ControlResourceSet set to “0,” the second indicated TCI state/pair of TCI states could be applied/used for all PDSCH receptions, and if the DCI (e.g., the scheduling DCI or the beam indication DCI with or without DL assignment) is received in a CORESET configured/associated with the indicator/parameter in the corresponding ControlResourceSet set to “1,” the first indicated TCI state/pair of TCI states could still be applied/used for all PDSCH receptions.

In yet another example, if the DCI (e.g., the scheduling DCI or the beam indication DCI with or without DL assignment) is received in a CORESET configured/associated with the indicator/parameter in the corresponding ControlResourceSet set to “0” (or “1”), the first indicated TCI state/pair of TCI states could be applied/used for receiving the first PDSCH(s), and the second indicated TCI state/pair of TCI states could be applied/used for receiving the second PDSCH(s).

If the DCI (e.g., the scheduling DCI or the beam indication DCI with or without DL assignment) is received in a CORESET configured/associated with the indicator/parameter in the corresponding ControlResourceSet set to “1” (or “0”), the first indicated TCI state/pair of TCI states could be applied/used for receiving the second PDSCH(s), and the second indicated TCI state/pair of TCI states could be applied/used for receiving the first PDSCH(s). The UE could be configured/indicated/provided by the network, e.g., via higher layer RRC signaling/parameter and/or MAC CE command and/or dynamic DCI based L1 signaling, the first and/or second PDSCHs and their corresponding/respective configuration information.

In yet another example, if the DCI (e.g., the scheduling DCI or the beam indication DCI with or without DL assignment) is received in a CORESET configured/associated with the indicator/parameter in the corresponding ControlResourceSet set to “0” (or “1”), the first indicated TCI state/pair of TCI states could be applied/used for all PDSCH receptions, and if the DCI (e.g., the scheduling DCI or the beam indication DCI with or without DL assignment) is received in a CORESET configured/associated with the indicator/parameter in the corresponding ControlResourceSet set to “1” (or “0”), the first indicated TCI state/pair of TCI states could be applied/used for receiving the first (or second) PDSCH(s), and the second indicated TCI state/pair of TCI states could be applied/used for receiving the second (or first) PDSCH(s). The UE could be configured/indicated/provided by the network, e.g., via higher layer RRC signaling/parameter and/or MAC CE command and/or dynamic DCI based L1 signaling, the first and/or second PDSCHs and their corresponding/respective configuration information.

In yet another example, if the DCI (e.g., the scheduling DCI or the beam indication DCI with or without DL assignment) is received in a CORESET configured/associated with the indicator/parameter in the corresponding ControlResourceSet set to “0” (or “1”), the second indicated TCI state/pair of TCI states could be applied/used for all PDSCH receptions, and if the DCI (e.g., the scheduling DCI or the beam indication DCI with or without DL assignment) is received in a CORESET configured/associated with the indicator/parameter in the corresponding ControlResourceSet set to “1” (or “0”), the first indicated TCI state/pair of TCI states could be applied/used for receiving the first (or second) PDSCH(s), and the second indicated TCI state/pair of TCI states could be applied/used for receiving the second (or first) PDSCH(s). The UE could be configured/indicated/provided by the network, e.g., via higher layer RRC signaling/parameter and/or MAC CE command and/or dynamic DCI based L1 signaling, the first and/or second PDSCHs and their corresponding/respective configuration information.

In yet another example, if the DCI (e.g., the scheduling DCI or the beam indication DCI with or without DL assignment) is received in a CORESET configured/associated with the indicator/parameter in the corresponding ControlResourceSet set to “0” (or “1”), the first indicated TCI state/pair of TCI states could be applied/used for receiving the first PDSCH DM-RS(s) (or equivalently, the RS(s) in the RS set(s) provided in the first indicated TCI state/pair of TCI states could be QCL'ed with the first DM-RS antenna port(s) for PDSCH reception(s)), and the second indicated TCI state/pair of TCI states could be applied/used for receiving the second PDSCH DM-RS(s) (or equivalently, the RS(s) in the RS set(s) provided in the second indicated TCI state/pair of TCI states could be QCL'ed with the second DM-RS antenna port(s) for PDSCH reception(s)).

If the DCI (e.g., the scheduling DCI or the beam indication DCI with or without DL assignment) is received in a CORESET configured/associated with the indicator/parameter in the corresponding ControlResourceSet set to “1” (or “0”), the first indicated TCI state/pair of TCI states could be applied/used for receiving the second PDSCH DM-RS(s) (or equivalently, the RS(s) in the RS set(s) provided in the second indicated TCI state/pair of TCI states could be QCL'ed with the second DM-RS antenna port(s) for PDSCH reception(s)), and the second indicated TCI state/pair of TCI states could be applied/used for receiving the first PDSCH DM-RS(s) (or equivalently, the RS(s) in the RS set(s) provided in the second indicated TCI state/pair of TCI states could be QCL'ed with the first DM-RS antenna port(s) for PDSCH reception(s)).

In yet another example, if the DCI (e.g., the scheduling DCI or the beam indication DCI with or without DL assignment) is received in a CORESET configured/associated with the indicator/parameter in the corresponding ControlResourceSet set to “00” (“01,” “10,” or “11”), the first indicated TCI state/pair of TCI states could still be applied/used for all PDSCH receptions, if the DCI (e.g., the scheduling DCI or the beam indication DCI with or without DL assignment) is received in a CORESET configured/associated with the indicator/parameter in the corresponding ControlResourceSet set to “01” (“00,” “10,” or “11”), the second indicated TCI state/pair of TCI states could be applied/used for all PDSCH receptions, if the DCI (e.g., the scheduling DCI or the beam indication DCI with or without DL assignment) is received in a CORESET configured/associated with the indicator/parameter in the corresponding ControlResourceSet set to “10” (“00,” “01,” or “11”), the first indicated TCI state/pair of TCI states could be applied/used for receiving the first PDSCH(s), and the second indicated TCI state/pair of TCI states could be applied/used for receiving the second PDSCH(s), and if the DCI (e.g., the scheduling DCI or the beam indication DCI with or without DL assignment) is received in a CORESET configured/associated with the indicator/parameter in the corresponding ControlResourceSet set to “11” (“00,” “01,” or “10”), the first indicated TCI state/pair of TCI states could be applied/used for receiving the second PDSCH(s), and the second indicated TCI state/pair of TCI states could be applied/used for receiving the first PDSCH(s).

In yet another example, if the DCI (e.g., the scheduling DCI or the beam indication DCI with or without DL assignment) is received in a CORESET configured/associated with the indicator/parameter in the corresponding ControlResourceSet set to “00” (“01,” “10,” or “11”), the first indicated TCI state/pair of TCI states could be applied/used for all PDSCH receptions, if the DCI (e.g., the scheduling DCI or the beam indication DCI with or without DL assignment) is received in a CORESET configured/associated with the indicator/parameter in the corresponding ControlResourceSet set to “01” (“00,” “10,” or “11”), the second indicated TCI state/pair of TCI states could be applied/used for all PDSCH receptions, if the DCI (e.g., the scheduling DCI or the beam indication DCI with or without DL assignment) is received in a CORESET configured/associated with the indicator/parameter in the corresponding ControlResourceSet set to “10” (“00,” “01,” or “11”), the first indicated TCI state/pair of TCI states could be applied/used for receiving the first PDSCH DM-RS(s) (or equivalently, the RS(s) in the RS set(s) provided in the first indicated TCI state/pair of TCI states could be QCL'ed with the first DM-RS antenna port(s) for PDSCH reception(s)), and the second indicated TCI state/pair of TCI states could be applied/used for receiving the second PDSCH DM-RS(s) (or equivalently, the RS(s) in the RS set(s) provided in the second indicated TCI state/pair of TCI states could be QCL'ed with the second DM-RS antenna port(s) for PDSCH reception(s)), and if the DCI (e.g., the scheduling DCI or the beam indication DCI with or without DL assignment) is received in a CORESET configured/associated with the indicator/parameter in the corresponding ControlResourceSet set to “11” (“00,” “01,” or “10”), the first indicated TCI state/pair of TCI states could be applied/used for receiving the second PDSCH DM-RS(s) (or equivalently, the RS(s) in the RS set(s) provided in the second indicated TCI state/pair of TCI states could be QCL'ed with the second DM-RS antenna port(s) for PDSCH reception(s)), and the second indicated TCI state/pair of TCI states could be applied/used for receiving the first PDSCH DM-RS(s) (or equivalently, the RS(s) in the RS set(s) provided in the second indicated TCI state/pair of TCI states could be QCL'ed with the first DM-RS antenna port(s) for PDSCH reception(s)).

The UE could be provided/configured/indicated by the network, e.g., via higher layer RRC signaling/parameter and/or MAC CE command and/or dynamic DCI based L1 signaling, to follow one or more of the design examples (e.g., the design examples as shown in the present disclosure to determine the association between the indicated TCI state(s) and the PDSCH reception(s). For instance, a higher layer parameter “dynamicBeamSelectionCoreset” can be provided/configured/indicated in, e.g., PDSCH-Config. When/if the higher layer parameter “dynamicBeamSelectionCoreset” is set to “enabled,” the UE could follow one or more of the design examples (e.g., the design examples as shown in the present disclosure to determine the association between the indicated TCI state(s) and the PDSCH reception(s).

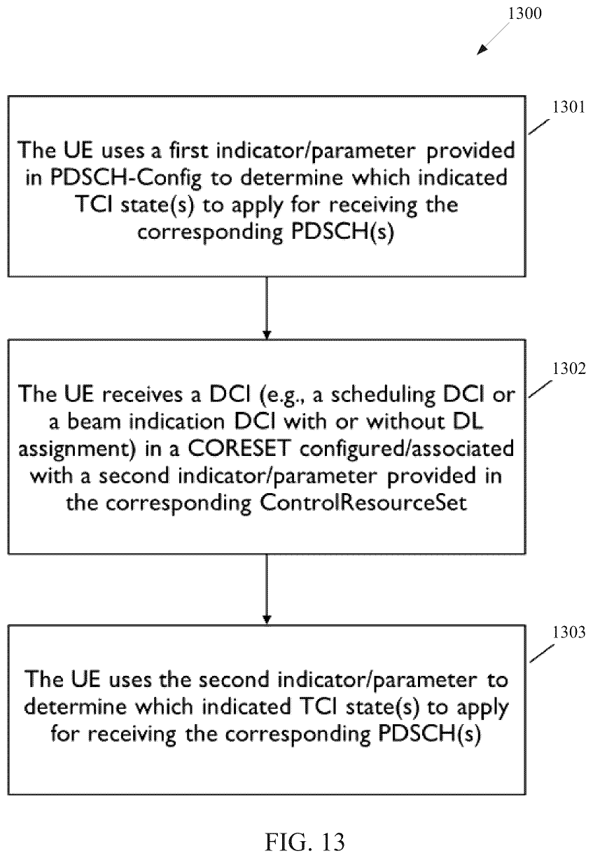

The UE could be provided/configured/indicated by the network, e.g., via higher layer RRC signaling/parameter and/or MAC CE command and/or dynamic DCI based L1 signaling, to follow one or more of the design examples (e.g., the design examples as shown in the present disclosure to determine the association between the indicated TCI state(s) and the PDSCH reception(s). For instance, a higher layer parameter “dynamicBeamSelectionPDSCH” can be provided/configured/indicated in, e.g., PDSCH-Config. When/if the higher layer parameter “dynamicBeamSelectionPDSCH” is set to “enabled,” the UE could follow one or more of the design examples (e.g., the design examples as shown in the present disclosure to determine the association between the indicated TCI state(s) and the PDSCH reception(s). The overall procedures of determining the association between the indicated TCI state(s) and the PDSCH reception(s) specified herein in the present disclosure is provided in FIG. 13.

FIG. 13 illustrates a flowchart of UE procedure 1300 for determining which of the indicated TCI state(s) to use for PDSCH receptions according to embodiments of the present disclosure. For example, the UE procedure 1300 as may be performed by a UE such as 111-116 as illustrated in FIG. 1). An embodiment of the UE procedure 1300 shown in FIG. 13 is for illustration only. One or more of the components illustrated in FIG. 13 can be implemented in specialized circuitry configured to perform the noted functions or one or more of the components can be implemented by one or more processors executing instructions to perform the noted functions.

As illustrated in FIG. 13, in step 1301, the UE uses a first indicator provided in PDSCH-Config to determine which indicated TCI state(s) to apply for receiving the corresponding PDSCH(s). In step 1302, the UE receives a DCI in a CORESET configured with a second indicator provided in the corresponding ControlResourceSet. In step 1303, the UE uses the second indicator/parameter to determine which indicated TCI state(s) to apply for receiving the corresponding PDSCH(s).

The UE could receive the beam indication DCI(s) in one or more CORESETs that are fully or partially overlapping in time and/or frequency domains (e.g., with overlapping control channel elements (CCEs), PDCCH monitoring occasions, search space sets, PRBs, REs, symbols, slots, and/or etc.). For the design examples specified herein in the present disclosure, wherein the UE could use the indicator/parameter indicated/configured/provided in ControlResourceSet to determine which CORESET the beam indication DCI is received (and therefore, which one or more of the indicated TCI states/pairs of TCI states to use/apply for receiving the PDCCH candidate(s)), the UE could follow one or more of the following design examples or combination(s) of one or more of the following design examples to determine which CORESET the beam indication DCI is received.

In one example, if the UE monitors PDCCH candidates for beam indication DCI(s) in multiple overlapping CORESETs (e.g., with overlapping PDCCH monitoring occasions and/or with overlapping CCEs and/or etc.)—e.g., each CORESET could be associated/configured with a valid indicator/parameter provided/configured/indicated in the corresponding ControlResourceSet discussed/specified herein in the present disclosure—that have been configured with same or different qcl-Type set to “typeD” properties on active DL BWP(s) of one or more cells, the UE could monitor PDCCH(s)/PDCCH candidate(s) for the beam indication DCI(s) only in the CORESET (e.g., in the overlapping PDCCH monitoring occasions and/or in the overlapping CCEs and/or in the overlapping search space sets with the lowest/highest aggregation level) with the lowest (or highest) CORESET index/ID, or in any other CORESET(s) from the multiple overlapping CORESETs (e.g., in the overlapping PDCCH monitoring occasions and/or in the overlapping CCEs and/or in the overlapping search space sets with the lowest/highest aggregation level) that have been configured with qcl-Type set to same “typeD” properties as the CORESET with the lowest (or highest) CORESET index/ID on the active DL BWP of a cell from the one or more cells.

In another example, if the UE monitors PDCCH candidates for beam indication DCI(s) in multiple overlapping CORESETs (e.g., with overlapping PDCCH monitoring occasions and/or with overlapping CCEs and/or etc.)—e.g., each CORESET could be associated/configured with a valid indicator/parameter provided/configured/indicated in the corresponding ControlResourceSet discussed/specified herein in the present disclosure—that have been configured with same or different qcl-Type set to “typeD” properties on active DL BWP(s) of one or more cells, the UE could monitor PDCCH(s)/PDCCH candidate(s) for the beam indication DCI(s) only in the CORESET (e.g., in the overlapping PDCCH monitoring occasions and/or in the overlapping CCEs and/or in the overlapping search space sets with the lowest/highest aggregation level) that is received earlier (or later) in time than the other CORESET(s) from the multiple overlapping CORESETs, or in any other CORESET(s) from the multiple overlapping CORESETs (e.g., in the overlapping PDCCH monitoring occasions and/or in the overlapping CCEs and/or in the overlapping search space sets with the lowest/highest aggregation level) that have been configured with qcl-Type set to same “typeD” properties as the CORESET that is received the earliest (or the latest) in time among the multiple overlapping CORESETs on the active DL BWP of a cell from the one or more cells.

In yet another example, if the UE monitors PDCCH candidates for beam indication DCI(s) in multiple overlapping CORESETs (e.g., with overlapping PDCCH monitoring occasions and/or with overlapping CCEs and/or etc.)—e.g., each CORESET could be associated/configured with a valid indicator/parameter provided/configured/indicated in the corresponding ControlResourceSet discussed/specified herein in the present disclosure—that have been configured with same or different qcl-Type set to “typeD” properties on active DL BWP(s) of one or more cells, the UE could monitor PDCCH(s)/PDCCH candidate(s) for the beam indication DCI(s) only in the CORESET (e.g., in the overlapping PDCCH monitoring occasions and/or in the overlapping CCEs and/or in the overlapping search space sets with the lowest/highest aggregation level) that has the lowest (or highest) CCE index among the multiple overlapping CORESETs, or in any other CORESET(s) from the multiple overlapping CORESETs (e.g., in the overlapping PDCCH monitoring occasions and/or in the overlapping CCEs and/or in the overlapping search space sets with the lowest/highest aggregation level) that have been configured with qcl-Type set to same “typeD” properties as the CORESET that has the lowest (or highest) CCE index among the multiple overlapping CORESETs on the active DL BWP of a cell from the one or more cells.

In yet another example, if the UE monitors PDCCH candidates for beam indication DCI(s) in multiple overlapping CORESETs (e.g., with overlapping PDCCH monitoring occasions and/or with overlapping CCEs and/or etc.)—e.g., each CORESET could be associated/configured with a valid indicator/parameter provided/configured/indicated in the corresponding ControlResourceSet discussed/specified herein in the present disclosure—that have been configured with same or different qcl-Type set to “typeD” properties on active DL BWP(s) of one or more cells, the UE could monitor PDCCH(s)/PDCCH candidate(s) for beam indication DCI(s) in the multiple CORESETs (e.g., in the overlapping PDCCH monitoring occasions and/or in the overlapping CCEs and/or in the overlapping search space sets with the lowest/highest aggregation level) with a descending (or an ascending) order of their CORESET indexes/IDs, and/or with a descending (or an ascending) order of their configured/associated CORESET pool indexes/IDs, and/or with a descending (or an ascending) order of their configured/associated CORESET group indexes/IDs.

In yet another example, if the UE monitors PDCCH candidates for beam indication DCI(s) in multiple overlapping CORESETs (e.g., with overlapping PDCCH monitoring occasions and/or with overlapping CCEs and/or etc.)—e.g., each CORESET could be associated/configured with a valid indicator/parameter provided/configured/indicated in the corresponding ControlResourceSet discussed/specified herein in the present disclosure—that have been configured with same or different qcl-Type set to “typeD” properties on active DL BWP(s) of one or more cells, the UE could monitor PDCCH(s)/PDCCH candidate(s) for beam indication DCI(s) in the multiple CORESETs (e.g., in the overlapping PDCCH monitoring occasions and/or in the overlapping CCEs and/or in the overlapping search space sets with the lowest/highest aggregation level) with a descending (or an ascending) order of their reception time.

In yet another example, if the UE monitors PDCCH candidates for beam indication DCI(s) in multiple overlapping CORESETs (e.g., with overlapping PDCCH monitoring occasions and/or with overlapping CCEs and/or etc.)—e.g., each CORESET could be associated/configured with a valid indicator/parameter provided/configured/indicated in the corresponding ControlResourceSet discussed/specified herein in the present disclosure—that have been configured with same or different qcl-Type set to “typeD” properties on active DL BWP(s) of one or more cells, the UE could monitor PDCCH(s)/PDCCH candidate(s) for beam indication DCI(s) in the multiple CORESETs (e.g., in the overlapping PDCCH monitoring occasions and/or in the overlapping CCEs and/or in the overlapping search space sets with the lowest/highest aggregation level) with a descending (or an ascending) order of their lowest (or highest) CCE indexes.

In yet another example, if the UE monitors PDCCH candidates for beam indication DCI(s) in multiple overlapping CORESETs (e.g., with overlapping PDCCH monitoring occasions and/or with overlapping CCEs and/or etc.)—e.g., each CORESET could be associated/configured with a valid indicator/parameter provided/configured/indicated in the corresponding ControlResourceSet discussed/specified herein in the present disclosure—that have been configured with same or different qcl-Type set to “typeD” properties on active DL BWP(s) of one or more cells, the UE could use/apply a first decoding/demodulation sequence to monitor at least the overlapping PDCCH(s)/PDCCH candidate(s) for beam indication DCI(s) in the multiple CORESETs (e.g., in the overlapping PDCCH monitoring occasions and/or in the overlapping CCEs and/or in the overlapping search space sets), and a second decoding/demodulation sequence to monitor at least the overlapping PDCCH(s)/PDCCH candidate(s) for beam indication DCI(s) in the multiple CORESETs (e.g., in the overlapping PDCCH monitoring occasions and/or in the overlapping CCEs and/or in the overlapping search space sets).

In yet another example, if the UE monitors PDCCH candidates for beam indication DCI(s) in multiple overlapping CORESETs (e.g., with overlapping PDCCH monitoring occasions and/or with overlapping CCEs and/or etc.)—e.g., each CORESET could be associated/configured with a valid indicator/parameter provided/configured/indicated in the corresponding ControlResourceSet discussed/specified herein in the present disclosure—that have been configured with same or different qcl-Type set to “typeD” properties on active DL BWP(s) of one or more cells, following examples may be provided.

In one example, the UE could monitor PDCCH(s)/PDCCH candidate(s) for beam indication DCI(s) only in a CORESET (e.g., in the overlapping PDCCH monitoring occasions and/or in the overlapping CCEs and/or in the overlapping search space sets with the lowest/highest aggregation level), and in any other CORESET from the multiple overlapping CORESETs (e.g., in the overlapping PDCCH monitoring occasions and/or in the overlapping CCEs and/or in the overlapping search space sets with the lowest/highest aggregation level) that have been configured with qcl-Type set to same “typeD” properties as the CORESET, on the active DL BWP of a cell from the one or more cells, wherein the CORESET could correspond to the CSS set with the lowest index in the cell with the lowest index containing CSS, if any; otherwise, to the USS set with the lowest index in the cell with lowest index; here, the lowest USS set index is determined over all USS sets with at least one PDCCH candidate in the overlapping PDCCH monitoring occasions and/or in the overlapping CCEs of the overlapping CORESETs.

In another example, if the UE is further configured/provided/indicated by the network, e.g., via higher layer parameter two-QCLTypeDforPDCCHRepetition, two QCL “typeD” properties for receiving PDCCH repetitions, the UE could monitor PDCCH(s)/PDCCH candidate(s) for beam indication DCI(s) only in a first CORESET (e.g., in the overlapping PDCCH monitoring occasions and/or in the overlapping CCEs and/or in the overlapping search space sets with the lowest/highest aggregation level) with qcl-Type set to first “typeD” properties (e.g., associated with the first indicated TCI state/pair of TCI states specified herein in the present disclosure) and, if any, in a second CORESET (e.g., in the overlapping PDCCH monitoring occasions and/or in the overlapping CCEs and/or in the overlapping search space sets with the lowest/highest aggregation level) with qcl-Type set to second “typeD” properties (e.g., associated with the second indicated TCI state/pair of TCI states specified herein in the present disclosure) that are different than the first “typeD” properties, and in any other CORESET (e.g., in the overlapping PDCCH monitoring occasions and/or in the overlapping CCEs and/or in the overlapping search space sets with the lowest/highest aggregation level) from the multiple CORESETs with corresponding qcl-Type set to the first “typeD” properties and/or to the second “typeD” properties, wherein the first CORESET could correspond to the CSS set with the lowest index in the cell with the lowest index containing CSS sets, if any; otherwise, to the USS set with the lowest index in the cell with lowest index excluding CSS sets and USS sets associated with CORESETs with qcl-Type set to first “typeD” properties, the second CORESET could correspond to the CSS set with the lowest index in the cell with the lowest index containing CSS sets, if any; otherwise, to the USS set with the lowest index in the cell with lowest index, where the CSS set or the USS set includes searchSpaceLinking with a value indicating, respectively, any CSS set or any USS set associated with CORESETs with qcl-Type set to first “typeD” properties; here, the lowest USS set index is determined over all USS sets with at least one PDCCH candidate for beam indication DCI in overlapping PDCCH monitoring occasions and/or overlapping CCEs.

In yet another example, if one or more of the multiple (overlapping) CORESETs have more than one (e.g., two) active/activated TCI states/pairs of TCI states and the UE reports a capability signaling, e.g., twoTypeDcapability, to indicate to the network that they are capable of/able to simultaneously monitor PDCCH candidate(s) received in a CORESET with more than one (e.g., two) active/activated TCI states/pairs of TCI states, the UE could monitor PDCCH(s)/PDCCH candidate(s) for beam indication DCI(s) only in a CORESET (e.g., in the overlapping PDCCH monitoring occasions and/or in the overlapping CCEs and/or in the overlapping search space sets with the lowest/highest aggregation level) with a first qcl-Type set to first “typeD” properties (e.g., associated with the first indicated TCI state/pair of TCI states) and, if any, a second qcl-Type set to second “typeD” properties (e.g., associated with the second indicated TCI state/pair of TCI states) that are different than the first “typeD” properties, and in any other CORESET (e.g., in the overlapping PDCCH monitoring occasions and/or in the overlapping CCEs and/or in the overlapping search space sets with the lowest/highest aggregation level) from the multiple CORESETs with corresponding qcl-Type set to the first “typeD” properties or to the second “typeD” properties, wherein the CORESET could correspond to the CSS set with the lowest index in the cell with the lowest index containing CSS, if any; otherwise, to the USS set with the lowest index in the cell with lowest index; here, the lowest USS set index is determined over all USS sets with at least one PDCCH candidate for beam indication DCI in overlapping PDCCH monitoring occasions and/or overlapping CCEs.

In yet another example, if the UE monitors PDCCH candidates for beam indication DCI(s) in multiple overlapping CORESETs (e.g., with overlapping PDCCH monitoring occasions and/or with overlapping CCEs and/or etc.)—e.g., each CORESET could be associated/configured with a valid indicator/parameter provided/configured/indicated in the corresponding ControlResourceSet discussed/specified herein in the present disclosure—that have been configured with same or different qcl-Type set to “typeD” properties on active DL BWP(s) of one or more cells, the UE could always apply the first indicated TCI state/pair of TCI state to monitor at least the overlapping PDCCH(s)/PDCCH candidate(s) for beam indication DCI(s) in the multiple CORESETs (e.g., in the overlapping PDCCH monitoring occasions and/or in the overlapping CCEs and/or in the overlapping search space sets)—i.e., the UE could always assume that the DM-RS port(s) of at least the overlapping PDCCH(s)/PDCCH candidate(s) for beam indication DCI(s) in the multiple CORESETs (e.g., in the overlapping PDCCH monitoring occasions and/or in the overlapping CCEs and/or in the overlapping search space sets) is quasi co-located with the RS(s) in the RS set(s) indicated/provided in the first indicated TCI state/pair of TCI states.

Alternatively, the UE could always apply the second indicated TCI state/pair of TCI state to monitor at least the overlapping PDCCH(s)/PDCCH candidate(s) for beam indication DCI(s) in the multiple CORESETs (e.g., in the overlapping PDCCH monitoring occasions and/or in the overlapping CCEs and/or in the overlapping search space sets)—i.e., the UE could always assume that the DM-RS port(s) of at least the overlapping PDCCH(s)/PDCCH candidate(s) for beam indication DCI(s) in the multiple CORESETs (e.g., in the overlapping PDCCH monitoring occasions and/or in the overlapping CCEs and/or in the overlapping search space sets) is quasi co-located with the RS(s) in the RS set(s) indicated/provided in the second indicated TCI state/pair of TCI states; or optionally, for N=2 or M=2, the UE could always apply both of the first and second indicated TCI states/pairs of TCI state to monitor at least the overlapping PDCCH(s)/PDCCH candidate(s) for beam indication DCI(s) in the multiple CORESETs (e.g., in the overlapping PDCCH monitoring occasions and/or in the overlapping CCEs and/or in the overlapping search space sets)—i.e., the UE could always assume that the DM-RS port(s) of at least the overlapping PDCCH(s)/PDCCH candidate(s) for beam indication DCI(s) in the multiple CORESETs (e.g., in the overlapping PDCCH monitoring occasions and/or in the overlapping CCEs and/or in the overlapping search space sets) is quasi co-located with the RS(s) in the RS set(s) indicated/provided in both of the first and second indicated TCI states/pairs of TCI states.

In yet another example, if the UE monitors PDCCH candidates for beam indication DCI(s) in multiple overlapping CORESETs (e.g., with overlapping PDCCH monitoring occasions and/or with overlapping CCEs and/or etc.)—e.g., each CORESET could be associated/configured with a valid indicator/parameter provided/configured/indicated in the corresponding ControlResourceSet discussed/specified herein in the present disclosure—that have been configured with same or different qcl-Type set to “typeD” properties on active DL BWP(s) of one or more cells, the UE could be provided/indicated/configured by the network, e.g., via higher layer RRC signaling/parameter and/or MAC CE command and/or dynamic DCI based L1 signaling, to follow one or more of the following: (1) the UE could apply the first indicated TCI state/pair of TCI state to monitor at least the overlapping PDCCH(s)/PDCCH candidate(s) for beam indication DCI(s) in the multiple CORESETs (e.g., in the overlapping PDCCH monitoring occasions and/or in the overlapping CCEs and/or in the overlapping search space sets)—i.e., the UE could always assume that the DM-RS port(s) of at least the overlapping PDCCH(s)/PDCCH candidate(s) for beam indication DCI(s) in the multiple CORESETs (e.g., in the overlapping PDCCH monitoring occasions and/or in the overlapping CCEs and/or in the overlapping search space sets) is quasi co-located with the RS(s) in the RS set(s) indicated/provided in the first indicated TCI state/pair of TCI states, or (2) the UE could apply the second indicated TCI state/pair of TCI state to monitor at least the overlapping PDCCH(s)/PDCCH candidate(s) for beam indication DCI(s) in the multiple CORESETs (e.g., in the overlapping PDCCH monitoring occasions and/or in the overlapping CCEs and/or in the overlapping search space sets)—i.e., the UE could always assume that the DM-RS port(s) of at least the overlapping PDCCH(s)/PDCCH candidate(s) for beam indication DCI(s) in the multiple CORESETs (e.g., in the overlapping PDCCH monitoring occasions and/or in the overlapping CCEs and/or in the overlapping search space sets) is quasi co-located with the RS(s) in the RS set(s) indicated/provided in the second indicated TCI state/pair of TCI states, or (3) for N=2 or M=2, the UE could apply both of the first and second indicated TCI states/pairs of TCI state to monitor at least the overlapping PDCCH(s)/PDCCH candidate(s) for beam indication DCI(s) in the multiple CORESETs (e.g., in the overlapping PDCCH monitoring occasions and/or in the overlapping CCEs and/or in the overlapping search space sets)—i.e., the UE could always assume that the DM-RS port(s) of at least the overlapping PDCCH(s)/PDCCH candidate(s) for beam indication DCI(s) in the multiple CORESETs (e.g., in the overlapping PDCCH monitoring occasions and/or in the overlapping CCEs and/or in the overlapping search space sets) is quasi co-located with the RS(s) in the RS set(s) indicated/provided in both of the first and second indicated TCI states/pairs of TCI states.

In yet another example, if the UE monitors PDCCH candidates for beam indication DCI(s) in multiple overlapping CORESETs (e.g., with overlapping PDCCH monitoring occasions and/or with overlapping CCEs and/or etc.)—e.g., each CORESET could be associated/configured with a valid indicator/parameter provided/configured/indicated in the corresponding ControlResourceSet discussed/specified herein in the present disclosure—that have been configured with same or different qcl-Type set to “typeD” properties on active DL BWP(s) of one or more cells, the UE could apply the first indicated TCI state/pair of TCI state and/or the second indicated TCI state/pair of TCI states and/or both of the first and second indicated TCI states/pairs of TCI states simultaneously to monitor at least the overlapping PDCCH(s)/PDCCH candidate(s) for beam indication DCI(s) in the multiple CORESETs (e.g., in the overlapping PDCCH monitoring occasions and/or in the overlapping CCEs and/or in the overlapping search space sets)—i.e., the UE could assume that the DM-RS port(s) of at least the overlapping PDCCH(s)/PDCCH candidate(s) for beam indication DCI(s) in the multiple CORESETs (e.g., in the overlapping PDCCH monitoring occasions and/or in the overlapping CCEs and/or in the overlapping search space sets) is quasi co-located with the RS(s) in the RS set(s) indicated/provided in the first indicated TCI state/pair of TCI states and/or the second indicated TCI state/pair of TCI states and/or at the same time both of the first and second indicated TCI states/pairs of TCI states.

In one embodiment, the UE could be indicated/configured/provided/informed by the network, e.g., via higher layer RRC signaling and/or MAC CE command and/or dynamic DCI based L1 signaling, when (start and/or end) to follow the indicator/parameter provided/indicated/configured in the higher layer parameter PDSCH-Config as specified herein in the present disclosure for determining the association between the indicated TCI state(s) and the PDSCH reception(s). The UE could also be indicated/configured/provided/informed by the network, e.g., via higher layer RRC signaling and/or MAC CE command and/or dynamic DCI based L1 signaling, when (start and/or end) to follow the dynamic TRP(s) selection/switching methods specified herein in the present disclosure (e.g., the design examples as shown in the present disclosure for determining the association between the indicated TCI state(s) and the PDSCH reception(s).

In one example, the UE could be indicated/configured/provided by the network, e.g., via higher layer RRC signaling and/or MAC CE command and/or dynamic DCI based signaling, a first application timer; the UE could follow the indicator/parameter provided/indicated/configured in the higher layer parameter PDSCH-Config as specified herein in the present disclosure to determine the association between the indicated TCI state(s) and the PDSCH reception(s) before the first application timer expires.

In addition, the UE could be indicated/configured/provided by the network, e.g., via higher layer RRC signaling and/or MAC CE command and/or dynamic DCI based signaling, a second application timer; the UE could follow the dynamic TRP(s) selection/switching methods specified herein in the present disclosure (e.g., the design examples as shown in the present disclosure to determine the association between the indicated TCI state(s) and the PDSCH reception(s) before the second application timer expires. The first application timer could be the same as or different from the second application timer. The first application timer could have higher or lower priority than the second application timer. The first and/or second application timers could be reset by the network (e.g., via higher layer RRC signaling and/or MAC CE command and/or dynamic DCI based signaling), and/or according to one or more events such as TCI state(s) update.

In another example, the UE could be indicated/configured/provided by the network, e.g., via higher layer RRC signaling and/or MAC CE command and/or dynamic DCI based signaling, a first application time window/period; the UE could follow the indicator/parameter provided/indicated/configured in the higher layer parameter PDSCH-Config as specified herein in the present disclosure to determine the association between the indicated TCI state(s) and the PDSCH reception(s) within the first application time window/period.

In addition, the UE could be indicated/configured/provided by the network, e.g., via higher layer RRC signaling and/or MAC CE command and/or dynamic DCI based signaling, a second application time window/period; the UE could follow the dynamic TRP(s) selection/switching methods specified herein in the present disclosure (e.g., the design examples as shown in the present disclosure to determine the association between the indicated TCI state(s) and the PDSCH reception(s) within the second application time window/period. The first application time window/period could be the same as or different from the second application time window/period.

In yet another example, when/if the UE is indicated/provided/configured by the network, e.g., via beam indication/activation MAC CE and/or one or more TCI codepoints in one or more TCI fields in the beam indication DCI (e.g., DCI format 1_1 or 1_2 with or without DL assignment), N>1 or M>1 (e.g., N=2 or M=2) TCI states/pairs of TCI states update(s)/indication(s), the UE could follow the indicator/parameter provided/indicated/configured in the higher layer parameter PDSCH-Config as specified herein in the present disclosure to determine the association between the indicated TCI state(s) and the PDSCH reception(s).

When/if the UE is indicated/provided/configured by the network, e.g., via beam indication/activation MAC CE and/or one or more TCI codepoints in one or more TCI fields in the beam indication DCI (e.g., DCI format 1_1 or 1_2 with or without DL assignment), a single (e.g., N=1 or M=1) TCI state/pair of TCI states update(s)/indication(s), the UE could follow the dynamic TRP(s) selection/switching methods specified herein in the present disclosure (e.g., the design examples as shown in the present disclosure) to determine the association between the indicated TCI state(s) and the PDSCH reception(s).

In yet another example, when/if the UE is indicated/provided/configured by the network, e.g., via beam indication/activation MAC CE and/or one or more TCI codepoints in one or more TCI fields in the beam indication DCI (e.g., DCI format 1_1 or 1_2 with or without DL assignment), a single (e.g., N=1 or M=1) TCI state/pair of TCI states update(s)/indication(s), the UE could follow the indicator/parameter provided/indicated/configured in the higher layer parameter PDSCH-Config as specified herein in the present disclosure to determine the association between the indicated TCI state(s) and the PDSCH reception(s).

When/if the UE is indicated/provided/configured by the network, e.g., via beam indication/activation MAC CE and/or one or more TCI codepoints in one or more TCI fields in the beam indication DCI (e.g., DCI format 1_1 or 1_2 with or without DL assignment), N>1 or M>1 (e.g., N=2 or M=2) TCI states/pairs of TCI states update(s)/indication(s), the UE could follow the dynamic TRP(s) selection/switching methods specified herein in the present disclosure (e.g., the design examples a as shown in the present disclosure) to determine the association between the indicated TCI state(s) and the PDSCH reception(s).

In yet another example, when/if the UE receives from the network, e.g., via higher layer RRC signaling (e.g., in PDSCH-Config), a higher layer parameter “beamSelectionPDSCH” set to “enabled,” the UE could follow the indicator/parameter provided/indicated/configured in the higher layer parameter PDSCH-Config as specified herein in the present disclosure to determine the association between the indicated TCI state(s) and the PDSCH reception(s); otherwise, e.g., when/if the higher layer parameter “beamSelectionPDSCH” is set to “disabled,” the UE could follow the dynamic TRP(s) selection/switching methods specified herein in the present disclosure (e.g., the design examples as shown in the present disclosure) to determine the association between the indicated TCI state(s) and the PDSCH reception(s).

Alternatively, when/if the UE receives from the network, e.g., via higher layer RRC signaling (e.g., in PDSCH-Config), higher layer parameter(s) “dynamicBeamSelectionPDSCH” or “dynamicBeamSelectionCoreset” or “dynamicBeamSelectionTCI” or “dynamicBeamSelectionDCI” specified/defined herein in the present disclosure set to “enabled,” the UE could follow the dynamic TRP(s) selection/switching methods specified herein in the present disclosure (e.g., the design examples as shown in the present disclosure) to determine the association between the indicated TCI state(s) and the PDSCH reception(s); otherwise, e.g., when/if the higher layer parameter(s) “dynamicBeamSelectionPDSCH” or “dynamicBeamSelectionCoreset” or “dynamicBeamSelectionTCI” or “dynamicBeamSelectionDCI” specified/defined herein in the present disclosure is set to “disabled,” the UE could follow the indicator/parameter provided/indicated/configured in the higher layer parameter PDSCH-Config as specified herein in the present disclosure to determine the association between the indicated TCI state(s) and the PDSCH reception(s).

In the present disclosure, CORESET(s) associated/configured with the indicator/parameter in the corresponding ControlResourceSet set to “0” (or “1,” “00,” “01,” “10,” or “11”) could correspond to UE specific search space (USS) CORESET(s) or vice versa, and/or CORESET(s) associated/configured with the indicator/parameter in the corresponding ControlResourceSet set to “1” (or “0,” “00,” “01,” “10,” or “11”) could correspond to common search space (CSS) CORESET(s) or vice versa. Furthermore, the indicator/parameter that is provided/configured/indicated in ControlResourceSet discussed/specified herein in the present disclosure could be one or more TCI state indexes/IDs, one or more indexes of TCI codepoints activated by a MAC CE, and etc.

In the present disclosure, the first PDCCH(s)/PDCCH candidate(s) and/or the second PDCCH(s)/PDCCH candidate(s) could correspond to or could be determined according to one or more of the following design examples or combination(s) of one or more of the following design examples.

In one example, the first PDCCH(s)/PDCCH candidate(s) and the second PDCCH(s)/PDCCH candidate(s) could be the same/identical. For this case, the first PDCCH(s)/PDCCH candidate(s) and the second PDCCH(s)/PDCCH candidate(s) could be received in the same CORESET associated/configured with more than one (e.g., two) active/activated TCI states/pairs of TCI states.

In another example, the first PDCCH(s)/PDCCH candidate(s) and the second PDCCH(s)/PDCCH candidate(s) could be received in search space sets/CORESETs that are higher layer linked, e.g., via a higher layer parameter SearchSpaceLinking.

In yet another example, the first (or second) PDCCH(s)/PDCCH candidate(s) could be received in a CORESET associated/configured with more than one (e.g., two) active/activated TCI states/pairs of TCI states, and the second (or first) PDCCH(s)/PDCCH candidate(s) could be received in a search space set/CORESET higher layer configured with a higher layer parameter SearchSpaceLinking.

In the present disclosure, the first PDSCH(s) and/or the second PDSCH(s) could correspond to or could be determined according to one or more of the following design examples or combination(s) of one or more of the following design examples.

In one example, when a UE is configured/provided/indicated by the network the higher layer parameter repetitionScheme set to “fdmSchemeA,” the UE may receive a single PDSCH transmission occasion of the transport block (TB), and may assume that precoding granularity is PBWP resource blocks in the frequency domain, where PBWP can be equal to one of the values among {2, 4, wideband}. For N=2 or M=2, if PBWP is configured/determined as “wideband,” the first (or second) PDCCH(s) could correspond to the first ┌n_{PRB}/2┐ PRBs, and the second (or first) PDSCH(s) could correspond to the remaining └n_{PRB}/2┘ PRBs, where n_{PRB} is the total number of allocated PRBs for the UE. If PBWP is configured/determined as one of the values among {2, 4}, the first (or second) PDSCH(s) could correspond to even precoding resource block groups (PRGs) within the allocated frequency domain resources, and the second (or first) PDSCH(s) could correspond to odd PRGs within the allocated frequency domain resources, wherein the PRGs are numbered continuously in increasing order with the first PRG index equal to 0.

In another example, when a UE is configured/provided/indicated by the network the higher layer parameter repetitionScheme set to “fdmSchemeB,” the UE may receive two PDSCH transmission occasions of the same TB, and may assume that precoding granularity is PBWP resource blocks in the frequency domain, where PBWP can be equal to one of the values among {2, 4, wideband}. For N=2 or M=2, if PBWP is configured/determined as “wideband,” the first (or second) PDCCH(s) could correspond to the first ┌n_{PRB}/2┐ PRBs, and the second (or first) PDSCH(s) could correspond to the remaining └n_{PRB}/2┘ PRBs, where n_{PRB} is the total number of allocated PRBs for the UE. If PBWP is configured/determined as one of the values among {2, 4}, the first (or second) PDSCH(s) could correspond to even precoding resource block groups (PRGs) within the allocated frequency domain resources, and the second (or first) PDSCH(s) could correspond to odd PRGs within the allocated frequency domain resources, wherein the PRGs are numbered continuously in increasing order with the first PRG index equal to 0.

In yet another example, when a UE is configured/provided/indicated by the network the higher layer parameter repetitionScheme set to “tdmSchemeA,” the UE may receive two PDSCH transmission occasions of the transport block (TB) within a given slot. For this case, the first (or second) PDSCH(s) in the present disclosure could correspond to the first PDSCH transmission occasion and resource allocation in time domain for the first PDSCH transmission occasion follows those described in the 3GPP TS 38.214. The second (or first) PDSCH(s) in the present disclosure could correspond to the second PDSCH transmission occasion, and the second PDSCH transmission occasion may have the same number of symbols as the first PDSCH transmission occasion.

In yet another example, when a UE is configured/provided by the network the higher layer parameter repetitionNumber in PDSCH-TimeDomainResourceAllocation, the UE may expect to receive multiple slot level PDSCH transmission occasions of the same TB in the repetitionNumber consecutive slots. When the value indicated by repetitionNumber in PDSCH-TimeDomainResourceAllocation equals to two, the first (or second) PDSCH(s) could correspond to the first PDSCH transmission occasion and resource allocation in time domain for the first PDSCH transmission occasion follows those described in the 3GPP TS 38.214 and the second (or first) PDSCH(s) could correspond to the second PDSCH transmission occasion. When the value of repetitionNumber in PDSCH-TimeDomainResourceAllocation is larger than two, the UE may be further configured to enable cyclicMapping or sequentialMapping.

When cyclicMapping is enabled, the first (or second) PDSCH(s) and the second (or first) PDSCH(s) could correspond to the first PDSCH transmission occasion and the second PDSCH transmission occasion, respectively, and the same mapping pattern continues to the remaining PDSCH transmission occasions. When sequentialMapping is enabled, the first (or second) PDSCH(s) could correspond to the first and second PDSCH transmission occasions, and the second (or first) PDSCH(s) could correspond to the third and fourth PDSCH transmission occasions, and the same mapping pattern continues to the remaining PDSCH transmission occasions.

In one embodiment, the UE could be indicated/configured/provided by the network, e.g., via higher layer RRC signalling/parameter and/or MAC CE command and/or dynamic DCI based L1 signalling, the association/mapping between one or more CORESETs and one or more unified TCI states/pairs of TCI states specified herein in the present disclosure. Specifically, a CORESET provided by ControlResourceSet could be associated/configured with one or more TCI states or TCI state IDs/indexes, one or more groups of TCI states or TCI state IDs/indexes or one or more lists of TCI states or TCI state IDs/indexes.

In one example, as specified in the present disclosure, a UE could be (higher layer RRC) provided/indicated/configured by the network a list of joint TCI states each provided by DLorJointTCIState and/or a list of UL TCI states each provided by UL-TCIState, wherein the list of joint TCI states could be provided by, e.g., listDLorJointTCIState, and the list of UL TCI states could be provided by, e.g., listULTCIState. The UE could be further provided/indicated/configured by the network, e.g., via higher layer RRC signaling/parameter and/or MAC CE command and/or dynamic DCI based signaling, one or more groups of (joint) TCI states or TCI state IDs/indexes from the list of joint TCI states or TCI state IDs/indexes each provided by DLorJointTCIState, and/or one or more groups of (UL) TCI states or TCI state IDs/indexes from the list of uplink TCI states or TCI state IDs/indexes each provided by ULTCI-State. Each group of joint/UL TCI states or TCI state IDs/indexes could have a TCI state group ID/index.

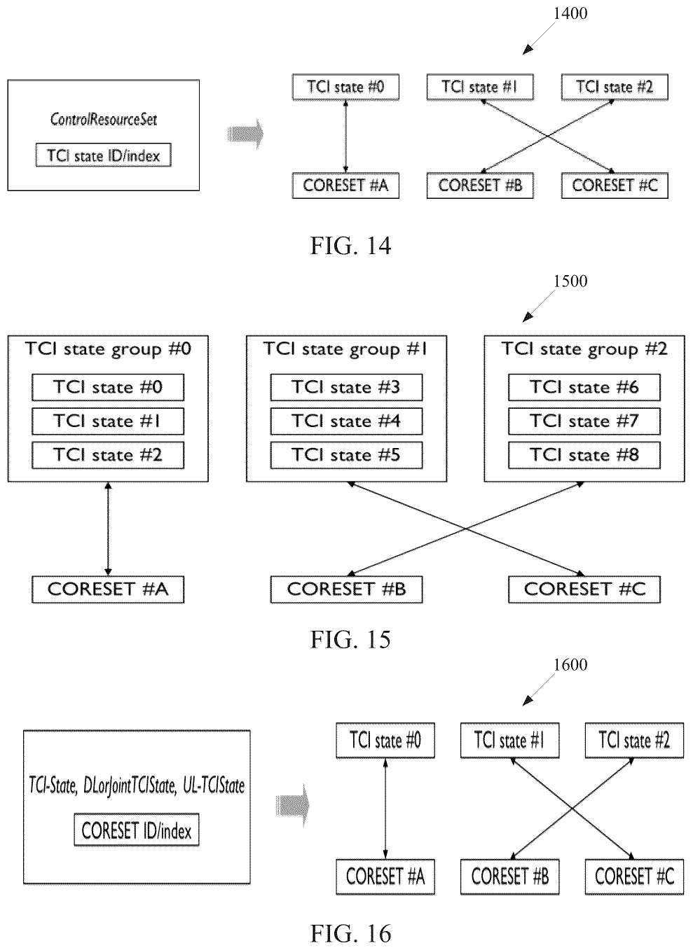

FIG. 14 illustrates an example of associating CORESETs with/to TCI states 1400 according to embodiments of the present disclosure. An embodiment of associating the CORESETs and the TCI states 1400 shown in FIG. 14 is for illustration only.

For example, the higher layer parameter ControlResourceSet that configures a CORESET could comprise/include/contain/have at least one TCI state ID/index. For this case, the CORESET provided by the corresponding ControlResourceSet could be associated/configured with the TCI state or TCI state ID/index indicated/configured/provided therein. In FIG. 14, a conceptual example characterizing associating CORESET(s) and TCI state ID(s)/index(es) via providing/configuring/indicating TCI state ID(s)/index(es) in ControlResourceSet is provided.

For another example, the higher layer parameter ControlResourceSet that configures a CORESET could comprise/include/contain/have a set of TCI state IDs/indexes. For this case, the CORESET provided by the corresponding ControlResourceSet could be associated/configured with the TCI states provided by the TCI state IDs/indexes in the set.

Yet for another example, the higher layer parameter ControlResourceSet that configures a CORESET could comprise/include/contain/have at least one TCI state group ID/index. For this case, the CORESET provided by the corresponding ControlResourceSet could be associated/configured with the TCI states or TCI state IDs/indexes in the TCI state group provided by the corresponding TCI state group ID/index.

Yet for another example, the higher layer parameter ControlResourceSet that configures a CORESET could comprise/include/contain/have at least one TCI state list ID/index (e.g., list ID/index of listDLorJointTCIState or list ID/index of listULTCIState). For this case, the CORESET provided by the corresponding ControlResourceSet could be associated/configured with the TCI states or TCI state IDs/indexes in the list of joint TCI states or UL TCI states provided by the corresponding TCI state list ID/index.

FIG. 15 illustrates another example of associating CORESET with/to TCI states 1500 according to embodiments of the present disclosure. An embodiment of associating the CORESETs and the TCI states 1500 shown in FIG. 15 is for illustration only.

Yet for another example, a TCI state group as discussed herein in the present disclosure could be provided by higher layer parameter groupDLorJointTCIState (for joint TCI state group) or groupULTCIState (for UL TCI state group). In one example, the higher layer parameter groupDLorJointTCIState or groupULTCIState discussed/specified herein in the present disclosure could comprise/contain/provide/indicate at least one CORESET ID/index; for this case, the TCI state IDs/indexes in the list of TCI states/TCI state IDs/indexes provided by the corresponding higher layer parameter could be associated/configured with the CORESET ID/index (and therefore, the corresponding CORESET) indicated therein.

In FIG. 15, a conceptual example characterizing the association/mapping between one or more CORESETs and one or more TCI state groups—and therefore, the corresponding TCI states/TCI state IDs provided therein—is presented. Alternatively, the higher layer parameter listDLorJointTCIState or listULTCIState could comprise/contain/provide/indicate a CORESET pool ID/index (e.g., CORESETPoolIndex with value 0 or 1 configured in PDCCH-Config/PDSCH-Config); for this case, the TCI state IDs/indexes in the list of TCI states/TCI state IDs/indexes provided by the corresponding higher layer parameter could be associated/configured with the CORESET pool ID/index (and therefore, the corresponding CORESETs configured with the CORESETPoolIndex) indicated therein.

Optionally, the higher layer parameter listDLorJointTCIState or listULTCIState could comprise/contain/provide/indicate a CORESET group ID/index (e.g., CORESETGroupIndex with value 0 or 1 configured in PDCCH-Config/PDSCH-Config); for this case, the TCI state IDs/indexes in the list of TCI states/TCI state IDs/indexes provided by the corresponding higher layer parameter could be associated/configured with the CORESET group ID/index (and therefore, the corresponding CORESETs configured with the CORESETGroupIndex) indicated therein.

Yet for another example, the higher layer parameter listDLorJointTCIState or listULTCIState discussed/specified herein in the present disclosure could comprise/contain/provide/indicate at least one CORESET ID/index; for this case, the TCI state IDs/indexes in the list of TCI states/TCI state IDs/indexes provided by the corresponding higher layer parameter could be associated/configured with the CORESET ID/index (and therefore, the corresponding CORESET) indicated therein. Alternatively, the higher layer parameter listDLorJointTCIState or listULTCIState could comprise/contain/provide/indicate a CORESET pool ID/index (e.g., CORESETPoolIndex with value 0 or 1 configured in PDCCH-Config/PDSCH-Config); for this case, the TCI state IDs/indexes in the list of TCI states/TCI state IDs/indexes provided by the corresponding higher layer parameter could be associated/configured with the CORESET pool ID/index (and therefore, the corresponding CORESETs configured with the CORESETPoolIndex) indicated therein.

Optionally, the higher layer parameter listDLorJointTCIState or listULTCIState could comprise/contain/provide/indicate a CORESET group ID/index (e.g., CORESETGroupIndex with value 0 or 1 configured in PDCCH-Config/PDSCH-Config); for this case, the TCI state IDs/indexes in the list of TCI states/TCI state IDs/indexes provided by the corresponding higher layer parameter could be associated/configured with the CORESET group ID/index (and therefore, the corresponding CORESETs configured with the CORESETGroupIndex) indicated therein.

Yet for another example, a TCI state group as discussed herein in the present disclosure could be provided by higher layer parameter groupDLorJointTCIState (for joint TCI state group) or groupULTCIState (for UL TCI state group). In one example, the higher layer parameter groupDLorJointTCIState or groupULTCIState discussed/specified herein in the present disclosure could comprise/contain/provide/indicate a set of CORESET IDs/indexes. In one example, the first TCI state ID/index in the TCI state group could be mapped to the first CORESET in the set, the second TCI state ID/index in the TCI state group could be mapped to the second CORESET in the set, and so on. In another example, the TCI state IDs/indexes provided in the TCI state group could be mapped to the set of CORESETs with their respective CORESET IDs/indexes in a descending (or an ascending) order.

In yet another example, one or more CORESETs in the set, e.g., sorted with their respective CORESET IDs/indexes in a descending or an ascending order, could be mapped to the TCI state IDs/indexes provided in the TCI state group in a descending (or an ascending) order. In yet another example, the CORESET IDs/indexes (and therefore, the corresponding CORESETs) in the set could be (one-to-one) mapped to the TCI state IDs/indexes in the TCI state group; here, the mapping could be according to their IDs/indexes in a descending or an ascending order, or alternatively, the mapping could be based on their positions/ordering in their respective group/set. For the design examples discussed herein in the present disclosure, if a CORESET ID/index is associated to a TCI state ID/index in the TCI state group, the corresponding CORESET is therefore associated to the TCI state provided by the TCI state ID/index.

Yet for another example, a TCI state group as discussed herein in the present disclosure could be provided by higher layer parameter groupDLorJointTCIState (for joint TCI state group) or groupULTCIState (for UL TCI state group). In one example, the higher layer parameter groupDLorJointTCIState or groupULTCIState discussed/specified herein in the present disclosure could comprise/contain/provide/indicate a set of CORESET pool/group indexes. In one example, the first TCI state ID/index in the TCI state group could be mapped to the first CORESET pool/group index (and therefore, the CORESETs configured/associated with the corresponding CORESET pool/group index) in the set, the second TCI state ID/index in the TCI state group could be mapped to the second CORESET pool/group index (and therefore, the CORESETs configured/associated with the corresponding CORESET pool/group index) in the set, and so on.

In another example, the TCI state IDs/indexes provided in the TCI state group could be mapped to the CORESET pool/group indexes (and therefore, the CORESETs configured/associated with the corresponding CORESET pool/group index) in the set in a descending (or an ascending) order. In yet another example, one or more CORESET pool/group indexes (and therefore, the CORESETs configured/associated with the corresponding CORESET pool/group index) in the set, e.g., sorted in a descending or an ascending order, could be mapped to the TCI state IDs/indexes in the TCI state group in a descending (or an ascending) order.

In yet another example, the CORESET pool/group indexes (and therefore, the CORESETs configured/associated with the corresponding CORESET group/pool indexes) in the set could be (one-to-one) mapped to the TCI state IDs/indexes provide in the TCI state group; here, the mapping could be according to their IDs/indexes in a descending or an ascending order, or alternatively, the mapping could be based on their positions/ordering in their respective group/set. For the design examples discussed herein in the present disclosure, if a CORESET group/pool index is associated to a TCI state ID/index, the CORESETs associated/configured with the corresponding CORESET group/pool index could be therefore associated to the TCI state provided by the TCI state ID/index.

Yet for another example, the higher layer parameter listDLorJointTCIState or listULTCIState discussed/specified herein in the present disclosure could comprise/contain/provide/indicate a set of CORESET IDs/indexes. In one example, the first TCI state group ID/index provided in the list (e.g., listDLorJointTCIState or listULTCIState) could be mapped to the first CORESET in the set, the second TCI state group ID/index provided in the list (e.g., listDLorJointTCIState or listULTCIState) could be mapped to the second CORESET in the set, and so on. In another example, the TCI state group IDs/indexes provided in the list (e.g., listDLorJointTCIState or listULTCIState) could be mapped to the set of CORESETs with their respective CORESET IDs/indexes in a descending (or an ascending) order. In yet another example, one or more CORESETs in the set, e.g., sorted with their respective CORESET IDs/indexes in a descending or an ascending order, could be mapped to the TCI state group IDs/indexes provided in the list (e.g., listDLorJointTCIState or listULTCIState) in a descending (or an ascending) order.

In yet another example, the CORESET IDs/indexes (and therefore, the corresponding CORESETs) in the set could be (one-to-one) mapped to the TCI state group IDs/indexes provided in the list (e.g., listDLorJointTCIState or listULTCIState); here, the mapping could be according to their IDs/indexes in a descending or an ascending order, or alternatively, the mapping could be based on their positions/ordering in their respective list/set. For the design examples discussed herein in the present disclosure, if a CORESET ID/index or a CORESET is associated to a TCI state group ID/index, the CORESET ID/index or the CORESET is therefore associated to the TCI states or TCI state IDs/indexes in the TCI state group provided by the TCI state group ID/index.

Yet for another example, the higher layer parameter listDLorJointTCIState or listULTCIState discussed/specified herein in the present disclosure could comprise/contain/provide/indicate a set of CORESET pool/group indexes. In one example, the first TCI state group ID/index provided in the list (e.g., listDLorJointTCIState or listULTCIState) could be mapped to the first CORESET pool/group index (and therefore, the CORESETs configured/associated with the corresponding CORESET pool/group index) in the set, the second TCI state group ID/index provide in the list (e.g., listDLorJointTCIState or listULTCIState) could be mapped to the second CORESET pool/group index (and therefore, the CORESETs configured/associated with the corresponding CORESET pool/group index) in the set, and so on.

In another example, the TCI state group IDs/indexes provided in the list (e.g., listDLorJointTCIState or listULTCIState) could be mapped to the CORESET pool/group indexes (and therefore, the CORESETs configured/associated with the corresponding CORESET pool/group index) in the set in a descending (or an ascending) order. In yet another example, one or more CORESET pool/group indexes (and therefore, the CORESETs configured/associated with the corresponding CORESET pool/group index) in the set, e.g., sorted in a descending or an ascending order, could be mapped to the TCI state group IDs/indexes in the list (e.g., listDLorJointTCIState or listULTCIState) in a descending (or an ascending) order.

In yet another example, the CORESET pool/group indexes (and therefore, the CORESETs configured/associated with the corresponding CORESET group/pool indexes) in the set could be (one-to-one) mapped to the TCI state group IDs/indexes provide in the list (e.g., listDLorJointTCIState or listULTCIState); here, the mapping could be according to their IDs/indexes in a descending or an ascending order, or alternatively, the mapping could be based on their positions/ordering in their respective list/set. For the design examples discussed herein in the present disclosure, if a CORESET group/pool index is associated to a TCI state group ID/index, the CORESETs associated/configured with the corresponding CORESET group/pool index could be therefore associated to the TCI states or TCI state IDs/indexes in the TCI state group provided by the TCI state group ID/index.

Yet for another example, the UE could be provided/configured/indicated by the network, e.g., via higher layer RRC signaling (e.g., in PDCCH-Config) and/or MAC CE command and/or DCI based L1 signaling, a set of TCI state IDs/indexes each associated/corresponding to a CORESET. In one example, the first TCI state ID/index in the set could be mapped to the first CORESET, the second TCI state ID/index in the set could be mapped to the second CORESET, and so on. In another example, the TCI state IDs/indexes in the set could be mapped to the CORESETs with their respective CORESET IDs/indexes in a descending (or an ascending) order. In yet another example, one or more CORESETs, e.g., sorted with their respective CORESET IDs/indexes in a descending or an ascending order, could be mapped to the TCI state IDs/indexes in the set in a descending (or an ascending) order.

In yet another example, a set of one or more CORESET IDs/indexes could be provided/configured/indicated in the same RRC/MAC CE/DCI signaling/parameter as the set of TCI state IDs/indexes; for this case, the CORESET IDs/indexes (and therefore, the corresponding CORESETs) in the set could be (one-to-one) mapped to the TCI state IDs/indexes in the set; here, the mapping could be according to their IDs/indexes in a descending or an ascending order, or alternatively, the mapping could be based on their positions/ordering in their respective sets. For the design examples discussed herein in the present disclosure, if a CORESET ID/index or a CORESET is associated to a TCI state ID/index, the CORESET ID/index or the CORESET is therefore associated to the TCI state provided by the TCI state ID/index.

Yet for another example, the UE could be provided/configured/indicated by the network, e.g., via higher layer RRC signaling (e.g., in PDCCH-Config) and/or MAC CE command and/or DCI based L1 signaling, a set of TCI state IDs/indexes each associated/corresponding to a CORESET pool/group (and therefore, the CORESETs configured/associated with the corresponding CORESET pool/group index). In one example, the first TCI state ID/index in the set could be mapped to the first CORESET pool/group index (and therefore, the CORESETs configured/associated with the corresponding CORESET pool/group index), the second TCI state ID/index in the set could be mapped to the second CORESET pool/group index (and therefore, the CORESETs configured/associated with the corresponding CORESET pool/group index), and so on. In another example, the TCI state IDs/indexes in the set could be mapped to the CORESETs with their associated/configured CORESET pool/group indexes in a descending (or an ascending) order. In yet another example, one or more CORESETs, e.g., sorted with their associated/configured CORESET pool/group indexes in a descending or an ascending order, could be mapped to the TCI state IDs/indexes in the set in a descending (or an ascending) order.

In yet another example, a set of one or more CORESET group/pool indexes could be provided/configured/indicated in the same RRC/MAC CE/DCI signaling/parameter as the set of TCI state IDs/indexes; for this case, the CORESET pool/group indexes (and therefore, the CORESETs configured/associated with the corresponding CORESET group/pool indexes) in the set could be (one-to-one) mapped to the TCI state IDs/indexes in the set; here, the mapping could be according to their IDs/indexes in a descending or an ascending order, or alternatively, the mapping could be based on their positions/ordering in their respective sets. For the design examples discussed herein in the present disclosure, if a CORESET group/pool index is associated to a TCI state ID/index, the CORESETs associated/configured with the corresponding CORESET group/pool index could be therefore associated to the TCI state provided by the TCI state ID/index.

Yet for another example, the UE could be provided/configured/indicated by the network, e.g., via higher layer RRC signaling (e.g., in PDCCH-Config) and/or MAC CE command and/or DCI based L1 signaling, a set of TCI state group IDs/indexes each associated/corresponding to a CORESET. In one example, the first TCI state group ID/index in the set could be mapped to the first CORESET, the second TCI state group ID/index in the set could be mapped to the second CORESET, and so on. In another example, the TCI state group IDs/indexes in the set could be mapped to the CORESETs with their respective CORESET IDs/indexes in a descending (or an ascending) order. In yet another example, one or more CORESETs, e.g., sorted with their respective CORESET IDs/indexes in a descending or an ascending order, could be mapped to the TCI state group IDs/indexes in the set in a descending (or an ascending) order.

In yet another example, a set of one or more CORESET IDs/indexes could be provided/configured/indicated in the same RRC/MAC CE/DCI signaling/parameter as the set of TCI state group IDs/indexes; for this case, the CORESET IDs/indexes (and therefore, the corresponding CORESETs) in the set could be (one-to-one) mapped to the TCI state group IDs/indexes in the set; here, the mapping could be according to their IDs/indexes in a descending or an ascending order, or alternatively, the mapping could be based on their positions/ordering in their respective sets. For the design examples discussed herein in the present disclosure, if a CORESET ID/index or a CORESET is associated to a TCI state group ID/index, the CORESET ID/index or the CORESET is therefore associated to the TCI states or TCI state IDs/indexes in the TCI state group provided by the TCI state group ID/index.

Yet for another example, the UE could be provided/configured/indicated by the network, e.g., via higher layer RRC signaling (e.g., in PDCCH-Config) and/or MAC CE command and/or DCI based L1 signaling, a set of TCI state group IDs/indexes each associated/corresponding to a CORESET pool/group (and therefore, the CORESETs configured/associated with the corresponding CORESET pool/group index). In one example, the first TCI state group ID/index in the set could be mapped to the first CORESET pool/group index (and therefore, the CORESETs configured/associated with the corresponding CORESET pool/group index), the second TCI state group ID/index in the set could be mapped to the second CORESET pool/group index (and therefore, the CORESETs configured/associated with the corresponding CORESET pool/group index), and so on. In another example, the TCI state group IDs/indexes in the set could be mapped to the CORESETs with their associated/configured CORESET pool/group indexes in a descending (or an ascending) order. In yet another example, one or more CORESETs, e.g., sorted with their associated/configured CORESET pool/group indexes in a descending or an ascending order, could be mapped to the TCI state group IDs/indexes in the set in a descending (or an ascending) order.

In yet another example, a set of one or more CORESET group/pool indexes could be provided/configured/indicated in the same RRC/MAC CE/DCI signaling/parameter as the set of TCI state group IDs/indexes; for this case, the CORESET pool/group indexes (and therefore, the CORESETs configured/associated with the corresponding CORESET group/pool indexes) in the set could be (one-to-one) mapped to the TCI state group IDs/indexes in the set; here, the mapping could be according to their IDs/indexes in a descending or an ascending order, or alternatively, the mapping could be based on their positions/ordering in their respective sets. For the design examples discussed herein in the present disclosure, if a CORESET group/pool index is associated to a TCI state group ID/index, the CORESETs associated/configured with the corresponding CORESET group/pool index could be therefore associated to the TCI states or TCI state IDs/indexes in the TCI state group provided by the TCI state group ID/index.

FIG. 16 illustrates yet another example of associating CORESETs with/to TCI states 1600 according to embodiments of the present disclosure. An embodiment of associating the CORESETs and the TCI states 1600 shown in FIG. 16 is for illustration only.

Yet for another example, the higher layer parameter TCI-State or DLorJointTCIState or ULTCI-State that configures a unified TCI state could comprise/include/contain/have at least one CORESET ID/index. For this case, the TCI state provided by the corresponding TCI-State/DLorJointTCIState/ULTCI-State could be associated/configured with the CORESET ID/index (and therefore, the corresponding CORESET) indicated/configured/provided therein. In FIG. 16, a conceptual example characterizing associating CORESET(s) and TCI state ID(s)/index(es) via providing/configuring/indicating CORESET ID(s)/index(es) in TCI-State, DLorJointTCIState or UL-TCIState is provided.

Yet for another example, the higher layer parameter TCI-State or DLorJointTCIState or ULTCI-State that configures a unified TCI state could comprise/include/contain/have a set of CORESET IDs/indexes. For this case, the TCI state provided by the corresponding TCI-State/DLorJointTCIState/ULTCI-State could be associated/configured with the CORESET IDs/indexes (and therefore, the corresponding CORESETs) indicated/configured/provided therein.

Yet for another example, the higher layer parameter TCI-State or DLorJointTCIState or ULTCI-State that configures a unified TCI state could comprise/include/contain/have at least one CORESET group/pool index. For this case, the TCI state provided by the corresponding TCI-State/DLorJointTCIState/ULTCI-State could be associated/configured with the CORESET group/pool index (and therefore, the corresponding CORESETs associated/configured with the CORESET group/pool index) indicated/configured/provided therein.

Yet for another example, the higher layer parameter TCI-State or DLorJointTCIState or ULTCI-State that configures a unified TCI state could comprise/include/contain/have a set of CORESET group/pool indexes. For this case, the TCI state provided by the corresponding TCI-State/DLorJointTCIState/ULTCI-State could be associated/configured with the set of CORESET group/pool indexes (and therefore, the corresponding CORESETs associated/configured with the set of CORESET group/pool indexes) indicated/configured/provided therein.

Yet for another example, the higher layer parameter ControlResourceSet that configures a CORESET could comprise/include/contain/have a one-bit indicator (e.g., with value 0 and/or 1). In one example, when/if the one-bit indicator is set to “0” (or “1”), the CORESET provided by the corresponding ControlResourceSet could be associated/configured with the first indicated TCI state/pair of TCI states (e.g., by one or more TCI codepoints of one or more TCI fields in the beam indication DCI), and when/if the one-bit indicator is set to “1” (or “0”), the CORESET provided by the corresponding ControlResourceSet could be associated/configured with the second indicated TCI state/pair of TCI states (e.g., by one or more TCI codepoints of one or more TCI fields in the beam indication DCI). In another example, a CORESET is associated to a TCI state if the same one-bit indicator (with the same value 0 or 1) as specified herein is provided/configured/indicated in ControlResourceSet that configures the CORESET and TCI-State/DLorJointTCIState/UL-TCIState that provides/configures the TCI state.

In yet another example, a CORESET is associated to a TCI state group (and therefore, the TCI states or TCI state IDs/indexes provided therein) if the same one-bit indicator (with the same value 0 or 1) as specified herein is provided/configured/indicated in ControlResourceSet that configures the CORESET and groupDLorJointTCIState or groupULTCIState that provides/configures the TCI state group. In yet another example, a CORESET is associated to a list of higher layer configured TCI states (and therefore, the TCI states or TCI state IDs/indexes provided therein) if the same one-bit indicator (with the same value 0 or 1) as specified herein is provided/configured/indicated in ControlResourceSet that configures the CORESET and listDLorJointTCIState or listULTCIState that provides/configures the TCI state list.

Yet for another example, the higher layer parameter ControlResourceSet that configures a CORESET could comprise/include/contain/have a one-bit indicator (e.g., with value 0 and/or 1). In one example, when/if the one-bit indicator is set to “0” (or “1”), the CORESET provided by the corresponding ControlResourceSet could be associated/configured with the first and/or second indicated TCI states/pairs of TCI states (e.g., by one or more TCI codepoints of one or more TCI fields in the beam indication DCI), and when/if the one-bit indicator is set to “1” (or “0”), the CORESET provided by the corresponding ControlResourceSet could be associated/configured with the second and/or first indicated TCI states/pairs of TCI states (e.g., by one or more TCI codepoints of one or more TCI fields in the beam indication DCI). In another example, a CORESET is associated to a TCI state if the same one-bit indicator (with the same value 0 or 1) as specified herein is provided/configured/indicated in ControlResourceSet that configures the CORESET and TCI-State/DLorJointTCIState/UL-TCIState that provides/configures the TCI state. In yet another example, a CORESET is associated to a TCI state group (and therefore, the TCI states or TCI state IDs/indexes provided therein) if the same one-bit indicator (with the same value 0 or 1) as specified herein is provided/configured/indicated in ControlResourceSet that configures the CORESET and groupDLorJointTCIState or groupULTCIState that provides/configures the TCI state group.

In yet another example, a CORESET is associated to a list of higher layer configured TCI states (and therefore, the TCI states or TCI state IDs/indexes provided therein) if the same one-bit indicator (with the same value 0 or 1) as specified herein is provided/configured/indicated in ControlResourceSet that configures the CORESET and listDLorJointTCIState or listULTCIState that provides/configures the TCI state list.

Yet for another example, the higher layer parameter ControlResourceSet that configures a CORESET could comprise/include/contain/have a two-bit indicator (e.g., with value “00,” “01,” “10,” and/or “11”). In one example, when/if the two-bit indicator is set to “00” (“01,” “10,” or “11”), the CORESET provided by the corresponding ControlResourceSet could be associated/configured with the first indicated TCI state/pair of TCI states (e.g., by one or more TCI codepoints of one or more TCI fields in the beam indication DCI), when/if the two-bit indicator is set to “01” (“00,” “10,” or “11”), the CORESET provided by the corresponding ControlResourceSet could be associated/configured with the second indicated TCI state/pair of TCI states (e.g., by one or more TCI codepoints of one or more TCI fields in the beam indication DCI), when/if the two-bit indicator is set to “10” (“00,” “01,” or “11”), the CORESET provided by the corresponding ControlResourceSet could be associated/configured with the first and/or second indicated TCI states/pairs of TCI states (e.g., by one or more TCI codepoints of one or more TCI fields in the beam indication DCI), and when/if the two-bit indicator is set to “11” (“00,” “01,” or “10”), the CORESET provided by the corresponding ControlResourceSet could be associated/configured with the second indicated TCI state/pair of TCI states (e.g., by one or more TCI codepoints of one or more TCI fields in the beam indication DCI). In another example, a CORESET is associated to a TCI state if the same two-bit indicator (with the same value “00,” “01,” “10,” or “11”) as specified herein is provided/configured/indicated in ControlResourceSet that configures the CORESET and TCI-State/DLorJointTCIState/UL-TCIState that provides/configures the TCI state.

In yet another example, a CORESET is associated to a TCI state group (and therefore, the TCI states or TCI state IDs/indexes provided therein) if the same two-bit indicator (with the same value “00,” “01,” “10,” or “11”) as specified herein is provided/configured/indicated in ControlResourceSet that configures the CORESET and groupDLorJointTCIState or groupULTCIState that provides/configures the TCI state group. In yet another example, a CORESET is associated to a list of higher layer configured TCI states (and therefore, the TCI states or TCI state IDs/indexes provided therein) if the same two-bit indicator (with the same value “00,” “01,” “10,” and/or “11”) as specified herein is provided/configured/indicated in ControlResourceSet that configures the CORESET and listDLorJointTCIState or listULTCIState that provides/configures the TCI state list.

In another example, a UE could be (higher layer RRC) provided/indicated/configured by the network one or more (e.g., Lj>1) lists of joint TCI states each provided by DLorJointTCIState and/or one or more (e.g., Lu>1) lists of UL TCI states each provided by UL-TCIState, wherein a list of joint TCI states could be provided by, e.g., listDLorJointTCIState, and a list of UL TCI states could be provided by, e.g., listULTCIState. The UE could be further provided/indicated/configured by the network, e.g., via higher layer RRC signaling/parameter and/or MAC CE command and/or dynamic DCI based signaling, one or more groups of (joint) TCI states or TCI state IDs/indexes from a (or each) list of joint TCI states or TCI state IDs/indexes each provided by DLorJointTCIState, and/or one or more groups of (UL) TCI states or TCI state IDs/indexes from a (or each) list of uplink TCI states or TCI state IDs/indexes each provided by ULTCI-State. Each group of joint/UL TCI states or TCI state IDs/indexes could have a TCI state group ID/index. For a (or each) list of joint TCI states or TCI state IDs/indexes and/or a (or each) list of UL TCI states or TCI state IDs/indexes, the UE could follow those specified in the design examples (e.g., the design examples) discussed herein in the present disclosure.

For example, the higher layer parameter ControlResourceSet that configures a CORESET could comprise/include/contain/have a set of TCI state list IDs/indexes (e.g., a set of list IDs/indexes of listDLorJointTCIState or list IDs/indexes of listULTCIState). For this case, the CORESET provided by the corresponding ControlResourceSet could be associated/configured with the TCI states or TCI state IDs/indexes in the lists of joint TCI states or UL TCI states provided by the corresponding TCI state list IDs/indexes in the set.

For another example, the UE could be provided/configured/indicated by the network, e.g., via higher layer RRC signaling (e.g., in PDCCH-Config) and/or MAC CE command and/or DCI based L1 signaling, a set of TCI state list IDs/indexes (e.g., a set of list IDs/indexes of listDLorJointTCIState or list IDs/indexes of listULTCIState) each associated/corresponding to a CORESET. In one example, the first TCI state list ID/index in the set could be mapped to the first CORESET, the second TCI state list ID/index in the set could be mapped to the second CORESET, and so on. In another example, the TCI state list IDs/indexes in the set could be mapped to the CORESETs with their respective CORESET IDs/indexes in a descending (or an ascending) order. In yet another example, one or more CORESETs, e.g., sorted with their respective CORESET IDs/indexes in a descending or an ascending order, could be mapped to the TCI state list IDs/indexes in the set in a descending (or an ascending) order.

In yet another example, a set of one or more CORESET IDs/indexes could be provided/configured/indicated in the same RRC/MAC CE/DCI signaling/parameter as the set of TCI state list IDs/indexes; for this case, the CORESET IDs/indexes (and therefore, the corresponding CORESETs) in the set could be (one-to-one) mapped to the TCI state list IDs/indexes in the set; here, the mapping could be according to their IDs/indexes in a descending or an ascending order, or alternatively, the mapping could be based on their positions/ordering in their respective sets. For the design examples discussed herein in the present disclosure, if a CORESET ID/index or a CORESET is associated to a TCI state list ID/index, the CORESET ID/index or the CORESET is therefore associated to the TCI states or TCI state IDs/indexes in the TCI state list provided by the TCI state list ID/index (e.g., list ID/index of listDLorJointTCIState or list ID/index of listULTCIState).

Yet for another example, the UE could be provided/configured/indicated by the network, e.g., via higher layer RRC signaling (e.g., in PDCCH-Config) and/or MAC CE command and/or DCI based L1 signaling, a set of TCI state list IDs/indexes (e.g., a set of list IDs/indexes of listDLorJointTCIState or list IDs/indexes of listULTCIState) each associated/corresponding to a CORESET pool/group (and therefore, the CORESETs configured/associated with the corresponding CORESET pool/group index). In one example, the first TCI state list ID/index in the set could be mapped to the first CORESET pool/group index (and therefore, the CORESETs configured/associated with the corresponding CORESET pool/group index), the second TCI state list ID/index in the set could be mapped to the second CORESET pool/group index (and therefore, the CORESETs configured/associated with the corresponding CORESET pool/group index), and so on.

In another example, the TCI state list IDs/indexes in the set could be mapped to the CORESETs with their associated/configured CORESET pool/group indexes in a descending (or an ascending) order. In yet another example, one or more CORESETs, e.g., sorted with their associated/configured CORESET pool/group indexes in a descending or an ascending order, could be mapped to the TCI state list IDs/indexes in the set in a descending (or an ascending) order. In yet another example, a set of one or more CORESET group/pool indexes could be provided/configured/indicated in the same RRC/MAC CE/DCI signaling/parameter as the set of TCI state list IDs/indexes; for this case, the CORESET pool/group indexes (and therefore, the CORESETs configured/associated with the corresponding CORESET group/pool indexes) in the set could be (one-to-one) mapped to the TCI state list IDs/indexes in the set; here, the mapping could be according to their IDs/indexes in a descending or an ascending order, or alternatively, the mapping could be based on their positions/ordering in their respective sets.

For the design examples discussed herein in the present disclosure, if a CORESET group/pool index is associated to a TCI state list ID/index, the CORESETs associated/configured with the corresponding CORESET group/pool index could be therefore associated to the TCI states or TCI state IDs/indexes in the TCI state list provided by the TCI state list ID/index (e.g., list ID/index of listDLorJointTCIState or list ID/index of listULTCIState).

In yet another example, as specified herein in the present disclosure, the UE could receive a MAC CE activation command, e.g., the Unified TCI States Activation/Deactivation MAC CE, used to map one or more TCI states and/or pairs of TCI states to the codepoints of the DCI field “Transmission Configuration Indication” for one or for a set of CCs/DL BWPs, and if applicable, for one or for a set of CCs/UL BWPs. When a set of TCI state IDs are activated for a set of CCs/DL BWPs and if applicable, for a set of CCs/UL BWPs, where the applicable list of CCs is determined by the indicated CC in the activation command, the same set of TCI state IDs are applied for all DL and/or UL BWPs in the indicated CCs. Each TCI codepoint could correspond to a single TCI state/pair of TCI states or multiple (e.g., 2) TCI states/pairs of TCI states (e.g., a first TCI state/pair of TCI states and a second TCI state/pair of TCI states).

For example, the MAC CE activation command could provide/comprise/include/contain/configure/indicate a CORESET ID/index. In one example, the TCI state IDs/indexes (and therefore, the corresponding TCI states/pairs of TCI states) activated by the MAC CE activation command could be associated/corresponding to the CORESET ID/index, and therefore, the corresponding CORESET. In another example, the first TCI state IDs/indexes (and therefore, the corresponding TCI states/pairs of TCI states) of the TCI codepoints activated by the MAC CE activation command could be associated/corresponding to the CORESET ID/index, and therefore, the corresponding CORESET.

In yet another example, the second TCI state IDs/indexes (and therefore, the corresponding TCI states/pairs of TCI states) of the TCI codepoints activated by the MAC CE activation command could be associated/corresponding to the CORESET ID/index, and therefore, the corresponding CORESET. In yet another example, the UE could be provided/configured/indicated by the network, e.g., via higher layer RRC signalling/parameter and/or MAC CE command and/or dynamic DCI based signalling, the association/mapping between one or more of the MAC CE activated TCI states/pairs of TCI states and the CORESET ID/index indicated therein, and therefore, the corresponding CORESET.

For another example, the MAC CE activation command could provide/comprise/include/contain/configure/indicate a CORESET group/pool index (e.g., the UE could be provided by the network, e.g., in PDCCH-Config/PDSCH-Config, one or more CORESET group/pool indexes—CORESETGroupIndex/CORESETPoolIndex with values 0 and/or 1). In one example, the TCI state IDs/indexes (and therefore, the corresponding TCI states/pairs of TCI states) activated by the MAC CE activation command could be associated/corresponding to the CORESET group/pool index, and therefore, the corresponding CORESETs associated/configured with the CORESET group/pool index. In another example, the first TCI state IDs/indexes (and therefore, the corresponding TCI states/pairs of TCI states) of the TCI codepoints activated by the MAC CE activation command could be associated/corresponding to the CORESET group/pool index, and therefore, the corresponding CORESETs configured/associated with the CORESET group/pool index.

In yet another example, the second TCI state IDs/indexes (and therefore, the corresponding TCI states/pairs of TCI states) of the TCI codepoints activated by the MAC CE activation command could be associated/corresponding to the CORESET group/pool index, and therefore, the corresponding CORESETs associated/configured with the CORESET group/pool index. In yet another example, the UE could be provided/configured/indicated by the network, e.g., via higher layer RRC signalling/parameter and/or MAC CE command and/or dynamic DCI based signalling, the association/mapping between one or more of the MAC CE activated TCI states/pairs of TCI states and the CORESET group/pool index indicated therein, and therefore, the corresponding CORESETs associated/configured with the CORESET group/pool index.

In yet another example, the TCI state IDs/indexes (and therefore, the corresponding TCI states/pairs of TCI states) activated by the MAC CE activation command could be (one-to-one) mapped to the CORESETs configured/associated with the CORESET group/pool index provided by CORESETGroupIndex/CORESETPoolIndex according to: (i) their respective IDs/indexes in a descending or an ascending order, (ii) their positions/ordering in their respective set/group/pool, or (iii) configured/provided by the network, e.g., via higher layer RRC signalling/parameter and/or MAC CE command and/or dynamic DCI based L1 signaling.

In yet another example, the first TCI state IDs/indexes (and therefore, the corresponding TCI states/pairs of TCI states) of the TCI codepoints activated by the MAC CE activation command could be associated/mapped to first CORESETs configured/associated with the CORESET group/pool index, and the second TCI state IDs/indexes (and therefore, the corresponding TCI states/pairs of TCI states) of the TCI codepoints activated by the MAC CE activation command could be associated/mapped to second CORESETs configured/associated with the CORESET group/pool index; the first and second CORESETs could be determined according to: (i) their respective IDs/indexes in a descending or an ascending order, (ii) their positions/ordering in the CORESET group/pool, or (iii) configured/provided by the network, e.g., via higher layer RRC signalling/parameter and/or MAC CE command and/or dynamic DCI based L1 signaling.

Yet for another example, the MAC CE activation command could provide/comprise/include/contain/configure/indicate a set of CORESET IDs/indexes. In one example, the TCI state IDs/indexes (and therefore, the corresponding TCI states/pairs of TCI states) activated by the MAC CE activation command could be associated/corresponding to the CORESET IDs/indexes in the set, and therefore, the corresponding CORESETs. In another example, the first TCI state IDs/indexes (and therefore, the corresponding TCI states/pairs of TCI states) of the TCI codepoints activated by the MAC CE activation command could be associated/corresponding to the CORESET IDs/indexes in the set, and therefore, the corresponding CORESETs. In yet another example, the second TCI state IDs/indexes (and therefore, the corresponding TCI states/pairs of TCI states) of the TCI codepoints activated by the MAC CE activation command could be associated/corresponding to the CORESET IDs/indexes in the set, and therefore, the corresponding CORESETs.

In yet another example, the UE could be provided/configured/indicated by the network, e.g., via higher layer RRC signalling/parameter and/or MAC CE command and/or dynamic DCI based signalling, the association/mapping between one or more of the MAC CE activated TCI states/pairs of TCI states and the set of CORESET IDs/indexes indicated therein, and therefore, the corresponding CORESETs. In yet another example, the TCI state IDs/indexes (and therefore, the corresponding TCI states/pairs of TCI states) activated by the MAC CE activation command could be (one-to-one) mapped to the CORESET IDs/indexes (and therefore, the corresponding CORESETs) in the set according to: (i) their respective IDs/indexes in a descending or an ascending order, (ii) their positions/ordering in their respective sets, or (iii) configured/provided by the network, e.g., via higher layer RRC signalling/parameter and/or MAC CE command and/or dynamic DCI based L1 signaling.

In yet another example, the first TCI state IDs/indexes (and therefore, the corresponding TCI states/pairs of TCI states) of the TCI codepoints activated by the MAC CE activation command could be associated/mapped to first CORESET IDs/indexes in the set, and the second TCI state IDs/indexes (and therefore, the corresponding TCI states/pairs of TCI states) of the TCI codepoints activated by the MAC CE activation command could be associated/mapped to second CORESET IDs/indexes in the set; the first and second CORESET IDs/indexes in the set could be determined according to: (i) their respective IDs/indexes in a descending or an ascending order, (ii) their positions/ordering in the set of CORESET IDs/indexes, or (iii) configured/provided by the network, e.g., via higher layer RRC signalling/parameter and/or MAC CE command and/or dynamic DCI based L1 signaling.

Yet for another example, the MAC CE activation command could provide/comprise/include/contain/configure/indicate a set of CORESET group/pool indexes (e.g., the UE could be provided by the network, e.g., in PDCCH-Config/PDSCH-Config, one or more CORESET group/pool indexes—CORESETGroupIndex/CORESETPoolIndex with values 0 and/or 1). In one example, the TCI state IDs/indexes (and therefore, the corresponding TCI states/pairs of TCI states) activated by the MAC CE activation command could be associated/corresponding to the CORESET group/pool indexes in the set, and therefore, the corresponding CORESETs associated/configured with the CORESET group/pool indexes in the set. In another example, the first TCI state IDs/indexes (and therefore, the corresponding TCI states/pairs of TCI states) of the TCI codepoints activated by the MAC CE activation command could be associated/corresponding to the CORESET group/pool indexes in the set, and therefore, the corresponding CORESETs configured/associated with the CORESET group/pool indexes in the set.

In yet another example, the second TCI state IDs/indexes (and therefore, the corresponding TCI states/pairs of TCI states) of the TCI codepoints activated by the MAC CE activation command could be associated/corresponding to the CORESET group/pool indexes in the set, and therefore, the corresponding CORESETs associated/configured with the CORESET group/pool indexes in the set.

In yet another example, the UE could be provided/configured/indicated by the network, e.g., via higher layer RRC signalling/parameter and/or MAC CE command and/or dynamic DCI based signalling, the association/mapping between one or more of the MAC CE activated TCI states/pairs of TCI states and the set of CORESET group/pool indexes indicated therein, and therefore, the corresponding CORESETs associated/configured with the CORESET group/pool indexes in the set. In yet another example, the TCI state IDs/indexes (and therefore, the corresponding TCI states/pairs of TCI states) activated by the MAC CE activation command could be (one-to-one) mapped to the CORESET group/pool indexes (each provided by CORESETGroupIndex/CORESETPoolIndex) in the set according to: (i) their respective IDs/indexes in a descending or an ascending order, (ii) their positions/ordering in their respective sets, or (iii) configured/provided by the network, e.g., via higher layer RRC signalling/parameter and/or MAC CE command and/or dynamic DCI based L1 signaling.

In yet another example, the first TCI state IDs/indexes (and therefore, the corresponding TCI states/pairs of TCI states) of the TCI codepoints activated by the MAC CE activation command could be associated/mapped to the first CORESET group/pool index in the set (and therefore, the corresponding CORESETs associated/configured with the first CORESET group/pool index in the set), and the second TCI state IDs/indexes (and therefore, the corresponding TCI states/pairs of TCI states) of the TCI codepoints activated by the MAC CE activation command could be associated/mapped to the second CORESET group/pool index in the set (and therefore, the corresponding CORESETs associated/configured with the second CORESET group/pool index in the set); the first and second CORESET group/pool indexes in the set could be determined according to: (i) their respective indexes in a descending or an ascending order, (ii) their positions/ordering in the set of CORESET group/pool indexes, or (iii) configured/provided by the network, e.g., via higher layer RRC signalling/parameter and/or MAC CE command and/or dynamic DCI based L1 signaling.

Yet for another example, the MAC CE activation command could provide/comprise/include/contain/configure/indicate one or more sets of CORESET IDs/indexes. In one example, the TCI state IDs/indexes (and therefore, the corresponding TCI states/pairs of TCI states) activated by the MAC CE activation command could be associated/corresponding to the CORESET IDs/indexes in the sets, and therefore, the corresponding CORESETs. In another example, the first TCI state IDs/indexes (and therefore, the corresponding TCI states/pairs of TCI states) of the TCI codepoints activated by the MAC CE activation command could be associated/corresponding to the CORESET IDs/indexes in the sets, and therefore, the corresponding CORESETs. In yet another example, the second TCI state IDs/indexes (and therefore, the corresponding TCI states/pairs of TCI states) of the TCI codepoints activated by the MAC CE activation command could be associated/corresponding to the CORESET IDs/indexes in the sets, and therefore, the corresponding CORESETs.

In yet another example, the UE could be provided/configured/indicated by the network, e.g., via higher layer RRC signalling/parameter and/or MAC CE command and/or dynamic DCI based signalling, the association/mapping between one or more of the MAC CE activated TCI states/pairs of TCI states and the sets of CORESET IDs/indexes indicated therein, and therefore, the corresponding CORESETs provided by the CORESET IDs/indexes in the sets. In yet another example, the TCI state IDs/indexes (and therefore, the corresponding TCI states/pairs of TCI states) activated by the MAC CE activation command could be (one-to-one) mapped to the sets of CORESET IDs/indexes according to: (i) their respective IDs/indexes in a descending or an ascending order, (ii) their positions/ordering in their respective sets, or (iii) configured/provided by the network, e.g., via higher layer RRC signalling/parameter and/or MAC CE command and/or dynamic DCI based L1 signaling.

In yet another example, the first TCI state IDs/indexes (and therefore, the corresponding TCI states/pairs of TCI states) of the TCI codepoints activated by the MAC CE activation command could be associated/mapped to the first set of CORESET IDs/indexes (and therefore, the corresponding CORESETs), and the second TCI state IDs/indexes (and therefore, the corresponding TCI states/pairs of TCI states) of the TCI codepoints activated by the MAC CE activation command could be associated/mapped to the second set of CORESET IDs/indexes (and therefore, the corresponding CORESETs); the first and second sets of CORESET ID/indexes could be determined according to: (i) their respective IDs/indexes in a descending or an ascending order, (ii) their positions/ordering in the sets of CORESET IDs/indexes, or (iii) configured/provided by the network, e.g., via higher layer RRC signalling/parameter and/or MAC CE command and/or dynamic DCI based L1 signaling.

Yet for another example, the higher layer parameter ControlResourceSet that configures a CORESET could comprise/include/contain/have one or more TCI codepoints activated by the MAC CE activation command or one or more IDs/indexes of the one or more TCI codepoints activated by the MAC CE activation command. In one example, the TCI state IDs/indexes (and therefore, the corresponding TCI states/pairs of TCI states) of the TCI codepoints indicated therein could be associated/corresponding to the corresponding CORESET. In another example, the first TCI state IDs/indexes (and therefore, the corresponding TCI states/pairs of TCI states) of the TCI codepoints indicated therein could be associated/corresponding to the corresponding CORESET.

In yet another example, the second TCI state IDs/indexes (and therefore, the corresponding TCI states/pairs of TCI states) of the TCI codepoints indicated therein could be associated/corresponding to the corresponding CORESET. In yet another example, the UE could be provided/configured/indicated by the network, e.g., via higher layer RRC signalling/parameter and/or MAC CE command and/or dynamic DCI based signalling, the association/mapping between one or more of the TCI states/pairs of TCI states of the TCI codepoints indicated therein and the corresponding CORESET.

Yet for another example, the UE could be provided/configured/indicated by the network, e.g., via higher layer RRC signaling (e.g., in PDCCH-Config) and/or MAC CE command and/or dynamic DCI based L1 signaling, one or more of the TCI codepoints activated by the MAC CE, one or more CORESET IDs/indexes, one or more sets of CORESET IDs/indexes, one or more CORESET group/pool indexes, and/or one or more sets of CORESET group/pool indexes. The UE could determine the association/mapping between the TCI codepoints (and therefore, the corresponding TCI states/pairs of TCI states) and the CORESET(s)/group(s) of CORESETs/pool(s) of CORESETs following those provided in the design examples (e.g., the design examples) specified herein in the present disclosure.

In one embodiment, the UE could determine which of the indicated TCI state(s)/pair(s) of TCI states to use/apply for PDCCH reception(s) according to the association/mapping relationship between the indicated TCI state(s)/pair(s) of TCI states and the CORESET(s) according to one or more of the design examples (e.g., the design examples) specified herein in the present disclosure.

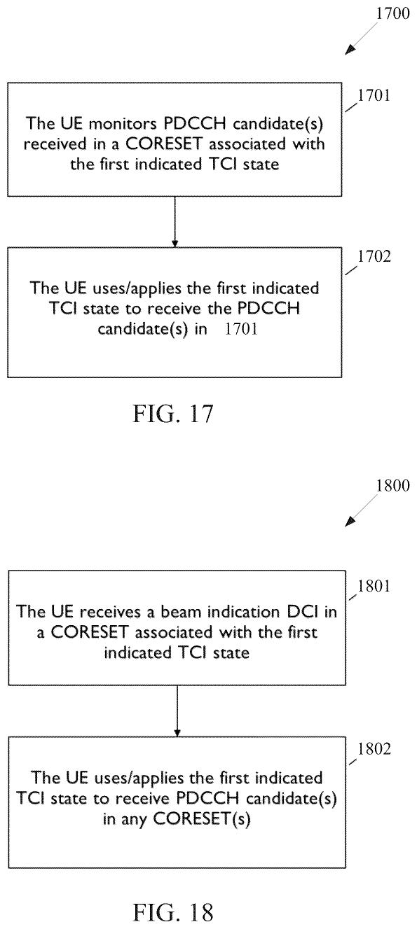

FIGS. 17 and 18 illustrate flowcharts of UE procedures 1700 and 1800 for determining TCI state(s) for receiving PDCCH candidates according to embodiments of the present disclosure. For example, the UE procedures 1700 and 1800 as may be performed by a UE such as 111-116 as illustrated in FIG. 1). An embodiment of the UE procedures 1700 and 1800 shown in FIGS. 17 and 18 are for illustration only. One or more of the components illustrated in FIGS. 17 and 18 can be implemented in specialized circuitry configured to perform the noted functions or one or more of the components can be implemented by one or more processors executing instructions to perform the noted functions.

In one example, for N=2 or M=2, the UE could apply/use the first (or second) indicated TCI state/pair of TCI states to monitor PDCCH candidate(s) received in CORESET(s) associated/configured with the first (or second) indicated TCI state/pair of TCI states (illustrated in FIG. 17) following those specified in one or more of the design examples (e.g., the design examples) provided herein in the present disclosure (or equivalently, the UE could assume that the DM-RS antenna port(s) of the PDCCH received in CORESET(s) associated/configured with the first (or second) indicated TCI state/pair of TCI states following those specified in one or more of the design examples (e.g., the design examples) provided herein in the present disclosure is quasi co-located with the RS(s) in the RS set(s) provided/indicated/configured in the first (or second) indicated TCI state/pair of TCI states), and the UE could apply/use the second (or first) indicated TCI state/pair of TCI states to monitor PDCCH candidate(s) received in CORESET(s) associated/configured with the second (or first) indicated TCI state/pair of TCI states following those specified in one or more of the design examples (e.g., the design examples) provided herein in the present disclosure (or equivalently, the UE could assume that the DM-RS antenna port(s) of the PDCCH received in CORESET(s) associated/configured with the second (or first) indicated TCI state/pair of TCI states following those specified in one or more of the design examples (e.g., the design examples) provided herein in the present disclosure is quasi co-located with the RS(s) in the RS set(s) provided/indicated/configured in the second (or first) indicated TCI state/pair of TCI states).

As illustrated in FIG. 17, the UE in step 1701 monitors PDCCH candidates received in a CORESET association with the first indicated TCI state. In step 1702, the UE uses/applies the first indicated TCI state to receive the PDCCH candidate(s) in step 1701.

In another example, for N=2 or M=2, the UE could apply/use the first indicated TCI state/pair of TCI states to monitor first PDCCH candidate(s) received in CORESET(s) associated/configured with the first indicated TCI state/pair of TCI states following those specified in one or more of the design examples (e.g., the design examples as shown in the present disclosure) provided herein in the present disclosure and the second indicated TCI state/pair of TCI states to monitor second PDCCH candidate(s) received in CORESET(s) associated/configured with the second indicated TCI state/pair of TCI states following those specified in one or more of the design examples (e.g., the design examples as shown in the present disclosure) provided herein in the present disclosure. The UE could apply/use the second indicated TCI state/pair of TCI states to monitor first PDCCH candidate(s) received in CORESET(s) associated/configured with the second indicated TCI state/pair of TCI states following those specified in one or more of the design examples (e.g., the design examples as shown in the present disclosure) provided herein in the present disclosure and the first indicated TCI state/pair of TCI states to monitor second PDCCH candidate(s) received in CORESET(s) associated/configured with the first indicated TCI state/pair of TCI states following those specified in one or more of the design examples (e.g., the design examples as shown in the present disclosure) provided herein in the present disclosure.

In yet another example, for N=2 or M=2, the UE could apply/use the first (or second) indicated TCI state/pair of TCI states to monitor PDCCH candidate(s) received in CORESET(s) associated/configured with the first (or second) indicated TCI state/pair of TCI states following those specified in one or more of the design examples (e.g., the design examples as shown in the present disclosure) provided herein in the present disclosure—or equivalently, the UE could assume that the DM-RS antenna port(s) of the PDCCH received in CORESET(s) associated/configured with the first (or second) indicated TCI state/pair of TCI states following those specified in one or more of the design examples (e.g., the design examples as shown in the present disclosure) provided herein in the present disclosure is quasi co-located with the RS(s) in the RS set(s) provided/indicated/configured in the first (or second) indicated TCI state/pair of TCI states, the UE could apply/use the second (or first) indicated TCI state/pair of TCI states to monitor PDCCH candidate(s) received in CORESET(s) associated/configured with the second (or first) indicated TCI state/pair of TCI states following those specified in one or more of the design examples (e.g., the design examples as shown in the present disclosure) provided herein in the present disclosure—or equivalently, the UE could assume that the DM-RS antenna port(s) of the PDCCH received in CORESET(s) associated/configured with the second (or first) indicated TCI state/pair of TCI states following those specified in one or more of the design examples (e.g., the design examples as shown in the present disclosure) provided herein in the present disclosure is quasi co-located with the RS(s) in the RS set(s) provided/indicated/configured in the second (or first) indicated TCI state/pair of TCI states), the UE could apply/use the first indicated TCI state/pair of TCI states to monitor first PDCCH candidate(s) received in CORESET(s) associated/configured with the first indicated TCI state/pair of TCI states following those specified in one or more of the design examples (e.g., the design examples as shown in the present disclosure) provided herein in the present disclosure and the second indicated TCI state/pair of TCI states to monitor second PDCCH candidate(s) received in CORESET(s) associated/configured with the second indicated TCI state/pair of TCI states following those specified in one or more of the design examples (e.g., the design examples as shown in the present disclosure) provided herein in the present disclosure, or the UE could apply/use the second indicated TCI state/pair of TCI states to monitor first PDCCH candidate(s) received in CORESET(s) associated/configured with the second indicated TCI state/pair of TCI states following those specified in one or more of the design examples (e.g., the design examples as shown in the present disclosure) provided herein in the present disclosure and the first indicated TCI state/pair of TCI states to monitor second PDCCH candidate(s) received in CORESET(s) associated/configured with the first indicated TCI state/pair of TCI states following those specified in one or more of the design examples (e.g., the design examples as shown in the present disclosure) provided herein in the present disclosure.

In yet another example, for N=2 or M=2, when/if the beam indication DCI is received in CORESET(s) associated/configured with the first (or second) indicated TCI state/pair of TCI states following those specified in one or more of the design examples (e.g., the design examples as shown in the present disclosure) provided herein in the present disclosure, the UE could apply/use the first (or second) indicated TCI state/pair of TCI states to monitor PDCCH candidate(s)—illustrated in FIG. 18, wherein the PDCCH candidate(s) could be received in any CORESET(s), and when/if the beam indication DCI is received in CORESET(s) associated/configured with the second (or first) indicated TCI state/pair of TCI states following those specified in one or more of the design examples (e.g., the design examples as shown in the present disclosure) provided herein in the present disclosure, the UE could apply/use the second (or first) indicated TCI state/pair of TCI states to monitor PDCCH candidate(s), wherein the PDCCH candidate(s) could be received in any CORESET(s).

As illustrated in FIG. 18, the UE in step 1801 receives a beam indication DCI in a CORESET associated with the first indicated TCI state. In step 1802, the UE uses the first indicated TCI state to receive PDCCH candidate(s) in any CORESET(s).

In yet another example, for N=2 or M=2, when/if the beam indication DCI is received in CORESET(s) associated/configured with the first and/or second indicated TCI states/pairs of TCI states following those specified in one or more of the design examples (e.g., the design examples as shown in the present disclosure) provided herein in the present disclosure, the UE could apply/use the first indicated TCI state/pair of TCI states to monitor first PDCCH candidate(s) and the second indicated TCI state/pair of TCI states to monitor second PDCCH candidate(s), wherein the first and/or second PDCCH candidate(s) could be received in any CORESET(s), and when/if the beam indication DCI is received in CORESET(s) associated/configured with the second and/or first indicated TCI states/pairs of TCI states following those specified in one or more of the design examples (e.g., the design examples as shown in the present disclosure) provided herein in the present disclosure, the UE could apply/use the second indicated TCI state/pair of TCI states to monitor the first PDCCH candidate(s) and the first indicated TCI state/pair of TCI states to monitor the second PDCCH candidate(s), wherein the first and/or second PDCCH candidate(s) could be received in any CORESET(s).

In yet another example, for N=2 or M=2, when/if the beam indication DCI is received in CORESET(s) associated/configured with the first (or second) indicated TCI state/pair of TCI states following those specified in one or more of the design examples (e.g., the design examples as shown in the present disclosure) provided herein in the present disclosure, the UE could apply/use the first (or second) indicated TCI state/pair of TCI states to monitor PDCCH candidate(s), wherein the PDCCH candidate(s) could be received in any CORESET(s), when/if the beam indication DCI is received in CORESET(s) associated/configured with the second (or first) indicated TCI state/pair of TCI states, the UE could apply/use the second (or first) indicated TCI state/pair of TCI states to monitor PDCCH candidate(s), wherein the PDCCH candidate(s) could be received in any CORESET(s), when/if the beam indication DCI is received in CORESET(s) associated/configured with the first and/or second indicated TCI states/pairs of TCI states following those specified in one or more of the design examples (e.g., the design examples as shown in the present disclosure) provided herein in the present disclosure, the UE could apply/use the first indicated TCI state/pair of TCI states to monitor first PDCCH candidate(s) and the second indicated TCI state/pair of TCI states to monitor second PDCCH candidate(s), wherein the first and/or second PDCCH candidate(s) could be received in any CORESET(s), and when/if the beam indication DCI is received in CORESET(s) associated/configured with the second and/or first indicated TCI states/pairs of TCI states following those specified in one or more of the design examples (e.g., the design examples as shown in the present disclosure) provided herein in the present disclosure, the UE could apply/use the second indicated TCI state/pair of TCI states to monitor the first PDCCH candidate(s) and the first indicated TCI state/pair of TCI states to monitor the second PDCCH candidate(s), wherein the first and/or second PDCCH candidate(s) could be received in any CORESET(s).

The UE could first follow one or more of the design examples (e.g., the design examples as shown in the present disclosure) specified/discussed herein in the present disclosure to determine the association between the indicated TCI state(s) and the PDCCH reception(s). The UE could then follow one or more of the design examples (e.g., the design examples as shown in the present disclosure) specified/discussed herein in the present disclosure to determine the association between the indicated TCI state(s) and the PDCCH reception(s) according to/based on one or more events or one or more conditions discussed/specified herein.

In one example, for N=2 or M=2, the UE could monitor category-1 PDCCH candidate(s) received in CORESET(s) associated/configured with one or more indicated TCI states/pairs of TCI states following those specified in one or more of the design examples (e.g., the design examples as shown in the present disclosure) provided herein in the present disclosure, and the UE could monitor category-2 PDCCH candidate(s) received in CORESET(s) not associated/configured with TCI state(s)/pair(s) of TCI states following those specified in one or more of the design examples (e.g., the design examples as shown in the present disclosure) provided herein in the present disclosure.

The UE could apply/use the first (or second) indicated TCI state/pair of TCI states to monitor the category-1 PDCCH candidate(s) received in CORESET(s) associated/configured with the first (or second) indicated TCI state/pair of TCI states following those specified in one or more of the design examples (e.g., the design examples as shown in the present disclosure) provided herein in the present disclosure (or equivalently, the UE could assume that the DM-RS antenna port(s) of the category-1 PDCCH candidate(s) received in CORESET(s) associated/configured with the first (or second) indicated TCI state/pair of TCI states following those specified in one or more of the design examples (e.g., the design examples as shown in the present disclosure) provided herein in the present disclosure is quasi co-located with the RS(s) in the RS set(s) provided/indicated/configured in the first (or second) indicated TCI state/pair of TCI states), and the UE could apply/use the second (or first) indicated TCI state/pair of TCI states to monitor the category-1 PDCCH candidate(s) received in CORESET(s) associated/configured with the second (or first) indicated TCI state/pair of TCI states following those specified in one or more of the design examples (e.g., the design examples as shown in the present disclosure) provided herein in the present disclosure (or equivalently, the UE could assume that the DM-RS antenna port(s) of the category-1 PDCCH candidate(s) received in CORESET(s) associated/configured with the second (or first) indicated TCI state/pair of TCI states following those specified in one or more of the design examples (e.g., the design examples as shown in the present disclosure) provided herein in the present disclosure is quasi co-located with the RS(s) in the RS set(s) provided/indicated/configured in the second (or first) indicated TCI state/pair of TCI states).

For the category-2 PDCCH candidate(s), following examples can be provided.

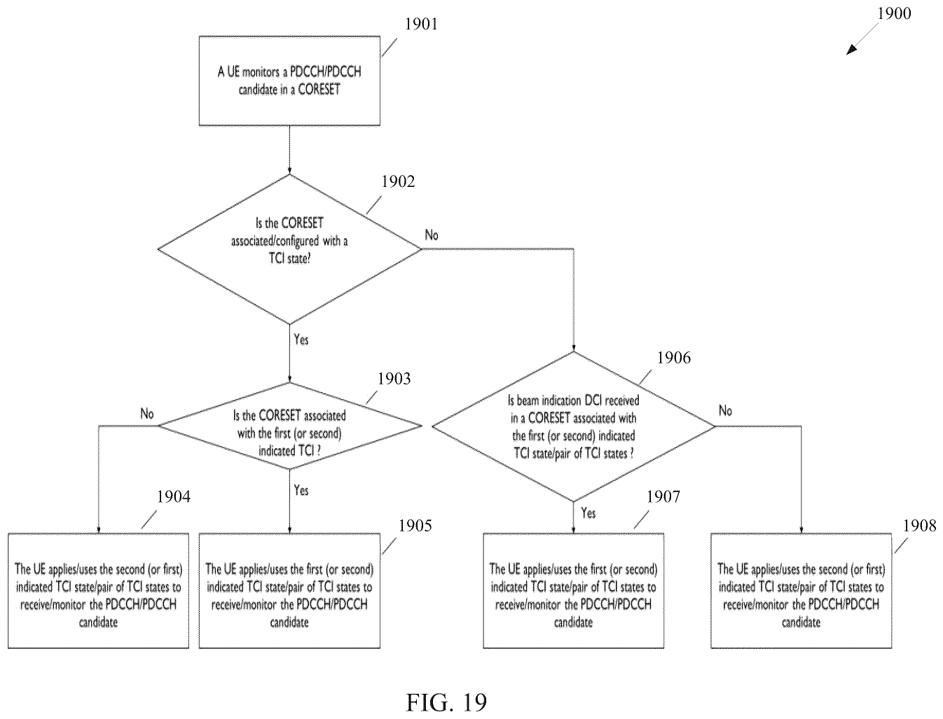

For example, when/if the beam indication DCI is received in CORESET(s) associated/configured with the first (or second) indicated TCI state/pair of TCI states following those specified in one or more of the design examples (e.g., the design examples as shown in the present disclosure) provided herein in the present disclosure, the UE could apply/use the first (or second) indicated TCI state/pair of TCI states to monitor the category-2 PDCCH candidate(s), and when/if the beam indication DCI is received in CORESET(s) associated/configured with the second (or first) indicated TCI state/pair of TCI states following those specified in one or more of the design examples (e.g., the design examples as shown in the present disclosure) provided herein in the present disclosure, the UE could apply/use the second (or first) indicated TCI state/pair of TCI states to monitor the category-2 PDCCH candidate(s). In FIG. 19, an example algorithm flowchart characterizing the above discussed TCI state(s) and PDCCH candidate(s) association is provided.

FIG. 19 illustrates a flowchart of UE procedure 1900 for associating the indicated TCI states with/to the PDCCH candidates according to embodiments of the present disclosure. For example, the UE procedure 1900 as may be performed by a UE such as 111-116 as illustrated in FIG. 1). An embodiment of the UE procedure 1900 shown in FIG. 19 is for illustration only. One or more of the components illustrated in FIG. 19 can be implemented in specialized circuitry configured to perform the noted functions or one or more of the components can be implemented by one or more processors executing instructions to perform the noted functions.

As illustrated in FIG. 19, the UE procedures begins at step 901. In step 1901, a UE monitors a PDCCH/PDCCH candidate in a CORESET. In step 1902, the UE determines if the CORESET is associated/configured with TCI state. In step 1903, the UE determines if the CORESET is associated with the first indicated TCI. In step 1904, the UE applies the second indicated TCI state/pair of TCI states to receive the PDCCH/PDCCH candidate. In step 1905, the UE applies the first indicated TCI stat of TCI states to receiver the PDCCH/PDCCH candidate. In step 1906, the UE determines if a beam indication DCI is received in a CORESET. In step 1907, the UE applies the first indicated TCI state of TCI states to receive the PDCCH/PDCCH candidate. In step 1908, the UE applies the second indicated TCI state of TCI states to receive the PDCCH/PDCCH candidate.

For another example, when/if the beam indication DCI is received in CORESET(s) associated/configured with the first and/or second indicated TCI states/pairs of TCI states following those specified in one or more of the design examples (e.g., the design examples as shown in the present disclosure) provided herein in the present disclosure, the UE could apply/use the first indicated TCI state/pair of TCI states to monitor first category-2 PDCCH candidate(s) and the second indicated TCI state/pair of TCI states to monitor second category-2 PDCCH candidate(s), and when/if the beam indication DCI is received in CORESET(s) associated/configured with the second and/or first indicated TCI states/pairs of TCI states following those specified in one or more of the design examples (e.g., the design examples as shown in the present disclosure) provided herein in the present disclosure, the UE could apply/use the second indicated TCI state/pair of TCI states to monitor the first category-2 PDCCH candidate(s) and the first indicated TCI state/pair of TCI states to monitor the second category-2 PDCCH candidate(s).

Yet for another example, when/if the beam indication DCI is received in CORESET(s) associated/configured with the first (or second) indicated TCI state/pair of TCI states following those specified in one or more of the design examples (e.g., the design examples as shown in the present disclosure) provided herein in the present disclosure, the UE could apply/use the first (or second) indicated TCI state/pair of TCI states to monitor category-2 PDCCH candidate(s), when/if the beam indication DCI is received in CORESET(s) associated/configured with the second (or first) indicated TCI state/pair of TCI states following those specified in one or more of the design examples (e.g., the design examples as shown in the present disclosure) provided herein in the present disclosure, the UE could apply/use the second (or first) indicated TCI state/pair of TCI states to monitor category-2 PDCCH candidate(s), when/if the beam indication DCI is received in CORESET(s) associated/configured with the first and/or second indicated TCI states/pairs of TCI states following those specified in one or more of the design examples (e.g., the design examples) provided herein in the present disclosure, the UE could apply/use the first indicated TCI state/pair of TCI states to monitor first category-2 PDCCH candidate(s) and the second indicated TCI state/pair of TCI states to monitor second category-2 PDCCH candidate(s), and when/if the beam indication DCI is received in CORESET(s) associated/configured with the second and/or first indicated TCI states/pairs of TCI states following those specified in one or more of the design examples (e.g., the design examples as shown in the present disclosure) provided herein in the present disclosure, the UE could apply/use the second indicated TCI state/pair of TCI states to monitor the first category-2 PDCCH candidate(s) and the first indicated TCI state/pair of TCI states to monitor the second category-2 PDCCH candidate(s).

In another example, for N=2 or M=2, the UE could monitor category-1 PDCCH candidate(s) received in CORESET(s) associated/configured with one or more indicated TCI states/pairs of TCI states following those specified in one or more of the design examples (e.g., the design examples as shown in the present disclosure) provided herein in the present disclosure, and the UE could monitor category-2 PDCCH candidate(s) received in CORESET(s) not associated/configured with TCI state(s)/pair(s) of TCI states following those specified in one or more of the design examples (e.g., the design examples as shown in the present disclosure) provided herein in the present disclosure.

The UE could apply/use the first indicated TCI state/pair of TCI states to monitor first category-1 PDCCH candidate(s) received in CORESET(s) associated/configured with the first indicated TCI state/pair of TCI states following those specified in one or more of the design examples (e.g., the design examples as shown in the present disclosure) provided herein in the present disclosure and the second indicated TCI state/pair of TCI states to monitor second category-1 PDCCH candidate(s) received in CORESET(s) associated/configured with the second indicated TCI state/pair of TCI states following those specified in one or more of the design examples (e.g., the design examples as shown in the present disclosure) provided herein in the present disclosure. The UE could apply/use the second indicated TCI state/pair of TCI states to monitor first category-1 PDCCH candidate(s) received in CORESET(s) associated/configured with the second indicated TCI state/pair of TCI states following those specified in one or more of the design examples (e.g., the design examples as shown in the present disclosure) provided herein in the present disclosure and the first indicated TCI state/pair of TCI states to monitor second category-1 PDCCH candidate(s) received in CORESET(s) associated/configured with the first indicated TCI state/pair of TCI states following those specified in one or more of the design examples (e.g., the design examples as shown in the present disclosure) provided herein in the present disclosure.

For example, when/if the beam indication DCI is received in CORESET(s) associated/configured with the first (or second) indicated TCI state/pair of TCI states following those specified in one or more of the design examples (e.g., the design examples as shown in the present disclosure) provided herein in the present disclosure, the UE could apply/use the first (or second) indicated TCI state/pair of TCI states to monitor the category-2 PDCCH candidate(s), and when/if the beam indication DCI is received in CORESET(s) associated/configured with the second (or first) indicated TCI state/pair of TCI states following those specified in one or more of the design examples (e.g., the design examples as shown in the present disclosure) provided herein in the present disclosure, the UE could apply/use the second (or first) indicated TCI state/pair of TCI states to monitor the category-2 PDCCH candidate(s).

For another example, when/if the beam indication DCI is received in CORESET(s) associated/configured with the first and/or second indicated TCI states/pairs of TCI states following those specified in one or more of the design examples (e.g., the design examples as shown in the present disclosure) provided herein in the present disclosure, the UE could apply/use the first indicated TCI state/pair of TCI states to monitor first category-2 PDCCH candidate(s) and the second indicated TCI state/pair of TCI states to monitor second category-2 PDCCH candidate(s), and when/if the beam indication DCI is received in CORESET(s) associated/configured with the second and/or first indicated TCI states/pairs of TCI states following those specified in one or more of the design examples (e.g., the design examples as shown in the present disclosure) provided herein in the present disclosure, the UE could apply/use the second indicated TCI state/pair of TCI states to monitor the first category-2 PDCCH candidate(s) and the first indicated TCI state/pair of TCI states to monitor the second category-2 PDCCH candidate(s).

Yet for another example, when/if the beam indication DCI is received in CORESET(s) associated/configured with the first (or second) indicated TCI state/pair of TCI states following those specified in one or more of the design examples (e.g., the design examples as shown in the present disclosure) provided herein in the present disclosure, the UE could apply/use the first (or second) indicated TCI state/pair of TCI states to monitor category-2 PDCCH candidate(s), when/if the beam indication DCI is received in CORESET(s) associated/configured with the second (or first) indicated TCI state/pair of TCI states following those specified in one or more of the design examples (e.g., the design examples as shown in the present disclosure) provided herein in the present disclosure, the UE could apply/use the second (or first) indicated TCI state/pair of TCI states to monitor category-2 PDCCH candidate(s), when/if the beam indication DCI is received in CORESET(s) associated/configured with the first and/or second indicated TCI states/pairs of TCI states following those specified in one or more of the design examples (e.g., the design examples as shown in the present disclosure) provided herein in the present disclosure, the UE could apply/use the first indicated TCI state/pair of TCI states to monitor first category-2 PDCCH candidate(s) and the second indicated TCI state/pair of TCI states to monitor second category-2 PDCCH candidate(s), and when/if the beam indication DCI is received in CORESET(s) associated/configured with the second and/or first indicated TCI states/pairs of TCI states following those specified in one or more of the design examples (e.g., the design examples as shown in the present disclosure) provided herein in the present disclosure, the UE could apply/use the second indicated TCI state/pair of TCI states to monitor the first category-2 PDCCH candidate(s) and the first indicated TCI state/pair of TCI states to monitor the second category-2 PDCCH candidate(s).

In yet another example, for N=2 or M=2, the UE could monitor category-1 PDCCH candidate(s) received in CORESET(s) associated/configured with one or more indicated TCI states/pairs of TCI states following those specified in one or more of the design examples (e.g., the design examples as shown in the present disclosure) provided herein in the present disclosure, and the UE could monitor category-2 PDCCH candidate(s) received in CORESET(s) not associated/configured with TCI state(s)/pair(s) of TCI states following those specified in one or more of the design examples (e.g., the design examples as shown in the present disclosure) provided herein in the present disclosure.

The UE could apply/use the first (or second) indicated TCI state/pair of TCI states to monitor category-1 PDCCH candidate(s) received in CORESET(s) associated/configured with the first (or second) indicated TCI state/pair of TCI states following those specified in one or more of the design examples (e.g., the design examples as shown in the present disclosure) provided herein in the present disclosure—or equivalently, the UE could assume that the DM-RS antenna port(s) of the category-1 PDCCH received in CORESET(s) associated/configured with the first (or second) indicated TCI state/pair of TCI states following those specified in one or more of the design examples (e.g., the design examples as shown in the present disclosure) provided herein in the present disclosure is quasi co-located with the RS(s) in the RS set(s) provided/indicated/configured in the first (or second) indicated TCI state/pair of TCI states, the UE could apply/use the second (or first) indicated TCI state/pair of TCI states to monitor category-1 PDCCH candidate(s) received in CORESET(s) associated/configured with the second (or first) indicated TCI state/pair of TCI states following those specified in one or more of the design examples (e.g., the design examples as shown in the present disclosure) provided herein in the present disclosure—or equivalently, the UE could assume that the DM-RS antenna port(s) of the category-1 PDCCH received in CORESET(s) associated/configured with the second (or first) indicated TCI state/pair of TCI states following those specified in one or more of the design examples (e.g., the design examples as shown in the present disclosure) provided herein in the present disclosure is quasi co-located with the RS(s) in the RS set(s) provided/indicated/configured in the second (or first) indicated TCI state/pair of TCI states), the UE could apply/use the first indicated TCI state/pair of TCI states to monitor first category-1 PDCCH candidate(s) received in CORESET(s) associated/configured with the first indicated TCI state/pair of TCI states following those specified in one or more of the design examples (e.g., the design examples as shown in the present disclosure) provided herein in the present disclosure and the second indicated TCI state/pair of TCI states to monitor second category-1 PDCCH candidate(s) received in CORESET(s) associated/configured with the second indicated TCI state/pair of TCI states following those specified in one or more of the design examples (e.g., the design examples as shown in the present disclosure) provided herein in the present disclosure, or the UE could apply/use the second indicated TCI state/pair of TCI states to monitor first category-1 PDCCH candidate(s) received in CORESET(s) associated/configured with the second indicated TCI state/pair of TCI states following those specified in one or more of the design examples (e.g., the design examples as shown in the present disclosure) provided herein in the present disclosure and the first indicated TCI state/pair of TCI states to monitor second category-1 PDCCH candidate(s) received in CORESET(s) associated/configured with the first indicated TCI state/pair of TCI states following those specified in one or more of the design examples (e.g., the design examples as shown in the present disclosure) provided herein in the present disclosure.

For example, when/if the beam indication DCI is received in CORESET(s) associated/configured with the first (or second) indicated TCI state/pair of TCI states following those specified in one or more of the design examples (e.g., the design examples as shown in the present disclosure) provided herein in the present disclosure, the UE could apply/use the first (or second) indicated TCI state/pair of TCI states to monitor the category-2 PDCCH candidate(s), and when/if the beam indication DCI is received in CORESET(s) associated/configured with the second (or first) indicated TCI state/pair of TCI states following those specified in one or more of the design examples (e.g., the design examples as shown in the present disclosure) provided herein in the present disclosure, the UE could apply/use the second (or first) indicated TCI state/pair of TCI states to monitor the category-2 PDCCH candidate(s).

For another example, when/if the beam indication DCI is received in CORESET(s) associated/configured with the first and/or second indicated TCI states/pairs of TCI states following those specified in one or more of the design examples (e.g., the design examples as shown in the present disclosure) provided herein in the present disclosure, the UE could apply/use the first indicated TCI state/pair of TCI states to monitor first category-2 PDCCH candidate(s) and the second indicated TCI state/pair of TCI states to monitor second category-2 PDCCH candidate(s), and when/if the beam indication DCI is received in CORESET(s) associated/configured with the second and/or first indicated TCI states/pairs of TCI states following those specified in one or more of the design examples (e.g., the design examples) provided herein in the present disclosure, the UE could apply/use the second indicated TCI state/pair of TCI states to monitor the first category-2 P as shown in the present disclosure DCCH candidate(s) and the first indicated TCI state/pair of TCI states to monitor the second category-2 PDCCH candidate(s).

Yet for another example, when/if the beam indication DCI is received in CORESET(s) associated/configured with the first (or second) indicated TCI state/pair of TCI states following those specified in one or more of the design examples (e.g., the design examples as shown in the present disclosure) provided herein in the present disclosure, the UE could apply/use the first (or second) indicated TCI state/pair of TCI states to monitor category-2 PDCCH candidate(s), when/if the beam indication DCI is received in CORESET(s) associated/configured with the second (or first) indicated TCI state/pair of TCI states following those specified in one or more of the design examples (e.g., the design examples as shown in the present disclosure) provided herein in the present disclosure, the UE could apply/use the second (or first) indicated TCI state/pair of TCI states to monitor category-2 PDCCH candidate(s), when/if the beam indication DCI is received in CORESET(s) associated/configured with the first and/or second indicated TCI states/pairs of TCI states following those specified in one or more of the design examples (e.g., the design examples as shown in the present disclosure) provided herein in the present disclosure, the UE could apply/use the first indicated TCI state/pair of TCI states to monitor first category-2 PDCCH candidate(s) and the second indicated TCI state/pair of TCI states to monitor second category-2 PDCCH candidate(s), and when/if the beam indication DCI is received in CORESET(s) associated/configured with the second and/or first indicated TCI states/pairs of TCI states following those specified in one or more of the design examples (e.g., the design examples as shown in the present disclosure) provided herein in the present disclosure, the UE could apply/use the second indicated TCI state/pair of TCI states to monitor the first category-2 PDCCH candidate(s) and the first indicated TCI state/pair of TCI states to monitor the second category-2 PDCCH candidate(s).

The UE could first follow one or more of the design examples (e.g., the design examples as shown in the present disclosure) specified/discussed herein in the present disclosure to determine the association between the indicated TCI state(s) and the PDCCH reception(s). The UE could then follow one or more of the design examples (e.g., the design examples as shown in the present disclosure) specified/discussed herein in the present disclosure to determine the association between the indicated TCI state(s) and the PDCCH reception(s) according to/based on one or more events or one or more conditions discussed/specified herein.

In one example, for N=2 or M=2, when/if the beam indication DCI is received in CORESET(s) associated/configured with the first (or second) indicated TCI state/pair of TCI states following those specified in one or more of the design examples (e.g., the design examples as shown in the present disclosure) provided herein in the present disclosure, the UE could apply/use the first (or second) indicated TCI state/pair of TCI states to monitor PDCCH candidate(s), wherein the PDCCH candidate(s) could be received in any CORESET(s), and when/if the beam indication DCI is received in CORESET(s) associated/configured with the second (or first) indicated TCI state/pair of TCI states following those specified in one or more of the design examples (e.g., the design examples as shown in the present disclosure) provided herein in the present disclosure, the UE could apply/use the second (or first) indicated TCI state/pair of TCI states to monitor PDCCH candidate(s), wherein the PDCCH candidate(s) could be received in any CORESET(s).

When/if the beam indication DCI is received in CORESET(s) not associated/configured with TCI state(s)/pair(s) of TCI states following those specified in one or more of the design examples (e.g., the design examples as shown in the present disclosure) provided herein in the present disclosure, following examples can be provided.

For example, the UE could apply/use the first (or second) indicated TCI state/pair of TCI states to monitor PDCCH candidate(s) received in CORESET(s) associated/configured with the first (or second) indicated TCI state/pair of TCI states following those specified in one or more of the design examples (e.g., the design examples as shown in the present disclosure) provided herein in the present disclosure (or equivalently, the UE could assume that the DM-RS antenna port(s) of the PDCCH received in CORESET(s) associated/configured with the first (or second) indicated TCI state/pair of TCI states is quasi co-located with the RS(s) in the RS set(s) provided/indicated/configured in the first (or second) indicated TCI state/pair of TCI states), and the UE could apply/use the second (or first) indicated TCI state/pair of TCI states to monitor PDCCH candidate(s) received in CORESET(s) associated/configured with the second (or first) indicated TCI state/pair of TCI states following those specified in one or more of the design examples (e.g., the design examples as shown in the present disclosure) provided herein in the present disclosure (or equivalently, the UE could assume that the DM-RS antenna port(s) of the PDCCH received in CORESET(s) associated/configured with the second (or first) indicated TCI state/pair of TCI states following those specified in one or more of the design examples (e.g., the design examples as shown in the present disclosure) provided herein in the present disclosure is quasi co-located with the RS(s) in the RS set(s) provided/indicated/configured in the second (or first) indicated TCI state/pair of TCI states).

For another example, the UE could apply/use the first indicated TCI state/pair of TCI states to monitor first PDCCH candidate(s) received in CORESET(s) associated/configured with the first indicated TCI state/pair of TCI states following those specified in one or more of the design examples (e.g., the design examples as shown in the present disclosure) provided herein in the present disclosure and the second indicated TCI state/pair of TCI states to monitor second PDCCH candidate(s) received in CORESET(s) associated/configured with the second indicated TCI state/pair of TCI states following those specified in one or more of the design examples (e.g., the design examples as shown in the present disclosure) provided herein in the present disclosure.

The UE could apply/use the second indicated TCI state/pair of TCI states to monitor first PDCCH candidate(s) received in CORESET(s) associated/configured with the second indicated TCI state/pair of TCI states following those specified in one or more of the design examples (e.g., the design examples as shown in the present disclosure) provided herein in the present disclosure and the first indicated TCI state/pair of TCI states to monitor second PDCCH candidate(s) received in CORESET(s) associated/configured with the first indicated TCI state/pair of TCI states following those specified in one or more of the design examples (e.g., the design examples as shown in the present disclosure) provided herein in the present disclosure.

Yet for another example, the UE could apply/use the first (or second) indicated TCI state/pair of TCI states to monitor PDCCH candidate(s) received in CORESET(s) associated/configured with the first (or second) indicated TCI state/pair of TCI states following those specified in one or more of the design examples (e.g., the design examples as shown in the present disclosure) provided herein in the present disclosure—or equivalently, the UE could assume that the DM-RS antenna port(s) of the PDCCH received in CORESET(s) associated/configured with the first (or second) indicated TCI state/pair of TCI states following those specified in one or more of the design examples (e.g., the design examples as shown in the present disclosure) provided herein in the present disclosure is quasi co-located with the RS(s) in the RS set(s) provided/indicated/configured in the first (or second) indicated TCI state/pair of TCI states, the UE could apply/use the second (or first) indicated TCI state/pair of TCI states to monitor PDCCH candidate(s) received in CORESET(s) associated/configured with the second (or first) indicated TCI state/pair of TCI states following those specified in one or more of the design examples (e.g., the design examples as shown in the present disclosure) provided herein in the present disclosure—or equivalently, the UE could assume that the DM-RS antenna port(s) of the PDCCH received in CORESET(s) associated/configured with the second (or first) indicated TCI state/pair of TCI states following those specified in one or more of the design examples (e.g., the design examples as shown in the present disclosure) provided herein in the present disclosure is quasi co-located with the RS(s) in the RS set(s) provided/indicated/configured in the second (or first) indicated TCI state/pair of TCI states), the UE could apply/use the first indicated TCI state/pair of TCI states to monitor first PDCCH candidate(s) received in CORESET(s) associated/configured with the first indicated TCI state/pair of TCI states following those specified in one or more of the design examples (e.g., the design examples as shown in the present disclosure) provided herein in the present disclosure and the second indicated TCI state/pair of TCI states to monitor second PDCCH candidate(s) received in CORESET(s) associated/configured with the second indicated TCI state/pair of TCI states following those specified in one or more of the design examples (e.g., the design examples as shown in the present disclosure) provided herein in the present disclosure, or the UE could apply/use the second indicated TCI state/pair of TCI states to monitor first PDCCH candidate(s) received in CORESET(s) associated/configured with the second indicated TCI state/pair of TCI states following those specified in one or more of the design examples (e.g., the design examples as shown in the present disclosure) provided herein in the present disclosure and the first indicated TCI state/pair of TCI states to monitor second PDCCH candidate(s) received in CORESET(s) associated/configured with the first indicated TCI state/pair of TCI states following those specified in one or more of the design examples (e.g., the design examples as shown in the present disclosure) provided herein in the present disclosure.

In another example, for N=2 or M=2, when/if the beam indication DCI is received in CORESET(s) associated/configured with the first and/or second indicated TCI states/pairs of TCI states following those specified in one or more of the design examples (e.g., the design examples as shown in the present disclosure) provided herein in the present disclosure, the UE could apply/use the first indicated TCI state/pair of TCI states to monitor first PDCCH candidate(s) and the second indicated TCI state/pair of TCI states to monitor second PDCCH candidate(s), wherein the first and/or second PDCCH candidate(s) could be received in any CORESET(s), and when/if the beam indication DCI is received in CORESET(s) associated/configured with the second and/or first indicated TCI states/pairs of TCI states following those specified in one or more of the design examples (e.g., the design examples as shown in the present disclosure) provided herein in the present disclosure, the UE could apply/use the second indicated TCI state/pair of TCI states to monitor the first PDCCH candidate(s) and the first indicated TCI state/pair of TCI states to monitor the second PDCCH candidate(s), wherein the first and/or second PDCCH candidate(s) could be received in any CORESET(s).

When/if the beam indication DCI is received in CORESET(s) not associated/configured with TCI state(s)/pair(s) of TCI states following those specified in one or more of the design examples (e.g., the design examples as shown in the present disclosure) provided herein in the present disclosure, following examples can be provided.

For example, the UE could apply/use the first (or second) indicated TCI state/pair of TCI states to monitor PDCCH candidate(s) received in CORESET(s) associated/configured with the first (or second) indicated TCI state/pair of TCI states following those specified in one or more of the design examples (e.g., the design examples as shown in the present disclosure) provided herein in the present disclosure (or equivalently, the UE could assume that the DM-RS antenna port(s) of the PDCCH received in CORESET(s) associated/configured with the first (or second) indicated TCI state/pair of TCI states following those specified in one or more of the design examples (e.g., the design examples as shown in the present disclosure) provided herein in the present disclosure is quasi co-located with the RS(s) in the RS set(s) provided/indicated/configured in the first (or second) indicated TCI state/pair of TCI states), and the UE could apply/use the second (or first) indicated TCI state/pair of TCI states to monitor PDCCH candidate(s) received in CORESET(s) associated/configured with the second (or first) indicated TCI state/pair of TCI states following those specified in one or more of the design examples (e.g., the design examples as shown in the present disclosure) provided herein in the present disclosure (or equivalently, the UE could assume that the DM-RS antenna port(s) of the PDCCH received in CORESET(s) associated/configured with the second (or first) indicated TCI state/pair of TCI states following those specified in one or more of the design examples (e.g., the design examples as shown in the present disclosure) provided herein in the present disclosure is quasi co-located with the RS(s) in the RS set(s) provided/indicated/configured in the second (or first) indicated TCI state/pair of TCI states).

For another example, the UE could apply/use the first indicated TCI state/pair of TCI states to monitor first PDCCH candidate(s) received in CORESET(s) associated/configured with the first indicated TCI state/pair of TCI states following those specified in one or more of the design examples (e.g., the design examples as shown in the present disclosure) provided herein in the present disclosure and the second indicated TCI state/pair of TCI states to monitor second PDCCH candidate(s) received in CORESET(s) associated/configured with the second indicated TCI state/pair of TCI states following those specified in one or more of the design examples (e.g., the design examples as shown in the present disclosure) provided herein in the present disclosure. The UE could apply/use the second indicated TCI state/pair of TCI states to monitor first PDCCH candidate(s) received in CORESET(s) associated/configured with the second indicated TCI state/pair of TCI states following those specified in one or more of the design examples (e.g., the design examples as shown in the present disclosure) provided herein in the present disclosure and the first indicated TCI state/pair of TCI states to monitor second PDCCH candidate(s) received in CORESET(s) associated/configured with the first indicated TCI state/pair of TCI states following those specified in one or more of the design examples (e.g., the design examples as shown in the present disclosure) provided herein in the present disclosure.

Yet for another example, the UE could apply/use the first (or second) indicated TCI state/pair of TCI states to monitor PDCCH candidate(s) received in CORESET(s) associated/configured with the first (or second) indicated TCI state/pair of TCI states following those specified in one or more of the design examples (e.g., the design examples as shown in the present disclosure) provided herein in the present disclosure—or equivalently, the UE could assume that the DM-RS antenna port(s) of the PDCCH received in CORESET(s) associated/configured with the first (or second) indicated TCI state/pair of TCI states following those specified in one or more of the design examples (e.g., the design examples as shown in the present disclosure) provided herein in the present disclosure is quasi co-located with the RS(s) in the RS set(s) provided/indicated/configured in the first (or second) indicated TCI state/pair of TCI states, the UE could apply/use the second (or first) indicated TCI state/pair of TCI states to monitor PDCCH candidate(s) received in CORESET(s) associated/configured with the second (or first) indicated TCI state/pair of TCI states following those specified in one or more of the design examples (e.g., the design examples as shown in the present disclosure) provided herein in the present disclosure—or equivalently, the UE could assume that the DM-RS antenna port(s) of the PDCCH received in CORESET(s) associated/configured with the second (or first) indicated TCI state/pair of TCI states following those specified in one or more of the design examples (e.g., the design examples as shown in the present disclosure) provided herein in the present disclosure is quasi co-located with the RS(s) in the RS set(s) provided/indicated/configured in the second (or first) indicated TCI state/pair of TCI states), the UE could apply/use the first indicated TCI state/pair of TCI states to monitor first PDCCH candidate(s) received in CORESET(s) associated/configured with the first indicated TCI state/pair of TCI states following those specified in one or more of the design examples (e.g., the design examples as shown in the present disclosure) provided herein in the present disclosure and the second indicated TCI state/pair of TCI states to monitor second PDCCH candidate(s) received in CORESET(s) associated/configured with the second indicated TCI state/pair of TCI states following those specified in one or more of the design examples (e.g., the design examples as shown in the present disclosure) provided herein in the present disclosure, or the UE could apply/use the second indicated TCI state/pair of TCI states to monitor first PDCCH candidate(s) received in CORESET(s) associated/configured with the second indicated TCI state/pair of TCI states following those specified in one or more of the design examples (e.g., the design examples as shown in the present disclosure) provided herein in the present disclosure and the first indicated TCI state/pair of TCI states to monitor second PDCCH candidate(s) received in CORESET(s) associated/configured with the first indicated TCI state/pair of TCI states following those specified in one or more of the design examples (e.g., the design examples as shown in the present disclosure) provided herein in the present disclosure.

In yet another example, for N=2 or M=2, when/if the beam indication DCI is received in CORESET(s) associated/configured with the first (or second) indicated TCI state/pair of TCI states following those specified in one or more of the design examples (e.g., the design examples as shown in the present disclosure) provided herein in the present disclosure, the UE could apply/use the first (or second) indicated TCI state/pair of TCI states to monitor PDCCH candidate(s), wherein the PDCCH candidate(s) could be received in any CORESET(s), when/if the beam indication DCI is received in CORESET(s) associated/configured with the second (or first) indicated TCI state/pair of TCI states following those specified in one or more of the design examples (e.g., the design examples as shown in the present disclosure) provided herein in the present disclosure, the UE could apply/use the second (or first) indicated TCI state/pair of TCI states to monitor PDCCH candidate(s), wherein the PDCCH candidate(s) could be received in any CORESET(s), when/if the beam indication DCI is received in CORESET(s) associated/configured with the first and/or second indicated TCI states/pairs of TCI states following those specified in one or more of the design examples (e.g., the design examples as shown in the present disclosure) provided herein in the present disclosure, the UE could apply/use the first indicated TCI state/pair of TCI states to monitor first PDCCH candidate(s) and the second indicated TCI state/pair of TCI states to monitor second PDCCH candidate(s), wherein the first and/or second PDCCH candidate(s) could be received in any CORESET(s), and when/if the beam indication DCI is received in CORESET(s) associated/configured with the second and/or first indicated TCI states/pairs of TCI states following those specified in one or more of the design examples (e.g., the design examples as shown in the present disclosure) provided herein in the present disclosure, the UE could apply/use the second indicated TCI state/pair of TCI states to monitor the first PDCCH candidate(s) and the first indicated TCI state/pair of TCI states to monitor the second PDCCH candidate(s), wherein the first and/or second PDCCH candidate(s) could be received in any CORESET(s).

When/if the beam indication DCI is received in CORESET(s) not associated/configured with TCI state(s)/pair(s) of TCI states following those specified in one or more of the design examples (e.g., the design examples as shown in the present disclosure) provided herein in the present disclosure, following examples can be provided.

For example, the UE could apply/use the first (or second) indicated TCI state/pair of TCI states to monitor PDCCH candidate(s) received in CORESET(s) associated/configured with the first (or second) indicated TCI state/pair of TCI states following those specified in one or more of the design examples (e.g., the design examples as shown in the present disclosure) provided herein in the present disclosure (or equivalently, the UE could assume that the DM-RS antenna port(s) of the PDCCH received in CORESET(s) associated/configured with the first (or second) indicated TCI state/pair of TCI states following those specified in one or more of the design examples (e.g., the design examples as shown in the present disclosure) provided herein in the present disclosure is quasi co-located with the RS(s) in the RS set(s) provided/indicated/configured in the first (or second) indicated TCI state/pair of TCI states), and the UE could apply/use the second (or first) indicated TCI state/pair of TCI states to monitor PDCCH candidate(s) received in CORESET(s) associated/configured with the second (or first) indicated TCI state/pair of TCI states following those specified in one or more of the design examples (e.g., the design examples as shown in the present disclosure) provided herein in the present disclosure (or equivalently, the UE could assume that the DM-RS antenna port(s) of the PDCCH received in CORESET(s) associated/configured with the second (or first) indicated TCI state/pair of TCI states following those specified in one or more of the design examples (e.g., the design examples as shown in the present disclosure) provided herein in the present disclosure is quasi co-located with the RS(s) in the RS set(s) provided/indicated/configured in the second (or first) indicated TCI state/pair of TCI states).

For another example, the UE could apply/use the first indicated TCI state/pair of TCI states to monitor first PDCCH candidate(s) received in CORESET(s) associated/configured with the first indicated TCI state/pair of TCI states following those specified in one or more of the design examples (e.g., the design examples as shown in the present disclosure) provided herein in the present disclosure and the second indicated TCI state/pair of TCI states to monitor second PDCCH candidate(s) received in CORESET(s) associated/configured with the second indicated TCI state/pair of TCI states following those specified in one or more of the design examples (e.g., the design examples as shown in the present disclosure) provided herein in the present disclosure. The UE could apply/use the second indicated TCI state/pair of TCI states to monitor first PDCCH candidate(s) received in CORESET(s) associated/configured with the second indicated TCI state/pair of TCI states following those specified in one or more of the design examples (e.g., the design examples as shown in the present disclosure) provided herein in the present disclosure and the first indicated TCI state/pair of TCI states to monitor second PDCCH candidate(s) received in CORESET(s) associated/configured with the first indicated TCI state/pair of TCI states following those specified in one or more of the design examples (e.g., the design examples as shown in the present disclosure) provided herein in the present disclosure.

Yet for another example, the UE could apply/use the first (or second) indicated TCI state/pair of TCI states to monitor PDCCH candidate(s) received in CORESET(s) associated/configured with the first (or second) indicated TCI state/pair of TCI states following those specified in one or more of the design examples (e.g., the design examples as shown in the present disclosure) provided herein in the present disclosure—or equivalently, the UE could assume that the DM-RS antenna port(s) of the PDCCH received in CORESET(s) associated/configured with the first (or second) indicated TCI state/pair of TCI states following those specified in one or more of the design examples (e.g., the design examples as shown in the present disclosure) provided herein in the present disclosure is quasi co-located with the RS(s) in the RS set(s) provided/indicated/configured in the first (or second) indicated TCI state/pair of TCI states, the UE could apply/use the second (or first) indicated TCI state/pair of TCI states to monitor PDCCH candidate(s) received in CORESET(s) associated/configured with the second (or first) indicated TCI state/pair of TCI states following those specified in one or more of the design examples (e.g., the design examples as shown in the present disclosure) provided herein in the present disclosure—or equivalently, the UE could assume that the DM-RS antenna port(s) of the PDCCH received in CORESET(s) associated/configured with the second (or first) indicated TCI state/pair of TCI states following those specified in one or more of the design examples (e.g., the design examples as shown in the present disclosure) provided herein in the present disclosure is quasi co-located with the RS(s) in the RS set(s) provided/indicated/configured in the second (or first) indicated TCI state/pair of TCI states), the UE could apply/use the first indicated TCI state/pair of TCI states to monitor first PDCCH candidate(s) received in CORESET(s) associated/configured with the first indicated TCI state/pair of TCI states following those specified in one or more of the design examples (e.g., the design examples as shown in the present disclosure) provided herein in the present disclosure and the second indicated TCI state/pair of TCI states to monitor second PDCCH candidate(s) received in CORESET(s) associated/configured with the second indicated TCI state/pair of TCI states following those specified in one or more of the design examples (e.g., the design examples as shown in the present disclosure) provided herein in the present disclosure, or the UE could apply/use the second indicated TCI state/pair of TCI states to monitor first PDCCH candidate(s) received in CORESET(s) associated/configured with the second indicated TCI state/pair of TCI states following those specified in one or more of the design examples (e.g., the design examples as shown in the present disclosure) provided herein in the present disclosure and the first indicated TCI state/pair of TCI states to monitor second PDCCH candidate(s) received in CORESET(s) associated/configured with the first indicated TCI state/pair of TCI states following those specified in one or more of the design examples (e.g., the design examples as shown in the present disclosure) provided herein in the present disclosure.

Furthermore, the UE could be indicated/configured/provided by the network, e.g., via higher layer RRC signaling/parameter and/or MAC CE command and/or dynamic DCI based L1 signaling, to follow one or more of the design examples (e.g., the design examples as shown in the present disclosure) specified herein in the present disclosure to determine the association between the indicated TCI state(s) and the PDCCH reception(s). For example, when/if the UE receives from the network, e.g., via higher layer RRC signaling (e.g., in PDCCH-Config, PDSCH-Config or ControlResourceSet), a higher layer parameter “beamSelectionPDCCH” set to “enabled” or a higher layer parameter “dynamicBeamSelectionPDCCH” set to “disabled,” the UE could follow the association/mapping between the CORESET(s) and the indicated TCI state(s)/pair(s) of TCI states —following those specified in one or more of the design examples (e.g., the design examples as shown in the present disclosure) provided herein in the present disclosure—to determine which of the indicated TCI state(s) to use/apply for receiving PDCCH candidate(s) in the CORESET(s)—following those specified in one or more of the design examples (e.g., the design examples as shown in the present disclosure); otherwise, e.g., when/if the higher layer parameter “beamSelectionPDCCH” is set to “disabled” or the higher layer parameter “dynamicBeamSelectionPDCCH” is set to “enabled,” the UE could follow the association/mapping between the CORESET(s) and the indicated TCI state(s)/pair(s) of TCI states—following those specified in one or more of the design examples (e.g., the design examples) provided herein in the present disclosure—to determine, based on in which CORESET(s) the beam indication DCI is received, which of the indicated TCI state(s) to use/apply for receiving PDCCH candidate(s) in any CORESET(s)—following those specified in one or more of the design examples (e.g., the design examples as shown in the present disclosure).

In addition, the UE could use/apply the same TCI state(s)/pair(s) of TCI states as that/those used for monitoring the PDCCH candidate(s)—e.g., following those specified in one or more of the design examples (e.g., the design examples as shown in the present disclosure) specified herein in the present disclosure—to receive PDSCH(s); the PDSCH(s) could be scheduled by the DCI(s) in the PDCCH(s)/PDCCH candidate(s).

In one embodiment, to support dynamic selection/switching of PDSCH reception(s) in a multi-TRP system, the UE could follow one or more of the design examples specified/provided below to determine the association between the indicated TCI state(s) and the PDSCH reception(s). In particular, the UE could determine which of the indicated TCI state(s)/pair(s) of TCI states to use/apply for PDSCH reception(s) according to the association/mapping relationship between the indicated TCI state(s)/pair(s) of TCI states and the CORESET(s) according to one or more of the design examples (e.g., the design examples as shown in the present disclosure) specified herein in the present disclosure.

In one example, if the DCI (e.g., the scheduling DCI or the beam indication DCI with or without DL assignment) is received in a CORESET configured/associated with the first indicated TCI state/pair of TCI states following those specified in one or more of the design examples (e.g., the design examples as shown in the present disclosure) specified herein in the present disclosure, the first indicated TCI state/pair of TCI states could still be applied/used for all PDSCH receptions, and if the DCI (e.g., the scheduling DCI or the beam indication DCI with or without DL assignment) is received in a CORESET configured/associated with the second indicated TCI state/pair of TCI states following those specified in one or more of the design examples (e.g., the design examples as shown in the present disclosure) specified herein in the present disclosure, the second indicated TCI state/pair of TCI states could be applied/used for all PDSCH receptions.

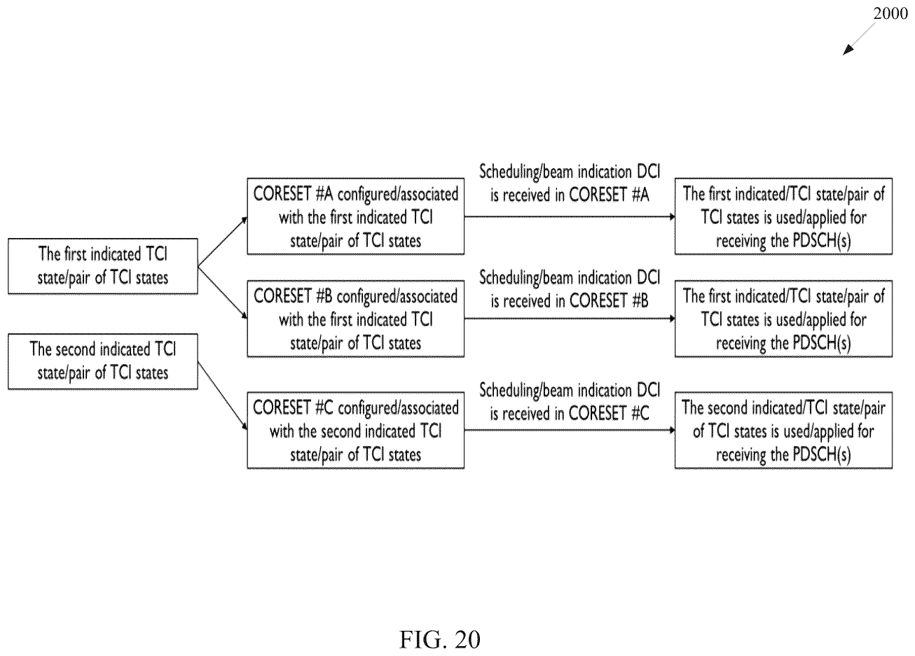

FIG. 20 illustrates an example of associating the indicated TCI states with/to the PDSCH receptions 2000 according to embodiments of the present disclosure. An embodiment of associating the indicated TCI states with/to the PDSCH receptions 2000 shown in FIG. 20 is for illustration only.

In FIG. 20, a conceptual example characterizing the above described association between the indicated TCI state(s) and the PDSCH reception(s) is presented.

In another example, if the DCI (e.g., the scheduling DCI or the beam indication DCI with or without DL assignment) is received in a CORESET configured/associated with the first and/or second indicated TCI states/pairs of TCI states following those specified in one or more of the design examples (e.g., the design examples as shown in the present disclosure) specified herein in the present disclosure, the first indicated TCI state/pair of TCI states could be applied/used for receiving the first PDSCH(s), and the second indicated TCI state/pair of TCI states could be applied/used for receiving the second PDSCH(s).

If the DCI (e.g., the scheduling DCI or the beam indication DCI with or without DL assignment) is received in a CORESET configured/associated with the second and/or first indicated TCI states/pairs of TCI states following those specified in one or more of the design examples (e.g., the design examples as shown in the present disclosure) specified herein in the present disclosure, the first indicated TCI state/pair of TCI states could be applied/used for receiving the second PDSCH(s), and the second indicated TCI state/pair of TCI states could be applied/used for receiving the first PDSCH(s). The UE could be configured/indicated/provided by the network, e.g., via higher layer RRC signaling/parameter and/or MAC CE command and/or dynamic DCI based L1 signaling, the first and/or second PDSCHs and their corresponding/respective configuration information.

In yet another example, if the DCI (e.g., the scheduling DCI or the beam indication DCI with or without DL assignment) is received in a CORESET configured/associated with the first indicated TCI state/pair of TCI states following those specified in one or more of the design examples (e.g., the design examples as shown in the present disclosure) specified herein in the present disclosure, the first indicated TCI state/pair of TCI states could be applied/used for all PDSCH receptions, and if the DCI (e.g., the scheduling DCI or the beam indication DCI with or without DL assignment) is received in a CORESET configured/associated with the first and/or second indicated TCI states/pairs of TCI states following those specified in one or more of the design examples (e.g., the design examples as shown in the present disclosure) specified herein in the present disclosure, the first indicated TCI state/pair of TCI states could be applied/used for receiving the first (or second) PDSCH(s), and the second indicated TCI state/pair of TCI states could be applied/used for receiving the second (or first) PDSCH(s). The UE could be configured/indicated/provided by the network, e.g., via higher layer RRC signaling/parameter and/or MAC CE command and/or dynamic DCI based L1 signaling, the first and/or second PDSCHs and their corresponding/respective configuration information.

In yet another example, if the DCI (e.g., the scheduling DCI or the beam indication DCI with or without DL assignment) is received in a CORESET configured/associated with the second indicated TCI state/pair of TCI states following those specified in one or more of the design examples (e.g., the design examples as shown in the present disclosure) specified herein in the present disclosure, the second indicated TCI state/pair of TCI states could be applied/used for all PDSCH receptions, and if the DCI (e.g., the scheduling DCI or the beam indication DCI with or without DL assignment) is received in a CORESET configured/associated with the first and/or second indicated TCI states/pairs of TCI states following those specified in one or more of the design examples (e.g., the design examples as shown in the present disclosure) specified herein in the present disclosure, the first indicated TCI state/pair of TCI states could be applied/used for receiving the first (or second) PDSCH(s), and the second indicated TCI state/pair of TCI states could be applied/used for receiving the second (or first) PDSCH(s). The UE could be configured/indicated/provided by the network, e.g., via higher layer RRC signaling/parameter and/or MAC CE command and/or dynamic DCI based L1 signaling, the first and/or second PDSCHs and their corresponding/respective configuration information.

In yet another example, if the DCI (e.g., the scheduling DCI or the beam indication DCI with or without DL assignment) is received in a CORESET configured/associated with the first and/or second indicated TCI states/pairs of TCI states following those specified in one or more of the design examples (e.g., the design examples as shown in the present disclosure) specified herein in the present disclosure, the first indicated TCI state/pair of TCI states could be applied/used for receiving the first PDSCH DM-RS(s) (or equivalently, the RS(s) in the RS set(s) provided in the first indicated TCI state/pair of TCI states could be QCL'ed with the first DM-RS antenna port(s) for PDSCH reception(s)), and the second indicated TCI state/pair of TCI states could be applied/used for receiving the second PDSCH DM-RS(s) (or equivalently, the RS(s) in the RS set(s) provided in the second indicated TCI state/pair of TCI states could be QCL'ed with the second DM-RS antenna port(s) for PDSCH reception(s)).

If the DCI (e.g., the scheduling DCI or the beam indication DCI with or without DL assignment) is received in a CORESET configured/associated with the second and/or first indicated TCI states/pairs of TCI states following those specified in one or more of the design examples (e.g., the design examples as shown in the present disclosure) specified herein in the present disclosure, the first indicated TCI state/pair of TCI states could be applied/used for receiving the second PDSCH DM-RS(s) (or equivalently, the RS(s) in the RS set(s) provided in the second indicated TCI state/pair of TCI states could be QCL'ed with the second DM-RS antenna port(s) for PDSCH reception(s)), and the second indicated TCI state/pair of TCI states could be applied/used for receiving the first PDSCH DM-RS(s) (or equivalently, the RS(s) in the RS set(s) provided in the second indicated TCI state/pair of TCI states could be QCL'ed with the first DM-RS antenna port(s) for PDSCH reception(s)).

In yet another example, if the DCI (e.g., the scheduling DCI or the beam indication DCI with or without DL assignment) is received in a CORESET configured/associated with the first indicated TCI state/pair of TCI states following those specified in one or more of the design examples (e.g., the design examples as shown in the present disclosure) specified herein in the present disclosure, the first indicated TCI state/pair of TCI states could be applied/used for all PDSCH receptions, if the DCI (e.g., the scheduling DCI or the beam indication DCI with or without DL assignment) is received in a CORESET configured/associated with the second indicated TCI state/pair of TCI states following those specified in one or more of the design examples (e.g., the design examples as shown in the present disclosure) specified herein in the present disclosure, the second indicated TCI state/pair of TCI states could be applied/used for all PDSCH receptions, if the DCI (e.g., the scheduling DCI or the beam indication DCI with or without DL assignment) is received in a CORESET configured/associated with the first and/or second indicated TCI states/pairs of TCI states following those specified in one or more of the design examples (e.g., the design examples as shown in the present disclosure) specified herein in the present disclosure, the first indicated TCI state/pair of TCI states could be applied/used for receiving the first PDSCH(s), and the second indicated TCI state/pair of TCI states could be applied/used for receiving the second PDSCH(s), and if the DCI (e.g., the scheduling DCI or the beam indication DCI with or without DL assignment) is received in a CORESET configured/associated with the second and/or first indicated TCI state/pair of TCI states following those specified in one or more of the design examples (e.g., the design examples as shown in the present disclosure) specified herein in the present disclosure, the first indicated TCI state/pair of TCI states could be applied/used for receiving the second PDSCH(s), and the second indicated TCI state/pair of TCI states could be applied/used for receiving the first PDSCH(s).

In yet another example, if the DCI (e.g., the scheduling DCI or the beam indication DCI with or without DL assignment) is received in a CORESET configured/associated with the first indicated TCI state/pair of TCI states following those specified in one or more of the design examples (e.g., the design examples as shown in the present disclosure) specified herein in the present disclosure, the first indicated TCI state/pair of TCI states could be applied/used for all PDSCH receptions, if the DCI (e.g., the scheduling DCI or the beam indication DCI with or without DL assignment) is received in a CORESET configured/associated with the second indicated TCI state/pair of TCI states following those specified in one or more of the design examples (e.g., the design examples as shown in the present disclosure) specified herein in the present disclosure, the second indicated TCI state/pair of TCI states could be applied/used for all PDSCH receptions, if the DCI (e.g., the scheduling DCI or the beam indication DCI with or without DL assignment) is received in a CORESET configured/associated with the first and/or second indicated TCI states/pairs of TCI states following those specified in one or more of the design examples (e.g., the design examples as shown in the present disclosure) specified herein in the present disclosure, the first indicated TCI state/pair of TCI states could be applied/used for receiving the first PDSCH DM-RS(s) (or equivalently, the RS(s) in the RS set(s) provided in the first indicated TCI state/pair of TCI states could be QCL'ed with the first DM-RS antenna port(s) for PDSCH reception(s)), and the second indicated TCI state/pair of TCI states could be applied/used for receiving the second PDSCH DM-RS(s) (or equivalently, the RS(s) in the RS set(s) provided in the second indicated TCI state/pair of TCI states could be QCL'ed with the second DM-RS antenna port(s) for PDSCH reception(s)), and if the DCI (e.g., the scheduling DCI or the beam indication DCI with or without DL assignment) is received in a CORESET configured/associated with the second and/or first indicated TCI states/pairs of TCI states following those specified in one or more of the design examples (e.g., the design examples as shown in the present disclosure) specified herein in the present disclosure, the first indicated TCI state/pair of TCI states could be applied/used for receiving the second PDSCH DM-RS(s) (or equivalently, the RS(s) in the RS set(s) provided in the second indicated TCI state/pair of TCI states could be QCL'ed with the second DM-RS antenna port(s) for PDSCH reception(s)), and the second indicated TCI state/pair of TCI states could be applied/used for receiving the first PDSCH DM-RS(s) (or equivalently, the RS(s) in the RS set(s) provided in the second indicated TCI state/pair of TCI states could be QCL'ed with the first DM-RS antenna port(s) for PDSCH reception(s)).

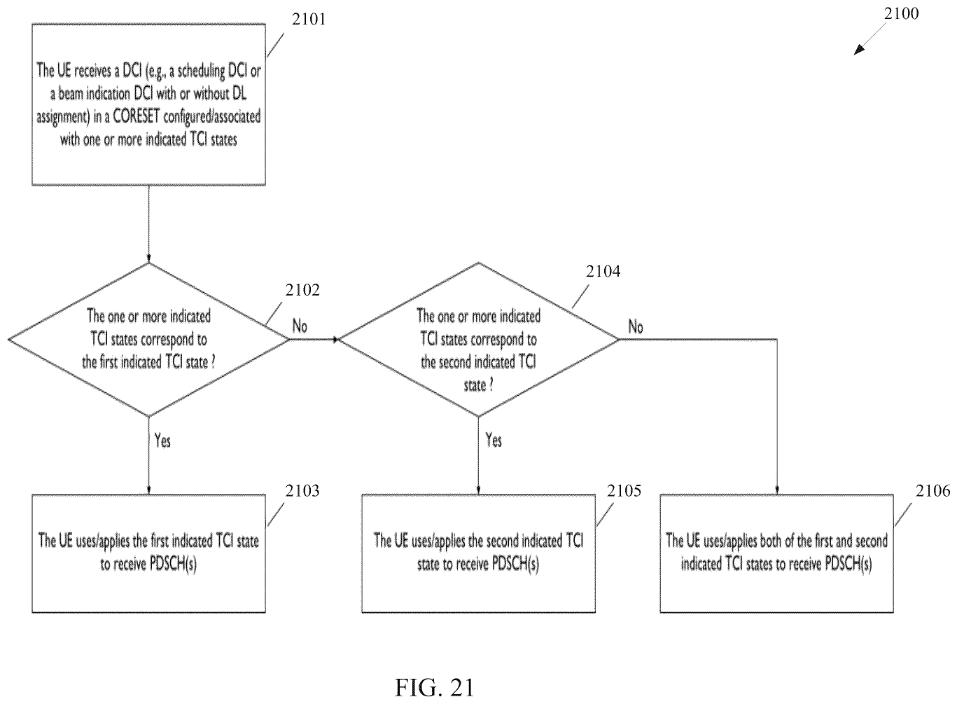

The UE could be provided/configured/indicated by the network, e.g., via higher layer RRC signaling/parameter and/or MAC CE command and/or dynamic DCI based L1 signaling, to follow one or more of the design examples (e.g., the design examples as shown in the present disclosure) and/or combination(s) of one or more of the design examples (e.g., the design examples as shown in the present disclosure) specified/discussed herein in the present disclosure to determine the association between the indicated TCI state(s) and the PDSCH reception(s). For instance, a higher layer parameter “dynamicBeamSelectionPDSCH” can be provided/configured/indicated in, e.g., PDSCH-Config. When/if the higher layer parameter “dynamicBeamSelectionPDSCH” is set to “enabled,” the UE could follow one or more of the design examples (e.g., the design examples as shown in the present disclosure) and/or combination(s) of one or more of the design examples (e.g., the design examples as shown in the present disclosure) specified/discussed herein in the present disclosure to determine the association between the indicated TCI state(s) and the PDSCH reception(s). The overall procedures of determining the association between the indicated TCI state(s) and the PDSCH reception(s) specified herein in the present disclosure is provided in FIG. 21.

FIG. 21 illustrates a flowchart of the UE procedure 2100 for determining the association between the indicated TCI states and the PDSCH receptions according to embodiments of the present disclosure. For example, the UE procedure 2100 as may be performed by a UE such as 111-116 as illustrated in FIG. 1). An embodiment of the UE procedure 2100 shown in FIG. 21 is for illustration only. One or more of the components illustrated in FIG. 21 can be implemented in specialized circuitry configured to perform the noted functions or one or more of the components can be implemented by one or more processors executing instructions to perform the noted functions.

As illustrated in FIG. 21, the UE in step 2101 receives a DCI in a CORESET configured with one or more indicated TCI states. In step 2102, the UE determines if one or more indicated TCI states corresponds to the first indicated TCI state. In step 2103, the UE use the first indicated TCI state to receive PDSCH(s). In step 2104, the UE determines if one or more indicated TCI states corresponds to the second indicated TCI state. In step 2105, the UE uses the second indicated TCI state to receive PDSCH(s). In step 2106, the UE uses both of the first and second indicated TCI states to receive PDSCH(s).

In the present disclosure, a CORESET group could comprise/contain/include one or more CORESETs associated/configured with the same indicator(s)/pointer(s) such as the one-bit indicator, two-bit indicator, TCI state ID(s)/index(s), TCI state group ID(s)/index(es), TCI state list ID(s)/index(es) and etc. specified herein in their corresponding ControlResourceSet. Alternatively, a CORESET group could comprise/contain/include one or more CORESETs associated/configured with the same TCI state(s)—or TCI state ID(s)/index(es), the same TCI state group(s)—and therefore, the TCI state IDs/indexes or TCI states provided therein, the same TCI state list(s)—and therefore, the TCI state IDs/indexes or TCI states provided therein, and etc.

Optionally, a CORESET group could comprise/contain/include one or more common search space (CSS) CORESETs; furthermore, a CORESET group could comprise/contain/include one or more UE specific search space (USS) CORESETs. In addition, a CORESET group could comprise/contain/include one or more CORESETs that need to be higher layer configured (e.g., with followunifiedTCI in their respective ControlResourceSet) to follow the indicated unified TCI state(s), while a CORESET group could also comprise/contain/include one or more CORESETs that may always follow the indicated TCI state(s).

In the present disclosure, the first PDCCH(s)/PDCCH candidate(s) and/or the second PDCCH(s)/PDCCH candidate(s) could correspond to or could be determined according to one or more of the following design examples or combination(s) of one or more of the following design examples.

In one example, the first PDCCH(s)/PDCCH candidate(s) and the second PDCCH(s)/PDCCH candidate(s) could be the same/identical. For this case, the first PDCCH(s)/PDCCH candidate(s) and the second PDCCH(s)/PDCCH candidate(s) could be received in the same CORESET associated/configured with more than one (e.g., two) active/activated TCI states/pairs of TCI states.

In another example, the first PDCCH(s)/PDCCH candidate(s) and the second PDCCH(s)/PDCCH candidate(s) could be received in search space sets/CORESETs that are higher layer linked, e.g., via a higher layer parameter SearchSpaceLinking.

In yet another example, the first (or second) PDCCH(s)/PDCCH candidate(s) could be received in a CORESET associated/configured with more than one (e.g., two) active/activated TCI states/pairs of TCI states, and the second (or first) PDCCH(s)/PDCCH candidate(s) could be received in a search space set/CORESET higher layer configured with a higher layer parameter SearchSpaceLinking.

In the present disclosure, unless otherwise specified, the first PDSCH(s) could correspond the first PDSCH DM-RS(s) or the first DM-RS antenna port(s) for PDSCH reception(s), and the second PDSCH(s) could correspond to the second PDSCH DM-RS(s) or the second DM-RS antenna port(s) for PDSCH reception(s). The UE could be configured/indicated/provided by the network, e.g., via higher layer RRC signaling/parameter and/or MAC CE command and/or dynamic DCI based L1 signaling, the first and/or second DM-RS antenna ports and their corresponding/respective configuration information. The first PDSCH(s) and/or the second PDSCH(s) could correspond to or could be determined according to one or more of the following design examples or combination(s) of one or more of the following design examples.

In one example, when a UE is configured/provided/indicated by the network the higher layer parameter repetitionScheme set to “fdmSchemeA,” the UE may receive a single PDSCH transmission occasion of the transport block (TB), and may assume that precoding granularity is PBWP resource blocks in the frequency domain, where PBWP can be equal to one of the values among {2, 4, wideband}. For N=2 or M=2, if PBWP is configured/determined as “wideband,” the first (or second) PDCCH(s) could correspond to the first ┌n_{PRB}/2┐ PRBs, and the second (or first) PDSCH(s) could correspond to the remaining └n_{PRB}/2┘ PRBs, where n_{PRB} is the total number of allocated PRBs for the UE. If PBWP is configured/determined as one of the values among {2, 4}, the first (or second) PDSCH(s) could correspond to even precoding resource block groups (PRGs) within the allocated frequency domain resources, and the second (or first) PDSCH(s) could correspond to odd PRGs within the allocated frequency domain resources, wherein the PRGs are numbered continuously in increasing order with the first PRG index equal to 0.

In another example, when a UE is configured/provided/indicated by the network the higher layer parameter repetitionScheme set to “fdmSchemeB,” the UE may receive two PDSCH transmission occasions of the same TB, and may assume that precoding granularity is PBWP resource blocks in the frequency domain, where PBWP can be equal to one of the values among {2, 4, wideband}. For N=2 or M=2, if PBWP is configured/determined as “wideband,” the first (or second) PDCCH(s) could correspond to the first ┌n_{PRB}/2┐ PRBs, and the second (or first) PDSCH(s) could correspond to the remaining └n_{PRB}/2┘ PRBs, where n_{PRB} is the total number of allocated PRBs for the UE. If PBWP is configured/determined as one of the values among {2, 4}, the first (or second) PDSCH(s) could correspond to even precoding resource block groups (PRGs) within the allocated frequency domain resources, and the second (or first) PDSCH(s) could correspond to odd PRGs within the allocated frequency domain resources, wherein the PRGs are numbered continuously in increasing order with the first PRG index equal to 0.

In yet another example, when a UE is configured/provided/indicated by the network the higher layer parameter repetitionScheme set to “tdmSchemeA,” the UE may receive two PDSCH transmission occasions of the transport block (TB) within a given slot. For this case, the first (or second) PDSCH(s) in the present disclosure could correspond to the first PDSCH transmission occasion and resource allocation in time domain for the first PDSCH transmission occasion follows those described in the 3GPP TS 38.214. The second (or first) PDSCH(s) in the present disclosure could correspond to the second PDSCH transmission occasion, and the second PDSCH transmission occasion may have the same number of symbols as the first PDSCH transmission occasion.

In yet another example, when a UE is configured/provided by the network the higher layer parameter repetitionNumber in PDSCH-TimeDomainResourceAllocation, the UE may expect to receive multiple slot level PDSCH transmission occasions of the same TB in the repetitionNumber consecutive slots. When the value indicated by repetitionNumber in PDSCH-TimeDomainResourceAllocation equals to two, the first (or second) PDSCH(s) could correspond to the first PDSCH transmission occasion and resource allocation in time domain for the first PDSCH transmission occasion follows those described in the 3GPP TS 38.214 and the second (or first) PDSCH(s) could correspond to the second PDSCH transmission occasion. When the value of repetitionNumber in PDSCH-TimeDomainResourceAllocation is larger than two, the UE may be further configured to enable cyclicMapping or sequentialMapping.

When cyclicMapping is enabled, the first (or second) PDSCH(s) and the second (or first) PDSCH(s) could correspond to the first PDSCH transmission occasion and the second PDSCH transmission occasion, respectively, and the same mapping pattern continues to the remaining PDSCH transmission occasions. When sequentialMapping is enabled, the first (or second) PDSCH(s) could correspond to the first and second PDSCH transmission occasions, and the second (or first) PDSCH(s) could correspond to the third and fourth PDSCH transmission occasions, and the same mapping pattern continues to the remaining PDSCH transmission occasions.

A CORESET with index 0 (i.e., CORESET 0) could be associated/specific to/with coresetPoolIndex value 0 and/or 1.

In one example, the UE could be provided/indicated/configured by the network, e.g., via higher layer RRC signaling/parameter and/or MAC CE command and/or dynamic DCI based L1 signaling, the association/mapping between CORESET 0 and the coresetPoolIndex value(s). For example, an indicator could be provided/indicated/configured in higher layer RRC parameter(s) such as MIB, SIB, ControlResourceSet, ControlResourceSetZero, searchSpace, searchSpaceZero, and/or etc. that configures the corresponding CORESET with index 0 (i.e., CORESET 0); for this case, when/if the indicator is set to “0,” “00,” or “first” (“1,” “01,” “10,” “11,” “second” or “both”), the CORESET 0 could be associated/specific to/with coresetPoolIndex value 0, when/if the indicator is set to “1,” “01,” or “second” (“0,” “00,” “10,” “11,” “first” or “both”), the CORESET 0 could be associated/specific to/with coresetPoolIndex value 1, and when/if the indicator is set to “10,” “11,” or “both” (“0,” “1,” “00,” “01,” “first,” or “second”), the CORESET 0 could be associated/specific to/with both coresetPoolIndex values 0 and 1.

For another example, one or more coresetPoolIndex parameters/fields could be provided/indicated/configured in higher layer RRC parameter(s) such as MIB, SIB, ControlResourceSet, ControlResourceSetZero, searchSpace, searchSpaceZero, and/or etc. that configures the corresponding CORESET with index 0 (i.e., CORESET 0); for this case, when/if a coresetPoolIndex parameter/field configured/provided/indicated therein is set to “0,” the corresponding CORESET 0 could be associated/specific to/with coresetPoolIndex value 0; when/if a coresetPoolIndex parameter/field configured/provided/indicated therein is set to “1,” the corresponding CORESET 0 could be associated/specific to/with coresetPoolIndex value 1; when/if two coresetPoolIndex parameters/fields configured/provided/indicated therein are set to “0” and “1” respectively, the corresponding CORESET 0 could be associated/specific to/with both coresetPoolIndex values 0 and 1.

In another example, the UE could follow fixed rule(s)/relation(s), e.g., provided in the system specification(s), to determine/identify the association/mapping between CORESET 0 and the coresetPoolIndex value(s). For example, the CORESET with index 0 (i.e., CORESET 0) could always be associated/specific to/with coresetPoolIndex value 0. For another example, the CORESET with index 0 (i.e., CORESET 0) could always be associated/specific to/with coresetPoolIndex value 1. Yet for another example, the CORESET with index 0 (i.e., CORESET 0) could always be associated/specific to/with both coresetPoolIndex values 0 and 1.

In yet another example, the UE could determine/identify, based on the association/mapping between channel(s)/signal(s) (e.g., SSB(s)) that carries/provides/indicates information/parameter(s) (e.g., MIB) configuring, e.g., resource allocation, for CORESET 0 and the coresetPoolIndex value(s), the association/mapping between CORESET 0 and the coresetPoolIndex value(s). For instance, when/if SSB(s) or PBCH in SSB(s) that carries/provides/indicates MIB configuring the resource allocation (i.e., time and frequency domain resource allocations) for CORESET 0 is associated/specific to/with coresetPoolIndex value 0 (and/or 1), the UE could determine/identify that the CORESET 0 is also associated/specific to/with coresetPoolIndex value 0 (and/or 1).

For the MDCI based MTRP operation (e.g., if a UE is provided two coresetPoolIndex values 0 and 1 for the first and second CORESETs, or is not provided coresetPoolIndex value for the first CORESETs and is provided coresetPoolIndex value of 1 for the second CORESETs, respectively), the UE could receive from the network an (enhanced) unified TCI state(s) activation/deactivation MAC CE command used to map up to Ntci (e.g., Ntci=8) TCI states and/or pairs of TCI states, with one TCI state for DL channels/signals and/or one TCI state for UL channels/signals to the TCI codepoints of the DCI field “Transmission Configuration Indication” for one or for a set of CCs/DL BWPs, and if applicable, for one or for a set of CCs/UL BWPs. If the (enhanced) unified TCI state(s) activation/deactivation MAC CE command maps TCI-State and/or UL-TCI-State to only one TCI codepoint, the UE may apply the indicated TCI-State and/or UL-TCI-State to one or to a set of CCs/DL BWPs, and if applicable, to one or to a set of CCs/UL BWPs once the indicated mapping for the one single TCI codepoint is applied.

Furthermore, the (enhanced) unified TCI state(s) activation/deactivation MAC CE command could also provide/indicate/configure/include/contain/comprise a coresetPoolIndex value field. When/if the coresetPoolIndex value field in the (enhanced) unified TCI state(s) activation/deactivation MAC CE is set to “0” (or “1”), the joint/DL/UL TCI state(s) activated by/in the (enhanced) unified TCI state(s) activation/deactivation MAC CE could be specific/associated to/with the coresetPoolIndex value 0 (or 1). In addition, the UE could be indicated by the network, e.g., via one or more TCI codepoints of one or more TCI fields in one or more DCIs (e.g., DCI format 1_1/1_2 with or without DL assignment) received in one or more CORESETs associated/configured with coresetPoolIndex value 0 (or 1), at least a first TCI state for DL channels/signals and/or a second TCI state for UL channels/signals for one or for a set of CCs/DL BWPs, and if applicable, for one or for a set of CCs/UL BWPs; for this case, the first and the second TCI states could be specific/associated to/with the coresetPoolIndex value 0 (or 1).

When/if a CORESET with index 0 (i.e., CORESET 0) is specific/associated to/with coresetPoolIndex value 0 according to those specified herein in the present disclosure, the UE could assume that a DM-RS antenna port for PDCCH receptions in the CORESET 0 is quasi co-located with the reference signals provided by a joint/DL TCI state specific/associated to/with the same coresetPoolIndex value 0 according to those specified herein in the present disclosure.

When/if a CORESET with index 0 (i.e., CORESET 0) is specific/associated to/with coresetPoolIndex value 1 according to those specified herein in the present disclosure, the UE could assume that a DM-RS antenna port for PDCCH receptions in the CORESET 0 is quasi co-located with the reference signals provided by a joint/DL TCI state specific/associated to/with the same coresetPoolIndex value 1 according to those specified herein in the present disclosure.

When/if a CORESET with index 0 (i.e., CORESET 0) is specific/associated to/with both coresetPoolIndex values 0 and 1 according to those specified herein in the present disclosure, the UE could assume that a DM-RS antenna port for PDCCH receptions in the CORESET 0 is quasi co-located with the reference signals provided by joint/DL TCI states specific/associated to/with both coresetPoolIndex values 0 and 1 according to those specified herein in the present disclosure.

For the SDCI based MTRP operation, the UE could receive from the network an (enhanced) unified TCI state(s) activation/deactivation MAC CE command used to map up to Ntci (e.g., Ntci=8) TCI codepoints of the DCI field “Transmission Configuration Indication” for one or for a set of CCs/DL BWPs, and if applicable, for one or for a set of CCs/UL BWPs, wherein each TCI codepoint could comprise one or two TCI states for DL channels/signals and/or one or two TCI states for UL channels/signals and/or one or two pairs of TCI states with each pair comprising one TCI state for DL channels/signals and one TCI state for UL channels/signals. If the (enhanced) unified TCI state(s) activation/deactivation MAC CE command maps the joint/DL/UL TCI state(s) to only one TCI codepoint, the UE may apply the indicated joint/DL/UL TCI state(s) to one or to a set of CCs/DL BWPs, and if applicable, to one or to a set of CCs/UL BWPs once the indicated mapping for the one single TCI codepoint is applied.

Furthermore, the UE could be indicated by the network, e.g., via one or more TCI codepoints of one or more TCI fields in one or more DCIs (e.g., DCI format 1_1/1_2 with or without DL assignment), at least a first and/or a second joint/DL TCI state(s) for DL channels/signals and/or a first and/or a second joint/UL TCI state(s) for UL channels/signals for one or for a set of CCs/DL BWPs, and if applicable, for one or for a set of CCs/UL BWPs.

A CORESET with index 0 (i.e., CORESET 0) could be associated/specific to/with the first and/or the second joint/DL TCI state(s) as specified herein in the present disclosure for the SDCI based MTRP operation.

In one example, the UE could be provided/indicated/configured by the network, e.g., via higher layer RRC signaling/parameter and/or MAC CE command and/or dynamic DCI based L1 signaling, the association/mapping between CORESET 0 and the first/second joint/DL TCI state(s). For example, an indicator could be provided/indicated/configured in higher layer RRC parameter(s) such as MIB, SIB, ControlResourceSet, ControlResourceSetZero, searchSpace, searchSpaceZero, and/or etc. that configures the corresponding CORESET with index 0 (i.e., CORESET 0), for this case, following examples can be provided.

In one example, when/if the indicator is set to “0,” “00,” or “first” (“1,” “01,” “10,” “11,” “second,” or “both”), the CORESET 0 could be associated/specific to/with the first joint/DL TCI state as specified herein in the present disclosure, such that, the UE could assume that a DM-RS antenna port for PDCCH receptions in the CORESET 0 is quasi co-located with the reference signals provided by the first joint/DL TCI state as specified herein in the present disclosure for the SDCI based MTRP operation.

In another example, when/if the indicator is set to “1,” “01,” or “second” (“0,” “00,” “10,” “11,” “first,” or “both”), the CORESET 0 could be associated/specific to/with the second joint/DL TCI state as specified herein in the present disclosure, such that, the UE could assume that a DM-RS antenna port for PDCCH receptions in the CORESET 0 is quasi co-located with the reference signals provided by the second joint/DL TCI state as specified herein in the present disclosure for the SDCI based MTRP operation.

In yet another example, when/if the indicator is set to “10,” “11,” or “both” (“0,” “1,” “00,” “01,” “first,” or “second”), the CORESET 0 could be associated/specific to/with both the first and the second joint/DL TCI states as specified herein in the present disclosure, such that, the UE could assume that a DM-RS antenna port for PDCCH receptions in the CORESET 0 is quasi co-located with the reference signals provided by both the first and the second joint/DL TCI states as specified herein in the present disclosure for the SDCI based MTRP operation.

In another example, the UE could follow fixed rule(s)/relation(s), e.g., provided in the system specification(s), to determine/identify the association/mapping between CORESET 0 and the first/second joint/DL TCI state(s) as specified herein in the present disclosure for the SDCI based MTRP operation.

For example, the CORESET with index 0 (i.e., CORESET 0) could always be associated/specific to/with the first joint/DL TCI state as specified herein in the present disclosure for the SDCI based MTRP operation, such that, the UE could assume that a DM-RS antenna port for PDCCH receptions in the CORESET 0 is quasi co-located with the reference signals provided by the first joint/DL TCI state as specified herein in the present disclosure for the SDCI based MTRP operation.

For another example, the CORESET with index 0 (i.e., CORESET 0) could always be associated/specific to/with the second joint/DL TCI state as specified herein in the present disclosure for the SDCI based MTRP operation, such that, the UE could assume that a DM-RS antenna port for PDCCH receptions in the CORESET 0 is quasi co-located with the reference signals provided by the second joint/DL TCI state as specified herein in the present disclosure for the SDCI based MTRP operation.

Yet for another example, the CORESET with index 0 (i.e., CORESET 0) could always be associated/specific to/with both the first and the second joint/DL TCI states as specified herein in the present disclosure for the SDCI based MTRP operation, such that, the UE could assume that a DM-RS antenna port for PDCCH receptions in the CORESET 0 is quasi co-located with the reference signals provided by both the first and the second joint/DL TCI states as specified herein in the present disclosure for the SDCI based MTRP operation.

In yet another example, the UE could determine/identify, based on the association/mapping between channel(s)/signal(s) (e.g., SSB(s)) that carries/provides/indicates information/parameter(s) (e.g., MIB) configuring, e.g., resource allocation, for CORESET 0 and the first/second joint/DL TCI state(s) as specified herein in the present disclosure for the SDCI based MTRP operation, the association/mapping between CORESET 0 and the first/second joint/DL TCI state(s) as specified herein in the present disclosure for the SDCI based MTRP operation.

For example, when/if SSB(s) or PBCH in SSB(s) that carries/provides/indicates MIB configuring the resource allocation (i.e., time and frequency domain resource allocations) for CORESET 0 is associated/specific to/with the first joint/DL TCI state as specified herein in the present disclosure, the UE could determine/identify that the CORESET 0 is also associated/specific to/with the first joint/DL TCI state, such that, the UE could assume that a DM-RS antenna port for PDCCH receptions in the CORESET 0 is quasi co-located with the reference signals provided by the first joint/DL TCI state as specified herein in the present disclosure for the SDCI based MTRP operation.

For another example, when/if SSB(s) or PBCH in SSB(s) that carries/provides/indicates MIB configuring the resource allocation (i.e., time and frequency domain resource allocations) for CORESET 0 is associated/specific to/with the second joint/DL TCI state as specified herein in the present disclosure, the UE could determine/identify that the CORESET 0 is also associated/specific to/with the second joint/DL TCI state, such that, the UE could assume that a DM-RS antenna port for PDCCH receptions in the CORESET 0 is quasi co-located with the reference signals provided by the second joint/DL TCI state as specified herein in the present disclosure for the SDCI based MTRP operation.

Yet for another example, when/if SSB(s) or PBCH in SSB(s) that carries/provides/indicates MIB configuring the resource allocation (i.e., time and frequency domain resource allocations) for CORESET 0 is associated/specific to/with the both the first and the second joint/DL TCI states as specified herein in the present disclosure, the UE could determine/identify that the CORESET 0 is also associated/specific to/with both the first and the second joint/DL TCI states, such that, the UE could assume that a DM-RS antenna port for PDCCH receptions in the CORESET 0 is quasi co-located with the reference signals provided by both the first and the second joint/DL TCI states as specified herein in the present disclosure for the SDCI based MTRP operation.

Any of the above variation embodiments can be utilized independently or in combination with at least one other variation embodiment.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive first information for first and second groups of configured transmission configuration indication (TCI) states;
receive, in a downlink control information (DCI), a first indicated TCI state of a TCI codepoint; and
receive second information for a first control resource set (CORESET); and
a processor operably coupled with the transceiver, the processor configured to:
identify, based on the first information, whether the first indicated TCI state is associated with the first or second group of configured TCI states; and
identify, based on the second information, whether the first CORESET is associated with the first or second group of configured TCI states,
wherein, when the first indicated TCI state and the first CORESET are associated with the same group of configured TCI states, the transceiver is further configured to receive physical downlink control channel (PDCCH) candidates in the first CORESET according to the first indicated TCI state.

2. The UE of claim 1, wherein the first information indicates at least one of:
a bitwidth of an identity (ID) of a configured TCI state in the first or second group, determined according to one of:
a total number of configured TCI states in the first or second group; and
a total number of configured TCI states across both of the first and second groups; and
an indicator associated with an activated TCI codepoint comprising at least one TCI state.

3. The UE of claim 2, wherein:
when the indicator is set to ‘first’ or ‘0’, the at least one TCI state of the activated TCI codepoint is from the first group; and
when the indicator is set to ‘second’ or ‘1’, the at least one TCI state of the activated TCI codepoint is from the second group.

4. The UE of claim 1, wherein the second information indicates at least one of:
first and second groups of CORESETs where:
when the first CORESET belongs to the first group of CORESETs, the first CORESET is associated with the first group of configured TCI states; and
when the first CORESET belongs to the second group of CORESETs, the first CORESET is associated with the second group of configured TCI states; and
an index of the first or second group of configured TCI states.

5. The UE of claim 4, wherein:
the transceiver is further configured to receive the index in a ControlResourceSet that configures the first CORESET;
when the index corresponds to the first group of configured TCI states, the first CORESET is associated with the first group of configured TCI states; and
when the index corresponds to the second group of configured TCI states, the first CORESET is associated with the second group of configured TCI states.

6. The UE of claim 1, wherein:
the transceiver is further configured to receive, in the DCI, a second indicated TCI state of the TCI codepoint; and
when the first CORESET is associated with the first and second groups of configured TCI states, the processor is further configured to determine that a demodulation (DM) reference signal (RS) antenna port for PDCCH receptions in the first CORESET is quasi co-located with RSs provided by the first and second indicated TCI states.

7. The UE of claim 1, wherein:
the transceiver is further configured to:
receive, in the DCI, a second indicated TCI state of the TCI codepoint; and
receive PDCCH candidates, different from those for the first CORESET, in a second CORESET according to the first or second indicated TCI state; and
when the first and second CORESETs overlap in one or more time or frequency domain resources, the PDCCH candidates are received in the one or more overlapping time or frequency domain resources according to (i) the first or second indicated TCI state or (ii) an indicated TCI state for a reference CORESET.

8. The UE of claim 7, wherein the reference CORESET corresponds to the first or second CORESET:
with a lower or higher CORESET index;
with a lower or higher control channel element (CCE) index;
with a lower or higher coresetPoolIndex; or
received earlier or later in time.

9. A base station (BS), comprising:
a transceiver configured to:
transmit first information for first and second groups of configured transmission configuration indication (TCI) states;
transmit, in a downlink control information (DCI), a first indicated TCI state of a TCI codepoint; and
transmit second information for a first control resource set (CORESET); and
a processor operably coupled with the transceiver, the processor configured to:
identify, based on the first information, whether the first indicated TCI state is associated with the first or second group of configured TCI states; and
identify, based on the second information, whether the first CORESET is associated with the first or second group of configured TCI states,
wherein, when the first indicated TCI state and the first CORESET are associated with the same group of configured TCI states, the transceiver is further configured to transmit physical downlink control channel (PDCCH) candidates in the first CORESET according to the first indicated TCI state.

10. The BS of claim 9, wherein the first information indicates at least one of:
a bitwidth of an identity (ID) of a configured TCI state in the first or second group, determined according to one of:
a total number of configured TCI states in the first or second group; and
a total number of configured TCI states across both of the first and second groups; and
an indicator associated with an activated TCI codepoint comprising at least one TCI state.

11. The BS of claim 10, wherein:
when the indicator is set to ‘first’ or ‘0’, the at least one TCI state of the activated TCI codepoint is from the first group; and
when the indicator is set to ‘second’ or ‘1’, the at least one TCI state of the activated TCI codepoint is from the second group.

12. The BS of claim 9, wherein the second information indicates at least one of:
first and second groups of CORESETs where:
when the first CORESET belongs to the first group of CORESETs, the first CORESET is associated with the first group of configured TCI states; and
when the first CORESET belongs to the second group of CORESETs, the first CORESET is associated with the second group of configured TCI states; and
an index of the first or second group of configured TCI states.

13. The BS of claim 12, wherein:
the transceiver is further configured to transmit the index in a ControlResourceSet that configures the first CORESET;
when the index corresponds to the first group of configured TCI states, the first CORESET is associated with the first group of configured TCI states; and
when the index corresponds to the second group of configured TCI states, the first CORESET is associated with the second group of configured TCI states.

14. The BS of claim 9, wherein:
the transceiver is further configured to transmit, in the DCI, a second indicated TCI state of the TCI codepoint; and
the first CORESET being associated with the first and second groups of configured TCI states indicates that a demodulation (DM) reference signal (RS) antenna port for PDCCH transmissions in the first CORESET is quasi co-located with RSs provided by the first and second indicated TCI states.

15. The BS of claim 9, wherein:
the transceiver is further configured to:
transmit, in the DCI, a second indicated TCI state of the TCI codepoint; and
transmit PDCCH candidates, different from those for the first CORESET, in a second CORESET according to the first or second indicated TCI state; and
when the first and second CORESETs overlap in one or more time or frequency domain resources, the PDCCH candidates are transmitted in the one or more overlapping time or frequency domain resources according to (i) the first or second indicated TCI state or (ii) an indicated TCI state for a reference CORESET.

16. The BS of claim 15, wherein the reference CORESET corresponds to the first or second CORESET:
with a lower or higher CORESET index;
with a lower or higher control channel element (CCE) index;
with a lower or higher coresetPoolIndex; or
transmitted earlier or later in time.

17. A method performed by a user equipment (UE), the method comprising:
receiving first information for first and second groups of configured transmission configuration indication (TCI) states;
receiving, in a downlink control information (DCI), a first indicated TCI state of a TCI codepoint;
receiving second information for a first control resource set (CORESET);
identifying, based on the first information, whether the first indicated TCI state is associated with the first or second group of configured TCI states;
identifying, based on the second information, whether the first CORESET is associated with the first or second group of configured TCI states; and
based on identifying that the first indicated TCI state and the first CORESET are associated with the same group of configured TCI states, receiving physical downlink control channel (PDCCH) candidates in the first CORESET according to the first indicated TCI state.

18. The method of claim 17, wherein the first information indicates at least one of:
a bitwidth of an identity (ID) of a configured TCI state in the first or second group, determined according to one of:
a total number of configured TCI states in the first or second group; and
a total number of configured TCI states across both of the first and second groups; and
an indicator associated with an activated TCI codepoint comprising at least one TCI state.

19. The method of claim 18, wherein:
when the indicator is set to ‘first’ or ‘0’, the at least one TCI state of the activated TCI codepoint is from the first group; and
when the indicator is set to ‘second’ or ‘1’, the at least one TCI state of the activated TCI codepoint is from the second group.

20. The method of claim 17, wherein the second information indicates at least one of:
first and second groups of CORESETs where:
when the first CORESET belongs to the first group of CORESETs, the first CORESET is associated with the first group of configured TCI states; and
when the first CORESET belongs to the second group of CORESETs, the first CORESET is associated with the second group of configured TCI states; and
an index of the first or second group of configured TCI states.
